(19) United States
(12) Patent Application Publication
(10) Pub. No.: US 2026/0091874 A1
(43) Pub. Date: Apr. 2, 2026

(54) AIRCRAFT WITH AN UNDUCTED FAN PROPULSOR

(71) Applicant: General Electric Company, Evendale, OH (US)

(72) Inventors: Sara Elizabeth Carle, Columbus, OH (US); Daniel L. Tweedt, West Chester, OH (US); Syed Arif Khalid, West Chester, OH (US); Andrew Breeze-Stringfellow, Montgomery, OH (US); William Bowden, Cleves, OH (US); Randy M. Vondrell, Newport, KY (US)

(21) Appl. No.: 19/345,532

(22) Filed: Sep. 30, 2025

Related U.S. Application Data
(63) Continuation-in-part of application No. PCT/US2024/040754, filed on Aug. 2, 2024.
Application No. PCT/US2024/040754 is a continuation-in-part of application No. 18/652,052, filed on May 1, 2024, now Pat. No. 12,384,522.
Application No. 18/652,052 is a continuation-in-part of application No. 18/230,609, filed on Aug. 4, 2023, now Pat. No. 12,365,471.

(51) Int. Cl. B64D 27/12; B64D 27/33

(52) U.S. Cl. CPC B64D 27/12; B64D 27/33

(57) ABSTRACT

The present disclosure is generally related to aircraft having one or more unducted fan propulsors at locations within specific regions relative to an airfoil, such as a wing or horizontal stabilizer. More specifically, the specific regions are located where there is a relatively higher pressure air flow beneath the wings or above a horizontal stabilizer. That higher pressure air flow can be utilized to provide increased thrust from the unducted fan propulsor.

### CROSS-REFERENCE TO RELATED APPLICATIONS

This application is a continuation-in-part of International Appl. No. PCT/US2024/040754, filed Aug. 2, 2024, which claims priority to U.S. patent application Ser. No. 18/230,609, filed on Aug. 4, 2023, and Ser. No. 18/652,052, filed May 1, 2024, the latter of which is a continuation-in-part of the former, the disclosures of which are hereby incorporated by reference in their entireties.

### FIELD

The present disclosure relates generally to an aircraft with a fan propulsor.

### BACKGROUND

Winged aircraft have undermounted propulsors in the form of a turboprop engine. The addition of a propulsor to a wing can lead to installation penalties, including increased drag. As the size of the undermounted propulsor increases, installation penalties can also increase, such as increased weight.

### BRIEF DESCRIPTION OF THE DRAWINGS

A full and enabling disclosure of the aspects of the present description, including the best mode thereof, directed to one of ordinary skill in the art, is set forth in the specification, which refers to the appended figures, in which:

FIG. 1 comprises a top plan view of an aircraft as configured in accordance with various embodiments of these teachings, with undermounted, unducted fan propulsors mounted on forward wings of the aircraft;

FIG. 2 comprises a top plan view of an aircraft as configured in accordance with various embodiments of these teachings, with unducted fan propulsors mounted on top of horizontal stabilizers of the aircraft;

FIG. 3 comprises an elevational cross-sectional view of an exemplary unducted fan propulsor having a plurality of blades arranged in a forward array and a rearward array;

FIG. 4 comprises a schematic side elevation view showing the location of the unducted fan propulsor of FIG. 3 relative to an airfoil section;

FIG. 5A is a schematic side elevation view similar to FIG. 4 and showing the unducted fan propulsor pitched downward relative to the airfoil section;

FIG. 5B defines a pitch angle Φ for the unducted fan propulsor relative to a chord line of the airfoil section in FIG. 4;

FIG. 6A comprises a top plan view of the propulsor of FIG. 4 and inboard and outboard locations of the wing relative to an unducted fan propulsor centerline, with the inboard and outboard locations in FIG. 6A used to determine a chord length (C) of the airfoil section in FIG. 4;

FIG. 6B comprises a schematic side elevation view of a first section and a second section of the aircraft wing, which sections are used to determine an effective quarter chord point (QC) of the airfoil section in FIG. 4;

FIG. 6C comprises a schematic top plan view of a portion of an aircraft having a pair of wings extending from the fuselage with the propulsor of FIG. 3 mounted relative to each of the wings;

FIG. 6D comprises a schematic front elevation view of the aircraft portion of FIG. 6C;

FIG. 6E comprises a schematic top plan view of a portion of an aircraft having a pair of wings extending from the fuselage with the propulsor of FIG. 3 mounted relative to each of the wings, similar to FIG. 6C but showing the propulsors toed inwardly toward the fuselage;

FIG. 7 comprises a schematic side elevation view similar to that of FIG. 4, but showing a first ellipse, a second ellipse, a third ellipse, and a fourth ellipse to illustrate various embodiments of mounting locations of one of the unducted fan propulsors relative to one of the wings;

FIG. 8 comprises a schematic side elevation view similar to that of FIG. 7, but showing a first ellipse, a second ellipse, a third ellipse, and a fourth ellipse to illustrate various embodiments of mounting locations of one of the unducted fan propulsors relative to one of the horizontal stabilizers;

FIG. 9 comprises a schematic side elevation view similar to that of FIG. 7, showing the first ellipse, the second ellipse, the third ellipse, and the fourth ellipse to illustrate various embodiments of mounting locations of one of the unducted fan propulsors relative to one of the wings;

FIG. 10 comprises a schematic side elevation view similar to that of FIG. 8, showing the first ellipse, the second ellipse, the third ellipse, and the fourth ellipse to illustrate various embodiments of mounting locations of one of the unducted fan propulsors relative to one of the horizontal stabilizers; and

FIG. 11 comprises a schematic representation showing exemplary locations of a point P of one of the unducted fan propulsors, as defined herein, within the first ellipse, the second ellipse, the third ellipse, and the fourth ellipse.

FIG. 12 provides a schematic cross-sectional view of a three-stream gas turbine engine according to various embodiments of the present disclosure;

FIG. 13 provides a close-up, schematic cross-sectional view of a forward portion of the unducted fan propulsor of FIG. 12.

FIG. 14 provides a schematic, cross-sectional view of an electric machine embedded in the three-stream gas turbine engine of FIG. 12.

FIG. 15 provides a schematic, cross-sectional view of an aft portion of the three-stream gas turbine engine of FIG. 12.

FIG. 16 provides a schematic cross-sectional view of a three-stream gas turbine engine having an embedded electric machine positioned forward of a mid-fan according to various embodiments of the present disclosure.

FIG. 17 provides a schematic cross-sectional view of a three-stream gas turbine engine according to various embodiments of the present disclosure.

FIG. 18 provides a close-up, schematic cross-sectional view of the three-stream gas turbine engine of FIG. 17.

FIG. 19 provides a schematic cross-sectional view of a three-stream gas turbine engine according to yet other various embodiments of the present disclosure.

FIG. 20 provides a schematic cross-sectional view of a three-stream gas turbine engine according to various embodiments of the present disclosure.

FIGS. 21A and 21B provide a flow diagram for a method of operating an unducted fan propulsor according to one example embodiment of the present disclosure.

FIGS. 22A and 22B provide a flow diagram for a method of operating an unducted fan propulsor according to one example embodiment of the present disclosure.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “or” when used herein shall be interpreted as having a disjunctive construction rather than a conjunctive construction unless otherwise specifically indicated.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

“Airfoil section” and “effective quarter chord point (QC)” are defined as follows.

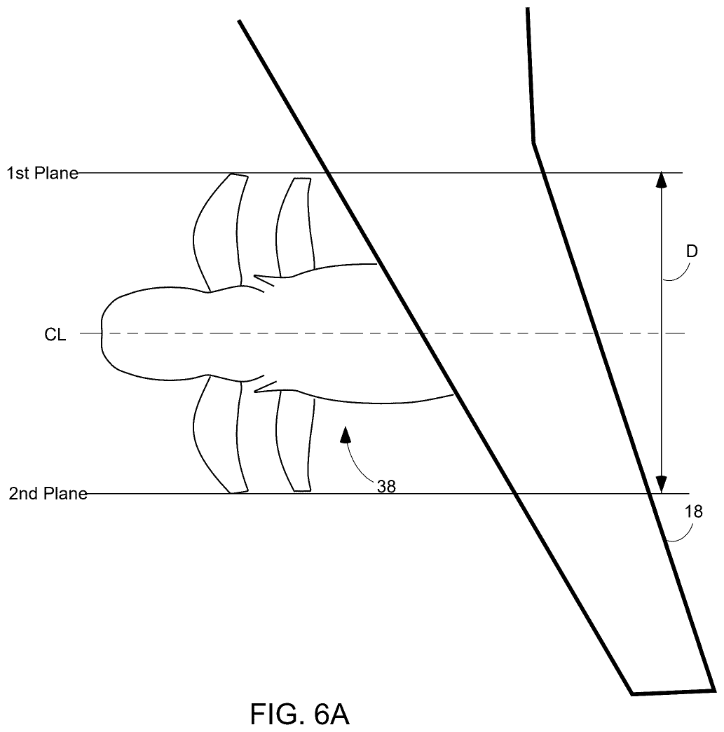

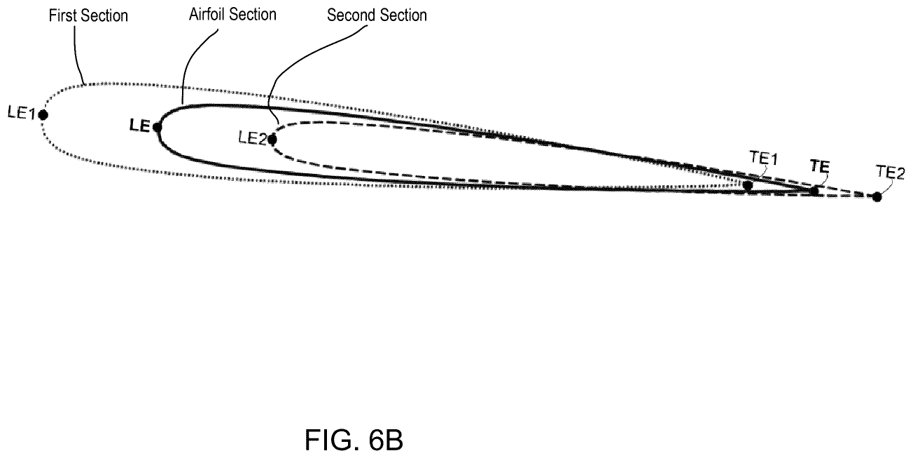

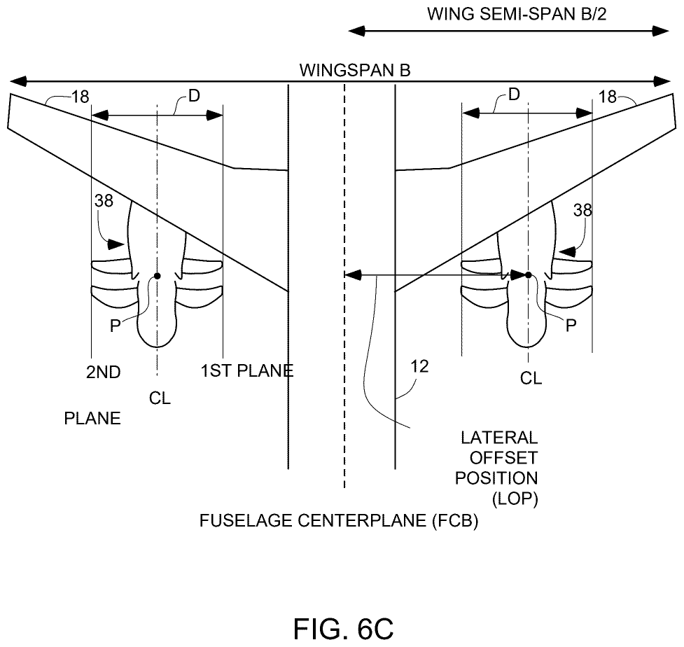

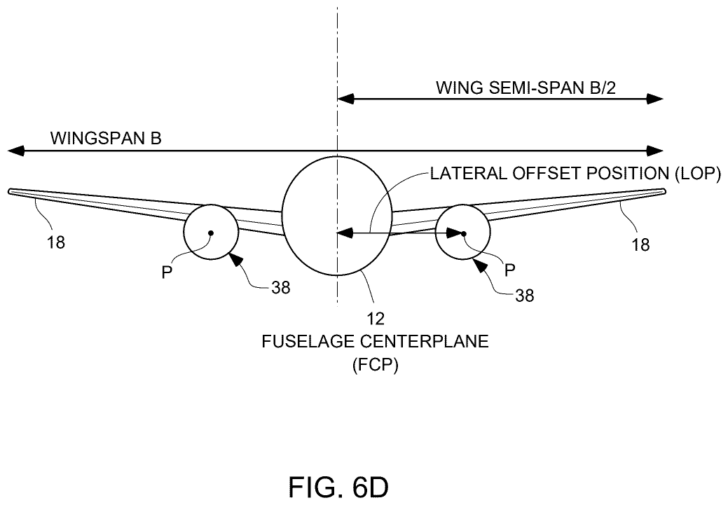

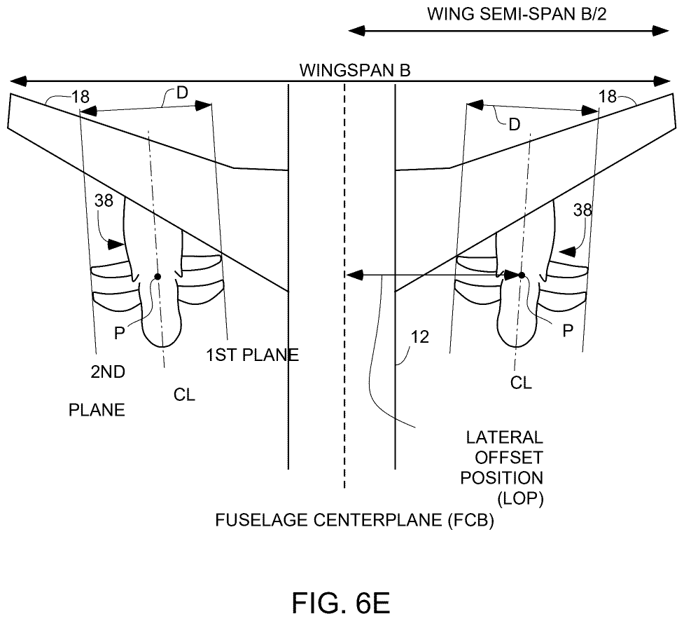

“Airfoil section” is defined as the average of a first offset plane section and a second offset plane section of an airfoil (e.g., an airfoil associated with a horizontal stabilizer or wing of an aircraft), where the first offset plane section is the section of the airfoil taken at a first plane and the second offset plane section is the section of the airfoil taken at a second plane, the first and second planes each being offset in a direction perpendicular to, and equidistant from a central plane by a distance of ½ of a fan diameter (D) of rotating blades of a propulsor mounted to the portion of the aircraft body associated with the airfoil section (wing or horizontal stabilizer). The first plane is inboard of the central plane (towards the fuselage) and the second plane is outboard of the central plane. When the aircraft is on the ground, both the gravity vector and axis of rotation of the rotating blades lie in the central plane. The intersection of the first offset plane with the airfoil defines a first section having a first section leading edge (LE1) and a first section trailing edge (TE1), with the LE1 at the forward-most point of the first section and the TE1 at the aft-most point of the first section. The intersection of the second offset plane with the airfoil defines a second section having a second section leading edge (LE2) and a second section trailing edge (TE2), with the LE2 at the forward-most point of the section and the TE2 at the aft-most point of the second section. Averaging the coordinates of LE1 and LE2 yields a representative LE location for the airfoil section. Averaging the coordinates of TE1 and TE2 yields a representative TE location for the airfoil section. The LE and TE points obtained this way are indicated in FIGS. 6 and 6B. An “Airfoil Section” defined herein has its leading and trailing edges TE, LE determined in this manner. “Effective Quarter-chord point” (“QC”) is defined as ¼ of the distance from the leading edge LE of the airfoil section determined in the foregoing manner, measured along the chord of this airfoil section. QC is dependent on the fan diameter (D) because the airfoil section LE and TE values change if D for the unducted fan propulsor changes.

“Cruise Speed” refers to aircraft speed and applies to a vehicle with a cruising altitude up to approximately 65,000 ft. In certain embodiments, cruise altitude is between approximately 28,000 ft. and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

It is understood that the plurality blades, whether forward or rearward, may have a variation of root forward-most points and root rearward-most points. This can be due to both installed position as well as orientation in the case of variable pitch blades. For purposes of defining the distances TRL, RTL, and VTL it is understood that a rotating blade or rotating array of blades are orientated such that the respective leading edges of the blades are in their most forward position, e.g., a feathered position. The respective trailing edge position is also obtained when the leading edge is in the most forward position. For purposes of defining the distances TRL, RTL, and VTL it is understood that the forward or leading edge or rearward or trailing edge of a stationary blade (or vane) or array of stationary blades (or vanes) is the most forward or leading edge position across the array of vanes or the most rearward or trailing edge position across the array of vanes.

“Blade” can refer to a stationary or rotating blade. “Stationary blade(s)” has the same meaning as “vane(s)”.

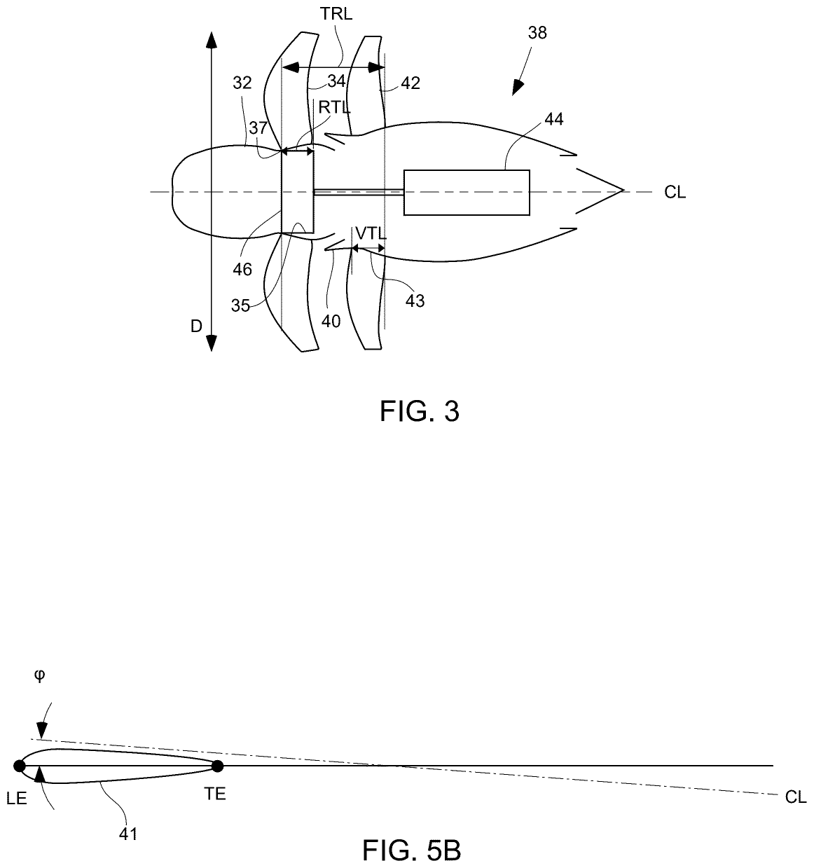

“Unducted fan propulsor” as used herein means an aircraft engine characterized by an array of rotating fan blades and static (or non-rotating), outlet guide vanes (OGV) aft of the array of rotating fan blades, or an array of rotating fan blades and static, unducted inlet guide vanes (IGV) forward of the rotating fan blades. In either case, neither the fan blades nor the IGV or OGV is surrounded by a duct or fan nacelle. FIG. 3 depicts an unducted fan propulsor. Additionally, the term unducted fan propulsor means an unducted, fan driven aircraft engine capable of providing thrust to an aircraft to enable cruise flight speeds between 0.7 Mach and 0.90 Mach, or 0.75 to 0.85 Mach.

“Aircraft” means a vehicle having a wing (and/or horizontal stabilizer), an airfoil defined by the wing (and/or horizontal stabilizer), and one or two unducted fan propulsors mounted to the wing, and the aircraft is operable at cruise flight speeds between 0.7 Mach and 0.90 Mach, or 0.75 to 0.85 Mach.

“Fuselage centerplane” (“FCP”) is defined as a plane that is located equidistant from the wingtips, intersecting the fuselage, and containing the gravity vector when the aircraft is on the ground.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “proximate” refers to being closer to one side or end than an opposite side or end.

The inventors were faced with a problem of how to improve thrust delivered to an aircraft by an unducted fan propulsor without increasing the required engine power delivered to the unducted fan of the unducted fan propulsor.

It was surprisingly found that the solution to this problem is heavily dependent on the location of the unducted fan propulsor relative to the aircraft wing.

The inventors found that installing an unducted fan propulsor presents the challenge of addressing penalties that can result due to the interaction with the rest of the aircraft. The manner in which these penalties are addressed according to the claimed subject matter is unique for this type of engine.

An unducted fan propulsor is particularly challenged due to the scrubbing and interference drags relative to a ducted turbofan. That additional drag then results in a higher thrust needed from the propulsor. Generally, higher thrust for a ducted turbofan comes with a larger power requirement and thus more fuel flow. For the unducted fan propulsor it was surprisingly found by placing the engine so that it can take advantage of the high pressure flow induced by the wing (and/or a horizontal stabilizer), engine thrust may increase without increasing the power requirement on the engine. This placement of the engine relative to the wing then acts to offset the scrubbing and interference drag, thus not increasing the required fuel (or reducing the increased fuel flow required for a non-optimum engine placement). The inventors found that increased drag effects associated with an unducted fan propulsor, rather than addressed directly, may instead be offset by placing the engine at a more optimal location relative to the wing.

Additionally, the inventors found that the installed engine's improved position also positively influences the noise produced by the wing-engine interaction during flight at cruise conditions.

It was surprisingly found that by adapting a particular location on an unducted fan propulsor relative to an aircraft wing's effective quarter chord point (QC), the desired result of offsetting interference and scrubbing drag without increasing the power delivered to the fan could be achieved for an unducted fan propulsor.

It was also found that the improved position is dependent on the fan blade size of the unducted fan propulsor.

As explained below, after recognizing the novel flow characteristics associated with an unducted fan propulsor installed on an aircraft, taking into account the limitations on where to place this propulsor, the inventors were surprisingly able to establish criteria for positioning the propulsor relative to an aircraft wing to offset interference and scrubbing effects by defining a midpoint (P) location between external output guide vanes (OGV) or input guide vanes (IGV) and a forward or aft rotating array of fan blades, respectively, and additionally defining the distance from the effective quarter chord point (QC) to P. The position of P relative to QC and QC itself were found dependent on the rotating fan diameter. The correlation of these parameters to offset interference and scrubbing effects was not used before and was the surprising finding of the inventors for an unducted fan propulsor. Thus, mounting unducted fan propulsors relative to the effective quarter-chord point (QC) and fan blade size as described in embodiments provided herein offsets interference and scrubbing effects associated with an unducted fan propulsor and is an improvement over other mounting locations, including conventional mounting locations that are more forward of, and more in line with, a wing chord line.

Various aspects of the present disclosure describe aspects of an aircraft characterized in part by a specific relation between an effective quarter chord point (QC) of an airfoil section associated with a wing (or horizontal stabilizer) and the unducted fan propulsor, which is believed to result in improved aircraft performance and/or fuel efficiency. According to the disclosure, an aircraft includes a fuselage and an unducted fan propulsor installed relative to a section of the wing or the horizontal stabilizer.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

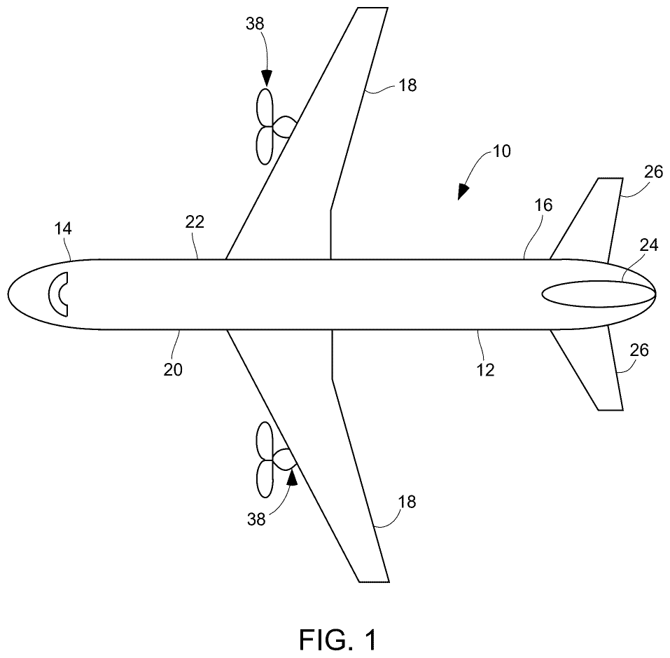

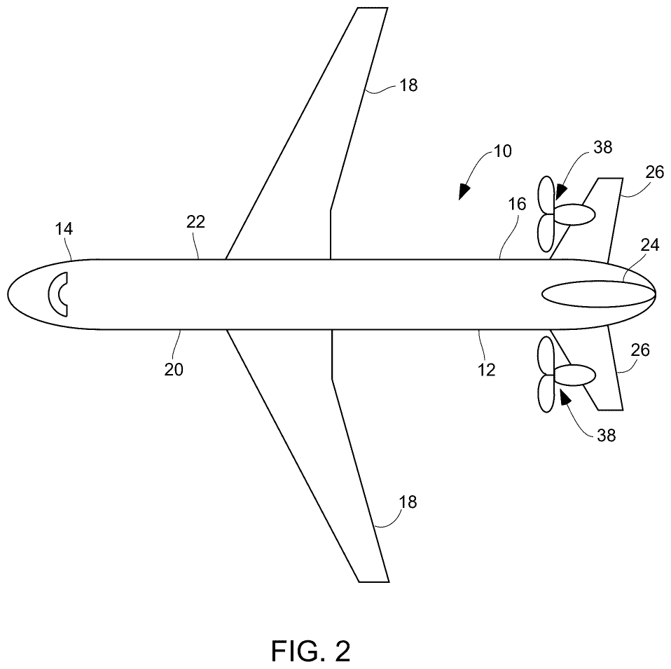

As shown in FIGS. 1 and 2, the aircraft 10 includes a fuselage 12 that extends longitudinally from a forward or nose section 14 and an aft or tail section 16 of the aircraft 10. The aircraft 10 further includes airfoils including a first wing 18 that extends laterally outwardly from a port side 20 and a second wing 18 that extends laterally outwardly from a starboard side 22 of the fuselage 12. The tail section 16 of the aircraft 10 includes a vertical stabilizer 24, a first airfoil of the horizontal stabilizer 26 that extends laterally outwardly from the port side 20, and a second airfoil of the horizontal stabilizer 26 that extends laterally outward from the starboard side 22 of the fuselage 12. An unducted fan propulsor 38 is undermounted relative to each of the wings 18, as shown in the embodiment of FIG. 1. Alternatively, the unducted fan propulsor 38 is mounted relative to the top of each of the horizontal stabilizers 26, as shown in FIG. 2. In some embodiments, more than one of the unducted fan propulsors 30 or 38 may be mounted to each of the wings 18 or each of the horizontal stabilizers 26.

FIG. 3 shows an elevational cross-sectional view of an embodiment of one of the unducted fan propulsors 38. As is seen from FIG. 3, the unducted fan propulsor 38 takes the form of an open fan propulsion system and has a rotating element in the form of rotatable propeller assembly 32 on which is mounted a first array of blades 34 around a centerline (CL) of the unducted fan propulsor 38. The first array of blades 34 defines a diameter D representing the tip-to-tip diameter of the blades and a maximum radial extent from CL. This diameter D is measured along a radial direction perpendicular to CL. The unducted fan propulsor 38 of FIG. 3 includes a second array of blades or vanes, which are non-rotating or static. In some embodiments, a non-rotating stationary element in the form of vane assembly 40 includes an array of vanes 42 disposed around CL.

Each of the blades 34 has a root 35 where the blade 34 is attached to the rotatable propeller assembly 32, and each blade 34 defines a root length (RTL). The root length (RTL) is defined as the axial extent (in a direction parallel to CL) from the radially innermost leading edge (LE) of the blade 34 airfoil, e.g., closest to CL, to the axial location of the radially innermost trailing edge (TE) of the blade 34 airfoil.

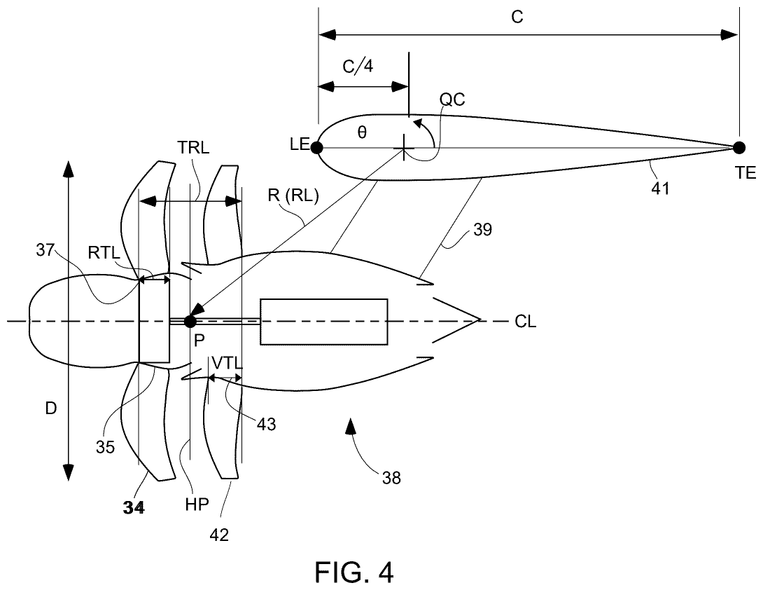

Each of the vanes 42 also has a root 43 with a vane root distance VTL where the vane 42 is attached to the non-rotating vane assembly 40. The total root length (TRL) is the distance between the leading edge (LE) of the blade 34 airfoil (radially nearest to CL) of the blades 34 and the trailing edge (LE) of the root 43 of the vanes 42, as shown in FIGS. 3 and 4. TRL is a measured axial distance from the radial innermost LE of the foremost row of blades/vanes and the trailing edge (TE) of the vanes 42. In some embodiments, the second array may instead be a second rotating elements and the TRL is the measured axial distance from the radially innermost LE of the blades 34 of the first rotating element and the TE of the root of the blades of the second rotating elements. In some embodiments, the vanes 42 may be forward of the rotating blades, and the TRL is the distance between the LE edge of the root of the vanes and the TE of the root of the rotating blades. In some embodiments, an unducted fan propulsor having rotating elements (e.g., rotating blades) and stationary elements (e.g. vanes) may be mounted according to the relationship described in the present disclosure. In unducted fan propulsors having multiple rows of blade and/or vanes, the TRL of an unducted fan propulsor is defined as the distance between the LE of the root of the foremost row of blades/vanes and the rearward edge of the root of the aftmost row of blades/vanes of the unducted fan propulsor.

Referring to FIG. 4, for purposes explained more later, the unducted fan propulsor 38 has a point P. For the unducted fan propulsor 38 with a first array of blades or vanes 34 and a second array of blades or vanes 42, as shown in FIGS. 3 and 4, the point P is located at the intersection of CL and a line HP perpendicular to CL and that passes through an axial midpoint of the total root length TRL between a forward end at the root of one of the blades 34 of the forward array and a rearward end at the root of one of the blades 42 of the rearward array when aligned with the one of the blades 34 of the forward array, as shown in FIG. 6. Either the forward or rearward array can be vanes or blades. In other words, the line HP is located equidistant from a forward end of the root of one of the forward vanes or blades 34 and a rearward end of the root of one of the rearward blades or vanes 42. The TRL of an unducted fan propulsor is defined as the distance between the LE of the root of the forward row of blades/vanes and the rearward edge of the root of the aftmost blade/vane.

Referring again to FIG. 3, the exemplary unducted fan propulsor 38 includes a drive mechanism 44 that provides torque and power to the propeller assembly 32 through a transmission 46. The drive mechanism 44 may be a gas turbine engine and associated transmission 46. Transmission 46 delivers torque from the drive mechanism 44 to the propeller assembly 32. The transmission system can be configured as a direct drive engine, transferring power from a power turbine or low pressure turbine (LPT) to the propeller assembly, or an indirect drive system where torque from the LPT is transferred to the propeller assembly 32 through a gearbox. The gearbox reduces a rotation speed of the drive shaft to match a desired rotational speed for the propeller assembly 32. The gas turbine engine includes in serial order a compressor, combustor, high pressure turbine and the LPT. In other embodiments the drive mechanism may generate power partially or fully by an electric motor. In the former case the drive mechanism is a hybrid electric drive mechanism including a gas turbine engine where a drive shaft includes an electric motor-generator for generating torque. In the latter case the drive mechanism is an electric motor.

The unducted fan propulsor 38 is attached relative to the wings 18 or horizontal stabilizer 26 through one or more intermediate components or features, e.g., a pylon 39, as shown in FIG. 4.

Each of the wings 18 shown in FIG. 1, and horizontal stabilizers 26 shown in FIG. 2, has an airfoil section 41 associated with it, where the airfoil section 41 is defined above.

As depicted in FIG. 4, a chord line C of the airfoil section, length C as shown, is a straight line extending from LE to TE of the airfoil section (it will be understood that the airfoil section as shown and defined herein is not meant to indicate any particular camber associated with an aircraft wing). The effective quarter-chord point (QC) of the airfoil section is located on the chord line. QC is located at a distance of C/4 from the LE of the airfoil section 41.

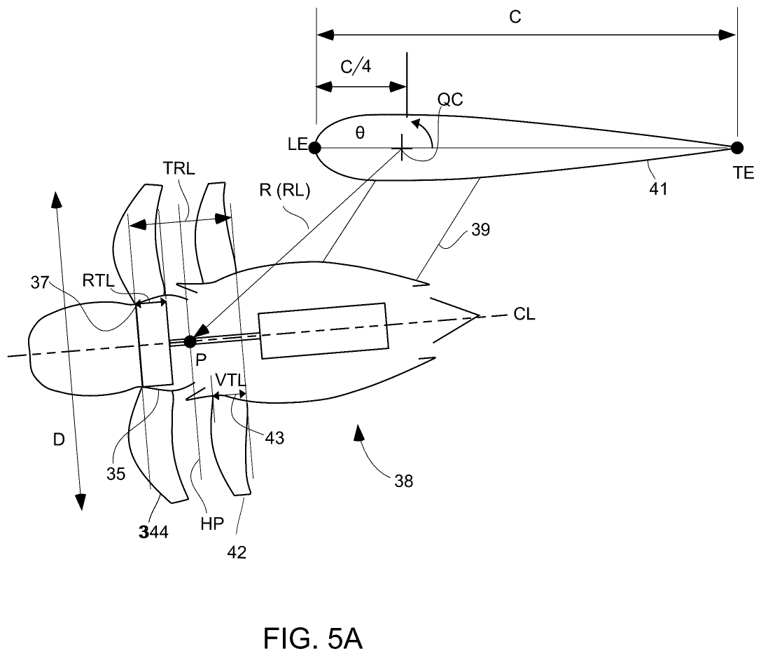

As shown in FIG. 4, the CL of the propulsor 38 and the chord line C are parallel to each other, corresponding to a zero pitch of the propulsor relative to the chord line C. The propulsor 38 can be pitched at different angles relative to the chord line, such as pitched downward as shown in FIG. 5A. FIG. 5B defines a pitch angle Φ for the propulsor 38, which is the angle spanned between the propulsor centerline CL and chord line C. Positive pitch corresponds to a clockwise rotation of CL relative to C. The pitch angle Φ can be fixed or variable during flight. For underwing installations, the pitch angle Φ can vary between −5 and +2 degrees, or it can vary between −3 and 0 degrees. During cruise conditions, propulsor pitch and toe angle (FIG. 6E, defined below) provide for an improved installed aerodynamic performance for the unducted fan propulsor in terms of reduced cabin noise and reduced off-axis loading of the unducted fan propulsor's drive shaft. For aft horizontal stabilizer or aft fuselage installations, the angle Φ can vary between −2 and +5 degrees to more align with downwash created by the wing.

The position of the open fan propulsor 38 is defined relative to QC. The airfoil section, as defined above, is the average of a first offset plane section and a second offset plane section of the airfoil (of the wing), where the first offset plane section is the section of the airfoil taken at a first plane and the second offset plane section is the section of the airfoil taken at a second plane, the first and second planes being offset in a direction perpendicular to, and equidistant from a central plane by a distance of ½ the maximum fan diameter (D) for the rotating blades, as shown in FIG. 6A. Both the gravity vector and axis of rotation of the rotating blades of the propulsor lie in this central plane when the aircraft is on the ground.

Referring to FIG. 6C, the propulsor 38—specifically, point P of the propulsor 38—has a spanwise location laterally offset from the fuselage centerplane (FCP) relative to the aircraft's wingspan B. P has a laterally offset position (LOP) between 10% and 80%, 20% and 40%, or between 25% and 35% of B/2 measured from the fuselage centerplane (FCP), as defined above. The location of P is also chosen to avoid interference with the fuselage or an adjacent propulsor if more than one propulsor is mounted relative to the wing. For an aft fuselage installation, the LOP of the propulsor will be closer to the fuselage, but far enough away from the fuselage's boundary layer to reduce or avoid undue interaction with the fuselage boundary layer.

As shown in FIG. 6C, the propulsor centerline CL and the fuselage centerplane (FCP) can be orientated parallel to each other. Referring to FIG. 6D, other angles between propulsor centerline CL and the fuselage centerplane (FCP) are contemplated. For an underwing mounted propulsor, the toe angle can provide added benefit when positive (i.e., the rotor toed-in towards the fuselage with the forward end of the propulsor 38 being more inboard than the aft end). The propulsor can have an inward toe angle of between 0 and 5 degrees, or between 1 and 3 degrees.

There are specific locations that the inventors have found to be advantageous to position the unducted fan propulsor 38 to generate increased thrust using higher pressure air flow, in order to offset the scrubbing and interference drag. The higher pressure air flow can be beneath the wings 18. In the case of a horizontal stabilizer 26, the higher pressure air flow is above the horizontal stabilizer 26. Accordingly, the high-pressure side of an airfoil may refer to the underside of a wing 18 or the top side of a horizontal stabilizer 26.

The aircraft described herein has a fuselage, wings and/or stabilizers, and two or more unducted fan propulsor systems (or propulsors). The unducted fan propulsor system, which is mounted on the pressure side of a wing or horizontal stabilizer, provides thrust to the aircraft. To improve upon what the propulsor system can deliver, there often is a need to make compromises to other parts of aircraft design (trade-offs). Stated another way, the benefits of an unducted fan propulsor cannot be viewed without consideration of the effect of placement of the propulsor on the aircraft. For example, placement can affect loads on and size of the pylon, wing loads, landing gear length and associated forces, weight, and cost.

The teachings described below enable improved balancing of the tradeoffs required in the aircraft design while positioning the unducted fan propulsor relative to the airfoil section's effective quarter chord point QC to offset scrubbing and interference drag loses.

Referring to FIG. 4, the location of an unducted fan propulsor relative to an airfoil section 41 is defined herein using a polar coordinate system having an angular (θ) coordinate and a radial (R) component, with origin located at the effective quarter chord point (QC) of the airfoil section having a chord length (C) as shown. The radial component is referred to herein as a “positioning line (R)”. The location of the point P of the unducted fan propulsor 38 relative to the origin (QC) of the polar coordinate system (the origin of the coordinate system is the same as the effective quarter chord point for airfoil section 41) is expressed in terms of a vector having radial component R with magnitude RL and angular component θ. The vector magnitude RL is called a “positioning line length (RL)”.

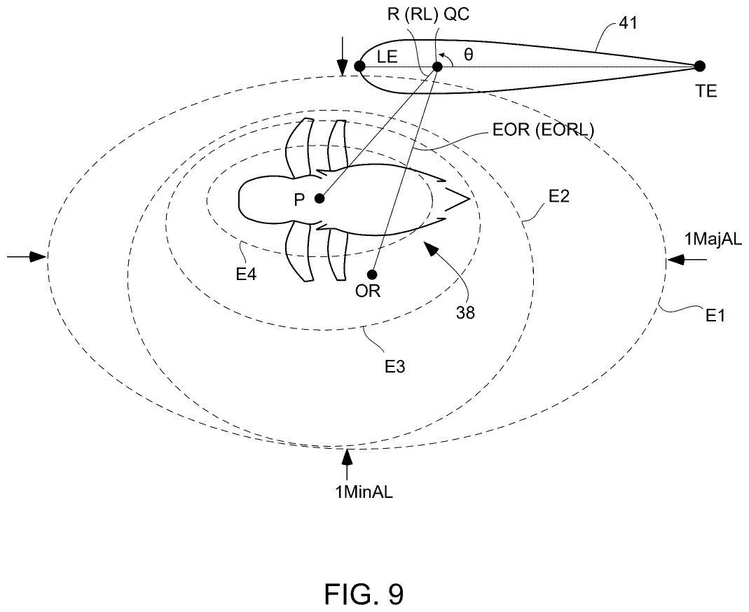

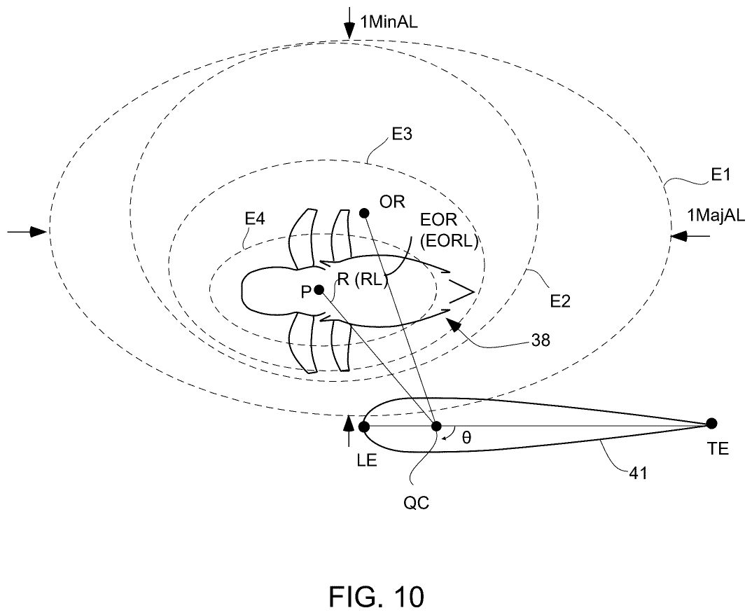

The angle θ is measured relative to a datum that is the airfoil section chord line (e.g., in FIG. 6 the vector R is located by an angle that is between 180 and 270 degrees measured counterclockwise about origin QC relative to the chord line). When viewed looking from an outboard position towards an inboard position (e.g., the fuselage), θ is positive in a counter-clockwise direction when the propulsor is below the airfoil section 41 (wing, FIG. 9), and θ is positive in a clockwise direction when the propulsor is above the airfoil section (horizontal stabilizer, FIG. 10) as indicated in the drawings, respectively, by the direction of the arrow from the origin.

The inventors found that for an unducted fan propulsor system the ratio of RL over D (i.e., RL/D) is desirably less than or equal to 2, less than or equal to 2 and greater than or equal to 0.15, or less than or equal to 2 and greater than or equal to 0.35. Additionally, for the undermounted unducted fan propulsor systems (pressure side of the airfoil section) of FIGS. 5 and 6 the angular component θ associated with these ranges for RL/D and locating the unducted fan propulsor system (i.e., the location of P relative to the airfoil section) are desirably between 187° and 342°, between 198° and 310°, or between 205° and 285°. These regions of RL and θ locating the unducted fan propulsor system relative to the airfoil section tend to offset scrubbing and interference drag for an unducted fan propulsor.

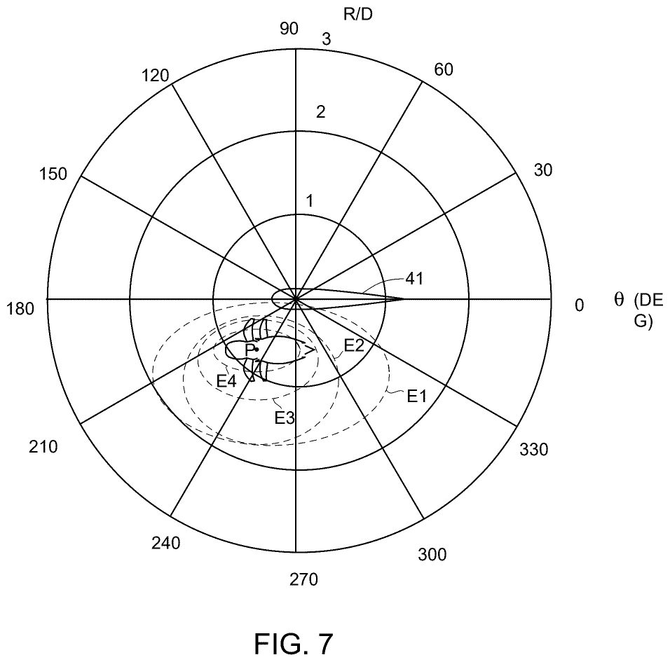

Alternatively, the point P for the unducted fan propulsor can be located within a defined ellipse defining a region relative to QC where scrubbing and interference drag tends to offset. FIGS. 7-10 each illustrate such ellipses according to several embodiments. Each of the ellipses has an origin OR, a major axis length (MajAL), and a minor axis length (MinAL), as shown in FIGS. 9 and 10 with respect to one of several ellipses and as will be explained further below. The location of OR is expressed relative to QC using the polar coordinate system frame of reference defined earlier. The propulsor system is mounted such that the point P of the unducted fan propulsors 38 is located within an ellipse as defined herein.

Referring to FIG. 9, the radial ellipse origin positioning line (EOR) extends from the ellipse origin OR, e.g., ellipse E1, to QC. The ellipse origin position line EOR has a length EORL. The origin of each of the ellipses is defined in the adopted polar coordinates with a radial coordinate defined as the ratio of EORL to the array of blades diameter (D), i.e., the quantity EORL/D. The angle θ is measured relative to the chord line (as defined earlier) and positive in a clockwise direction when the propulsor is above the airfoil section (horizontal stabilizer, FIG. 10) as indicated in the drawings, respectively, by the direction of the arrow from the origin.

An angle θ for the ellipse origin positioning line EOR is measured from a datum that is the chord line to an ellipse positioning line EOR (e.g., in FIG. 9 the vector EOR is located by an angle that is between 180 and 270 degrees measured counterclockwise about origin QC). A positive θ (1) increases in a counter-clockwise direction when the high pressure side of the airfoil section is below the airfoil section, and (2) increases in a clockwise direction when the high pressure side of the airfoil section is above the airfoil section.

In a first embodiment, the point P of the unducted fan propulsor 38 is located in a first ellipse E1 with a first ellipse origin defined by EORL/D of 0.938 and θ of 253.6°. The first ellipse E1 also has a first major axis length (1MajAL) and a first minor axis length (1MinAL), where 1MajAL/D is 2.8 and 1MinAL/D is 1.7. An unducted fan propulsor located within E1 tends to offset scrubbing and interference drag.

In a second embodiment, the point P of the unducted fan propulsor 38 is located in a second ellipse E2 having a second ellipse origin defined by EORL/D of 1.051 and θ of 248.8°. The second ellipse E2 has a second major axis length (2MajAL) and a second minor axis length (2MinAL), where 2MajAL/D is 1.86 and 2MinAL/D is 1.56. An unducted fan propulsor located within E2 tends to offset scrubbing and interference drag.

In a third embodiment, the point P of the unducted fan propulsor 38 is located in a third ellipse E3 having a third ellipse origin defined by EORL/D of 0.870 and θ of 239.6°. The third ellipse E3 has a third major axis length (3MajAL) and a third minor axis length (3MinAL), where 3MajAL/D is 1.4 and 3MinAL/D is 0.9. An unducted fan propulsor located within E3 tends to offset scrubbing and interference drag.

In a fourth embodiment, the point P of the unducted fan propulsor 38 is located in a fourth ellipse E4 having a fourth ellipse origin defined by EORL/D of 0.763 and θ of 235.7°. The fourth ellipse E4 has a fourth major axis length (4MajAL) and a fourth minor axis length (4MinAL), where 4MajAL/D is 0.94 and 4MinAL/D is 0.44. An unducted fan propulsor located within E4 tends to offset scrubbing and interference drag.

The location of the unducted fan propulsor system (i.e., point P) relative to the airfoil section may also be expressed in terms of the following expressions:

$$\frac{R L}{D} + \frac{( \begin{matrix}\sqrt{a * [ b * {sin}^{2} ( θ ) - c * {cos}^{2} ( θ ) + d * sin ( θ ) * cos ( θ ) ]} + \\ e * sin ( θ ) + f * cos ( θ )\end{matrix} )}{g * {sin}^{2} ( θ ) + h * {cos}^{2} ( θ )} > 0$$

$$and$$

$$\frac{R L}{D} + \frac{( \begin{matrix}- \sqrt{a * [ b * {sin}^{2} ( θ ) - c * {cos}^{2} ( θ ) + d * sin ( θ ) * cos ( θ ) ]} + \\ e * sin ( θ ) + f * cos ( θ )\end{matrix} )}{g * {sin}^{2} ( θ ) + h * {cos}^{2} ( θ )} < 0$$

where 0.07<RL/D<1.98 and θ is between 187° and 340°, and where a, b, c, d, e, f, g and h have the values set forth in the following table under the heading “Fifth Emb.”:

| | Fifth | Sixth | Seventh | Eighth |
|---|---|---|---|---|
| Variable | Emb. | Emb. | Emb. | Emb. |
| a | 1.4161 | 0.52621 | 0.09923 | 0.01069156 |
| b | 1.88978 | 0.7205 | 0.2964 | 0.036 |
| c | 0.0875 | 0.352 | 0.36 | 0.3485 |
| d | 0.477 | 0.7448 | 0.66 | 0.5418 |
| e | 1.764 | 0.8476 | 0.3675 | 0.139167 |
| f | 0.19146 | 0.23119 | 0.0891 | 0.020812 |
| g | 1.96 | 0.8649 | 0.49 | 0.2209 |
| h | 0.7225 | 0.6084 | 0.2025 | 0.0484 |

In a sixth embodiment, the point P of the unducted fan propulsor 38 can be defined by the above expression, but where 0.254<RL/D<1.86 and θ is between 199° and 306°, and where a, b, c, d, e, f, g and h have the values set forth in the above table under the heading “Sixth Emb.”

In a seventh embodiment, the point P of the unducted fan propulsor 38 can be defined by the above expression, but where 0.369<RL/D<1.43 and θ is between 204° and 291°, and where a, b, c, d, e, f, g and h have the values set forth in the above table under the heading “Seventh Emb.”.

In an eighth embodiment, the point P of the unducted fan propulsor 38 can be defined by the above expression, but where 0.477<RL/D<0.9455 and θ is between 211° and 274°, And where a, b, c, d, e, f, g and h have the values set forth in the above table under the heading “Eighth Emb.”

The unducted fan propulsor locations illustrated in FIG. 7 are made relative to an airfoil section of an aircraft wing and refer to an undermounted unducted fan propulsor system.

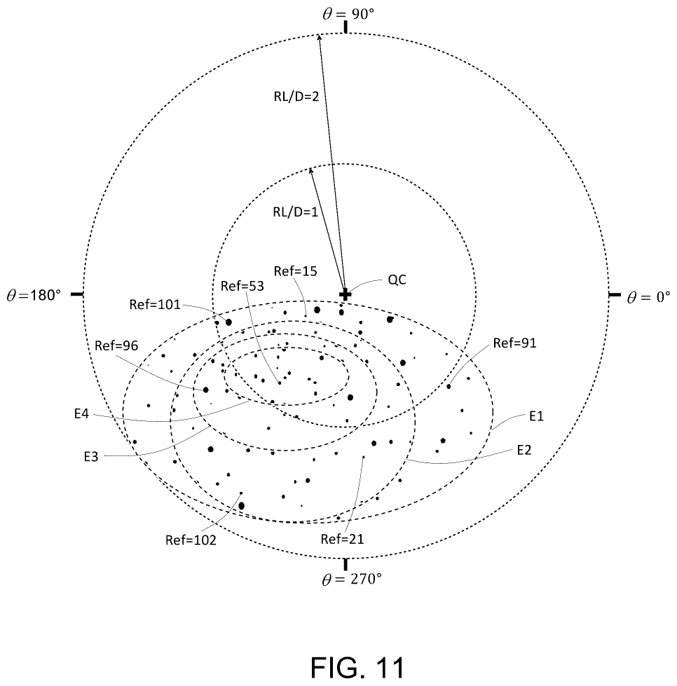

TABLES 1 and 3-6 set forth examples of embodiments of invention. TABLE 1 shows each maximum outer diameter (D) and the location of point P of the unducted fan propulsor relative to the effective quarter chord point, QC, contemplated, where the point P is defined by RL and θ. The term “Ref.” refers to the row in Table 1 for reference. The exemplary types of aircraft indicated with reference letters A through I in TABLE 1 are identified in TABLE 2. The point P of the unducted fan propulsor locations from TABLE 1 are shown in FIG. 11 for an under-wing mounted propulsor (for a propulsor mounted above a horizontal stabilizer the maximum outer diameter (D) and the point P of the unducted fan propulsor locations would be mirrored about the chord line of the airfoil section, which, for purposes of explanation, may be thought of as an axis passing through θ=0 deg and θ=180 deg in FIG. 11) relative to the first ellipse (E1), second ellipse (E2), third ellipse (E3), and the fourth ellipse (E4). The size of the points in FIG. 11 represent the relative size of D for the range provided in TABLE 1 (not to scale). The rotating blades diameter (D) may be between 2-50, 8-16, 10-15, 12-14, or 14-16 feet.

TABLE 1
P-location relative to the effective quarter chord point (QC)

| | Type of | RL | D | θ | |
|---|---|---|---|---|---|
| Ref. | aircraft | (ft) | (ft) | (deg) | RL/D |
| 1 | C I | 2.60 | 2.0 | 220.00 | 1.30 |
| 2 | F I | 1.07 | 2.0 | 189.00 | 0.54 |
| 3 | I | 3.13 | 2.0 | 199.73 | 1.57 |
| 4 | C F I | 2.18 | 3.0 | 319.20 | 0.73 |
| 5 | F I | 2.82 | 3.0 | 242.40 | 0.94 |
| 6 | C I | 1.47 | 4.0 | 293.60 | 0.37 |
| 7 | C I | 2.43 | 4.0 | 217.87 | 0.61 |
| 8 | I | 6.64 | 4.0 | 259.47 | 1.66 |
| 9 | C F I | 4.23 | 5.0 | 265.87 | 0.85 |
| 10 | C H I | 6.57 | 5.0 | 194.40 | 1.31 |
| 11 | F I | 2.03 | 5.0 | 250.93 | 0.41 |
| 12 | C F H I | 8.03 | 5.0 | 275.47 | 1.61 |
| 13 | C | 2.52 | 6.0 | 337.33 | 0.42 |
| 14 | H | 4.44 | 6.0 | 228.53 | 0.74 |
| 15 | C I | 1.88 | 6.0 | 208.27 | 0.31 |
| 16 | C F | 7.14 | 7.0 | 244.53 | 1.02 |
| 17 | B F H | 4.15 | 7.0 | 332.00 | 0.59 |
| 18 | B C I | 6.49 | 7.0 | 292.53 | 0.93 |
| 19 | C G | 8.05 | 8.0 | 216.80 | 1.01 |
| 20 | B F I | 11.89 | 8.0 | 256.27 | 1.49 |
| 21 | C G H | 10.08 | 8.0 | 277.60 | 1.26 |
| 22 | B C G I | 7.31 | 8.0 | 330.93 | 0.91 |
| 23 | C H | 9.97 | 8.0 | 294.67 | 1.25 |
| 24 | G I | 11.57 | 8.0 | 312.80 | 1.45 |
| 25 | B F I | 11.58 | 9.0 | 260.53 | 1.29 |
| 26 | C H | 6.06 | 9.0 | 224.27 | 0.67 |
| 27 | F G H | 3.06 | 9.0 | 233.87 | 0.34 |
| 28 | C I | 12.78 | 9.0 | 204.00 | 1.42 |
| 29 | B H | 10.47 | 10.0 | 210.40 | 1.05 |
| 30 | B I | 5.53 | 10.0 | 221.07 | 0.55 |
| 31 | A B C F G H | 7.00 | 10.0 | 253.07 | 0.70 |
| 32 | I | 2.47 | 10.0 | 306.40 | 0.25 |
| 33 | A C | 15.27 | 10.0 | 222.13 | 1.53 |
| 34 | G | 11.67 | 10.0 | 241.33 | 1.17 |
| 35 | A C F H | 17.13 | 10.0 | 243.47 | 1.71 |
| 36 | A B G I | 18.70 | 11.0 | 210.00 | 1.70 |
| 37 | G | 10.93 | 11.0 | 249.87 | 0.99 |
| 38 | A H | 4.33 | 11.0 | 285.07 | 0.39 |
| 39 | F I | 6.82 | 11.0 | 206.13 | 0.62 |
| 40 | A F H | 11.60 | 12.0 | 272.27 | 0.97 |
| 41 | A B F I | 10.64 | 12.0 | 227.47 | 0.89 |
| 42 | A H | 21.84 | 12.0 | 232.80 | 1.82 |
| 43 | A G | 8.56 | 12.0 | 236.00 | 0.71 |
| 44 | B F H | 0.78 | 12.0 | 263.50 | 0.07 |
| 45 | A F | 10.00 | 12.5 | 200.00 | 0.80 |
| 46 | A B G H I | 15.25 | 12.5 | 268.00 | 1.22 |
| 47 | B | 19.92 | 12.5 | 279.73 | 1.59 |
| 48 | A B F | 15.92 | 12.5 | 316.00 | 1.27 |
| 49 | A B | 6.25 | 12.5 | 270.13 | 0.50 |
| 50 | A F H | 18.42 | 12.5 | 211.47 | 1.47 |
| 51 | F G | 24.25 | 12.5 | 215.73 | 1.94 |
| 52 | A B H | 19.50 | 13.0 | 287.20 | 1.50 |
| 53 | H | 10.66 | 13.0 | 234.93 | 0.82 |
| 54 | B | 14.99 | 13.0 | 326.67 | 1.15 |
| 55 | I | 18.11 | 13.0 | 239.20 | 1.39 |
| 56 | A B F H | 23.49 | 13.0 | 225.33 | 1.81 |
| 57 | A F G H | 10.49 | 13.0 | 302.13 | 0.81 |
| 58 | B I | 3.38 | 13.0 | 231.73 | 0.26 |
| 59 | A B G | 13.95 | 13.0 | 212.53 | 1.07 |
| 60 | A B H | 10.14 | 13.0 | 255.20 | 0.78 |
| 61 | F | 10.80 | 13.5 | 215.00 | 0.80 |
| 62 | A H I | 19.35 | 13.5 | 198.67 | 1.43 |
| 63 | B F | 15.39 | 13.5 | 220.00 | 1.14 |
| 64 | A G H I | 7.83 | 13.5 | 207.20 | 0.58 |
| 65 | B H | 10.30 | 13.5 | 235.70 | 0.76 |
| 66 | A B | 23.49 | 13.5 | 237.07 | 1.74 |
| 67 | A H | 22.05 | 13.5 | 238.13 | 1.63 |
| 68 | F G | 13.08 | 13.5 | 192.00 | 0.97 |
| 69 | A B F | 6.03 | 13.5 | 195.47 | 0.45 |
| 70 | A F | 13.23 | 13.5 | 200.80 | 0.98 |
| 71 | B H | 16.89 | 14.0 | 201.87 | 1.21 |
| 72 | B I | 22.68 | 14.0 | 254.13 | 1.62 |
| 73 | A B F H | 24.17 | 14.0 | 269.07 | 1.73 |
| 74 | B E G | 19.69 | 14.0 | 301.07 | 1.41 |
| 75 | A | 12.60 | 14.0 | 223.20 | 0.90 |
| 76 | H I | 23.30 | 15.0 | 214.67 | 1.55 |
| 77 | A B E G H | 10.30 | 15.0 | 248.80 | 0.69 |
| 78 | A B E H | 17.90 | 15.0 | 288.27 | 1.19 |
| 79 | F G | 21.23 | 16.0 | 246.67 | 1.33 |
| 80 | A E | 8.64 | 16.0 | 290.40 | 0.54 |
| 81 | E G | 17.60 | 16.0 | 207.00 | 1.10 |
| 82 | A E | 25.20 | 18.0 | 230.00 | 1.40 |
| 83 | F | 19.80 | 18.0 | 225.00 | 1.10 |
| 84 | A G | 6.84 | 18.0 | 263.73 | 0.38 |
| 85 | A E | 35.64 | 18.0 | 221.00 | 1.98 |
| 86 | A E | 6.17 | 20.0 | 297.03 | 0.31 |
| 87 | F | 30.55 | 21.0 | 259.78 | 1.45 |
| 88 | A D | 10.99 | 22.0 | 252.33 | 0.50 |
| 89 | A E | 21.50 | 22.0 | 237.43 | 0.98 |
| 90 | D | 14.29 | 24.0 | 222.53 | 0.60 |
| 91 | D E | 25.75 | 24.0 | 319.38 | 1.07 |
| 92 | D E | 3.41 | 29.0 | 267.23 | 0.12 |
| 93 | D | 39.42 | 29.0 | 304.48 | 1.36 |
| 94 | E | 38.55 | 33.0 | 282.13 | 1.17 |
| 95 | D | 51.16 | 33.0 | 229.98 | 1.55 |
| 96 | D E | 44.23 | 35.0 | 215.08 | 1.26 |
| 97 | E | 24.18 | 35.0 | 311.93 | 0.69 |
| 98 | D | 8.53 | 40.0 | 207.63 | 0.21 |
| 99 | D | 31.45 | 40.0 | 274.68 | 0.79 |
| 100 | D | 18.19 | 45.0 | 334.28 | 0.40 |
| 101 | D | 42.32 | 48.0 | 192.73 | 0.88 |
| 102 | D | 90.00 | 50.0 | 244.88 | 1.80 |

TABLE 2

| Designator | |
|---|---|
| for TABLE 1 | Aircraft Type |
| A | Narrow Body, twin engine |
| B | Narrow Body, 4 engines |
| C | Narrow Body, distributed propulsors (>4 engines) |
| D | Wide Body, twin engine |
| E | Wide Body, 4 engines |
| F | Wide Body, distributed propulsors (>4 engines) |
| G | Regional Jet |
| H | Business Jet |
| I | UAV |

For Aircraft Type A, B, C and G having a Mach flight speed at cruise conditions of between 0.70 and 0.85 the fan diameter (D) is between 8 and 16 feet, or more preferably between 12 feet and 16 feet.

TABLES 3-6 provide exemplary embodiments for EORL and D for each of the first ellipse E1, second ellipse E2, third ellipse E3 and fourth ellipse E4, respectively, relative to the quarter chord point (QC).

TABLE 3
First Ellipse E1 Embodiments

| D | θ | EORL | 1MajAL | 1MinAL | EORL/ | 1MajAL/ | 1MinAL/ |
|---|---|---|---|---|---|---|---|
| (ft) | (deg) | (ft) | (ft) | (ft) | D | D | D |
| 2 | 253.6 | 1.876 | 5.6 | 3.4 | 0.938 | 2.8 | 1.7 |
| 3 | 253.6 | 2.814 | 8.4 | 5.1 | 0.938 | 2.8 | 1.7 |
| 4 | 253.6 | 3.752 | 11.2 | 6.8 | 0.938 | 2.8 | 1.7 |
| 5 | 253.6 | 4.69 | 14 | 8.5 | 0.938 | 2.8 | 1.7 |
| 6 | 253.6 | 5.628 | 16.8 | 10.2 | 0.938 | 2.8 | 1.7 |
| 7 | 253.6 | 6.566 | 19.6 | 11.9 | 0.938 | 2.8 | 1.7 |
| 8 | 253.6 | 7.504 | 22.4 | 13.6 | 0.938 | 2.8 | 1.7 |
| 9 | 253.6 | 8.442 | 25.2 | 15.3 | 0.938 | 2.8 | 1.7 |
| 10 | 253.6 | 9.38 | 28 | 17 | 0.938 | 2.8 | 1.7 |
| 11 | 253.6 | 10.318 | 30.8 | 18.7 | 0.938 | 2.8 | 1.7 |
| 12 | 253.6 | 11.256 | 33.6 | 20.4 | 0.938 | 2.8 | 1.7 |
| 12.5 | 253.6 | 11.725 | 35 | 21.25 | 0.938 | 2.8 | 1.7 |
| 13 | 253.6 | 12.194 | 36.4 | 22.1 | 0.938 | 2.8 | 1.7 |
| 13.5 | 253.6 | 12.663 | 37.8 | 22.95 | 0.938 | 2.8 | 1.7 |
| 14 | 253.6 | 13.132 | 39.2 | 23.8 | 0.938 | 2.8 | 1.7 |
| 15 | 253.6 | 14.07 | 42 | 25.5 | 0.938 | 2.8 | 1.7 |
| 16 | 253.6 | 15.008 | 44.8 | 27.2 | 0.938 | 2.8 | 1.7 |
| 18 | 253.6 | 16.884 | 50.4 | 30.6 | 0.938 | 2.8 | 1.7 |
| 20 | 253.6 | 18.76 | 56 | 34 | 0.938 | 2.8 | 1.7 |
| 21 | 253.6 | 19.698 | 58.8 | 35.7 | 0.938 | 2.8 | 1.7 |
| 22 | 253.6 | 20.636 | 61.6 | 37.4 | 0.938 | 2.8 | 1.7 |
| 24 | 253.6 | 22.512 | 67.2 | 40.8 | 0.938 | 2.8 | 1.7 |
| 29 | 253.6 | 27.202 | 81.2 | 49.3 | 0.938 | 2.8 | 1.7 |
| 33 | 253.6 | 30.954 | 92.4 | 56.1 | 0.938 | 2.8 | 1.7 |
| 35 | 253.6 | 32.83 | 98 | 59.5 | 0.938 | 2.8 | 1.7 |
| 40 | 253.6 | 37.52 | 112 | 68 | 0.938 | 2.8 | 1.7 |
| 45 | 253.6 | 42.21 | 126 | 76.5 | 0.938 | 2.8 | 1.7 |
| 48 | 253.6 | 45.024 | 134.4 | 81.6 | 0.938 | 2.8 | 1.7 |
| 50 | 253.6 | 46.9 | 140 | 85 | 0.938 | 2.8 | 1.7 |

TABLE 4
Second Ellipse E2 Embodiments

| D | θ | EORL | 2MajAL | 2MinAL | EORL/ | 2MajAL/ | 2MinAL/ |
|---|---|---|---|---|---|---|---|
| (ft) | (deg) | (ft) | (ft) | (ft) | D | D | D |
| 2 | 248.8 | 2.102 | 3.72 | 3.12 | 1.051 | 1.86 | 1.56 |
| 3 | 248.8 | 3.153 | 5.58 | 4.68 | 1.051 | 1.86 | 1.56 |
| 4 | 248.8 | 4.204 | 7.44 | 6.24 | 1.051 | 1.86 | 1.56 |
| 5 | 248.8 | 5.255 | 9.3 | 7.8 | 1.051 | 1.86 | 1.56 |
| 6 | 248.8 | 6.306 | 11.16 | 9.36 | 1.051 | 1.86 | 1.56 |
| 7 | 248.8 | 7.357 | 13.02 | 10.92 | 1.051 | 1.86 | 1.56 |
| 8 | 248.8 | 8.408 | 14.88 | 12.48 | 1.051 | 1.86 | 1.56 |
| 9 | 248.8 | 9.459 | 16.74 | 14.04 | 1.051 | 1.86 | 1.56 |
| 10 | 248.8 | 10.51 | 18.6 | 15.6 | 1.051 | 1.86 | 1.56 |
| 11 | 248.8 | 11.561 | 20.46 | 17.16 | 1.051 | 1.86 | 1.56 |
| 12 | 248.8 | 12.612 | 22.32 | 18.72 | 1.051 | 1.86 | 1.56 |
| 12.5 | 248.8 | 13.1375 | 23.25 | 19.5 | 1.051 | 1.86 | 1.56 |
| 13 | 248.8 | 13.663 | 24.18 | 20.28 | 1.051 | 1.86 | 1.56 |
| 13.5 | 248.8 | 14.1885 | 25.11 | 21.06 | 1.051 | 1.86 | 1.56 |
| 14 | 248.8 | 14.714 | 26.04 | 21.84 | 1.051 | 1.86 | 1.56 |
| 15 | 248.8 | 15.765 | 27.9 | 23.4 | 1.051 | 1.86 | 1.56 |
| 16 | 248.8 | 16.816 | 29.76 | 24.96 | 1.051 | 1.86 | 1.56 |
| 18 | 248.8 | 18.918 | 33.48 | 28.08 | 1.051 | 1.86 | 1.56 |
| 20 | 248.8 | 21.02 | 37.2 | 31.2 | 1.051 | 1.86 | 1.56 |
| 21 | 248.8 | 22.071 | 39.06 | 32.76 | 1.051 | 1.86 | 1.56 |
| 22 | 248.8 | 23.122 | 40.92 | 34.32 | 1.051 | 1.86 | 1.56 |
| 24 | 248.8 | 25.224 | 44.64 | 37.44 | 1.051 | 1.86 | 1.56 |
| 29 | 248.8 | 30.479 | 53.94 | 45.24 | 1.051 | 1.86 | 1.56 |
| 33 | 248.8 | 34.683 | 61.38 | 51.48 | 1.051 | 1.86 | 1.56 |
| 35 | 248.8 | 36.785 | 65.1 | 54.6 | 1.051 | 1.86 | 1.56 |
| 40 | 248.8 | 42.04 | 74.4 | 62.4 | 1.051 | 1.86 | 1.56 |
| 45 | 248.8 | 47.295 | 83.7 | 70.2 | 1.051 | 1.86 | 1.56 |
| 48 | 248.8 | 50.448 | 89.28 | 74.88 | 1.051 | 1.86 | 1.56 |
| 50 | 248.8 | 52.55 | 93 | 78 | 1.051 | 1.86 | 1.56 |

TABLE 5
Third Ellipse E3 Embodiments

| D | θ | EORL | 3MajAL | 3MinAL | EORL/ | 3MajAL/ | 3MinAL/ |
|---|---|---|---|---|---|---|---|
| (ft) | (deg) | (ft) | (ft) | (ft) | D | D | D |
| 2 | 239.6 | 1.74 | 2.8 | 1.8 | 0.87 | 1.4 | 0.9 |
| 3 | 239.6 | 2.61 | 4.2 | 2.7 | 0.87 | 1.4 | 0.9 |
| 4 | 239.6 | 3.48 | 5.6 | 3.6 | 0.87 | 1.4 | 0.9 |
| 5 | 239.6 | 4.35 | 7 | 4.5 | 0.87 | 1.4 | 0.9 |
| 6 | 239.6 | 5.22 | 8.4 | 5.4 | 0.87 | 1.4 | 0.9 |
| 7 | 239.6 | 6.09 | 9.8 | 6.3 | 0.87 | 1.4 | 0.9 |
| 8 | 239.6 | 6.96 | 11.2 | 7.2 | 0.87 | 1.4 | 0.9 |
| 9 | 239.6 | 7.83 | 12.6 | 8.1 | 0.87 | 1.4 | 0.9 |
| 10 | 239.6 | 8.7 | 14 | 9 | 0.87 | 1.4 | 0.9 |
| 11 | 239.6 | 9.57 | 15.4 | 9.9 | 0.87 | 1.4 | 0.9 |
| 12 | 239.6 | 10.44 | 16.8 | 10.8 | 0.87 | 1.4 | 0.9 |
| 12.5 | 239.6 | 10.875 | 17.5 | 11.25 | 0.87 | 1.4 | 0.9 |
| 13 | 239.6 | 11.31 | 18.2 | 11.7 | 0.87 | 1.4 | 0.9 |
| 13.5 | 239.6 | 11.745 | 18.9 | 12.15 | 0.87 | 1.4 | 0.9 |
| 14 | 239.6 | 12.18 | 19.6 | 12.6 | 0.87 | 1.4 | 0.9 |
| 15 | 239.6 | 13.05 | 21 | 13.5 | 0.87 | 1.4 | 0.9 |
| 16 | 239.6 | 13.92 | 22.4 | 14.4 | 0.87 | 1.4 | 0.9 |
| 18 | 239.6 | 15.66 | 25.2 | 16.2 | 0.87 | 1.4 | 0.9 |
| 20 | 239.6 | 17.4 | 28 | 18 | 0.87 | 1.4 | 0.9 |
| 21 | 239.6 | 18.27 | 29.4 | 18.9 | 0.87 | 1.4 | 0.9 |
| 22 | 239.6 | 19.14 | 30.8 | 19.8 | 0.87 | 1.4 | 0.9 |
| 24 | 239.6 | 20.88 | 33.6 | 21.6 | 0.87 | 1.4 | 0.9 |
| 29 | 239.6 | 25.23 | 40.6 | 26.1 | 0.87 | 1.4 | 0.9 |
| 33 | 239.6 | 28.71 | 46.2 | 29.7 | 0.87 | 1.4 | 0.9 |
| 35 | 239.6 | 30.45 | 49 | 31.5 | 0.87 | 1.4 | 0.9 |
| 40 | 239.6 | 34.8 | 56 | 36 | 0.87 | 1.4 | 0.9 |
| 45 | 239.6 | 39.15 | 63 | 40.5 | 0.87 | 1.4 | 0.9 |
| 48 | 239.6 | 41.76 | 67.2 | 43.2 | 0.87 | 1.4 | 0.9 |
| 50 | 239.6 | 43.5 | 70 | 45 | 0.87 | 1.4 | 0.9 |

TABLE 6
Fourth Ellipse E4 Embodiments

| D | θ | EORL | 4MajAL | 4MinAL | EORL/ | 4MajAL/ | 4MinAL/ |
|---|---|---|---|---|---|---|---|
| (ft) | (deg) | (ft) | (ft) | (ft) | D | D | D |
| 2 | 235.7 | 1.526 | 1.88 | 0.88 | 0.763 | 0.94 | 0.44 |
| 3 | 235.7 | 2.289 | 2.82 | 1.32 | 0.763 | 0.94 | 0.44 |
| 4 | 235.7 | 3.052 | 3.76 | 1.76 | 0.763 | 0.94 | 0.44 |
| 5 | 235.7 | 3.815 | 4.7 | 2.2 | 0.763 | 0.94 | 0.44 |
| 6 | 235.7 | 4.578 | 5.64 | 2.64 | 0.763 | 0.94 | 0.44 |
| 7 | 235.7 | 5.341 | 6.58 | 3.08 | 0.763 | 0.94 | 0.44 |
| 8 | 235.7 | 6.104 | 7.52 | 3.52 | 0.763 | 0.94 | 0.44 |
| 9 | 235.7 | 6.867 | 8.46 | 3.96 | 0.763 | 0.94 | 0.44 |
| 10 | 235.7 | 7.63 | 9.4 | 4.4 | 0.763 | 0.94 | 0.44 |
| 11 | 235.7 | 8.393 | 10.34 | 4.84 | 0.763 | 0.94 | 0.44 |
| 12 | 235.7 | 9.156 | 11.28 | 5.28 | 0.763 | 0.94 | 0.44 |
| 12.5 | 235.7 | 9.5375 | 11.75 | 5.5 | 0.763 | 0.94 | 0.44 |
| 13 | 235.7 | 9.919 | 12.22 | 5.72 | 0.763 | 0.94 | 0.44 |
| 13.5 | 235.7 | 10.3005 | 12.69 | 5.94 | 0.763 | 0.94 | 0.44 |
| 14 | 235.7 | 10.682 | 13.16 | 6.16 | 0.763 | 0.94 | 0.44 |
| 15 | 235.7 | 11.445 | 14.1 | 6.6 | 0.763 | 0.94 | 0.44 |
| 16 | 235.7 | 12.208 | 15.04 | 7.04 | 0.763 | 0.94 | 0.44 |
| 18 | 235.7 | 13.734 | 16.92 | 7.92 | 0.763 | 0.94 | 0.44 |
| 20 | 235.7 | 15.26 | 18.8 | 8.8 | 0.763 | 0.94 | 0.44 |
| 21 | 235.7 | 16.023 | 19.74 | 9.24 | 0.763 | 0.94 | 0.44 |
| 22 | 235.7 | 16.786 | 20.68 | 9.68 | 0.763 | 0.94 | 0.44 |
| 24 | 235.7 | 18.312 | 22.56 | 10.56 | 0.763 | 0.94 | 0.44 |
| 29 | 235.7 | 22.127 | 27.26 | 12.76 | 0.763 | 0.94 | 0.44 |
| 33 | 235.7 | 25.179 | 31.02 | 14.52 | 0.763 | 0.94 | 0.44 |
| 35 | 235.7 | 26.705 | 32.9 | 15.4 | 0.763 | 0.94 | 0.44 |
| 40 | 235.7 | 30.52 | 37.6 | 17.6 | 0.763 | 0.94 | 0.44 |
| 45 | 235.7 | 34.335 | 42.3 | 19.8 | 0.763 | 0.94 | 0.44 |
| 48 | 235.7 | 36.624 | 45.12 | 21.12 | 0.763 | 0.94 | 0.44 |
| 50 | 235.7 | 38.15 | 47 | 22 | 0.763 | 0.94 | 0.44 |

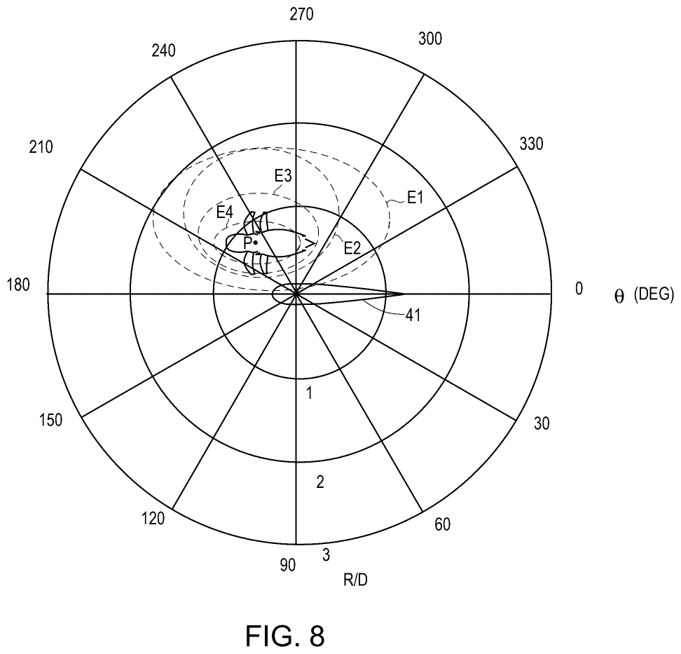

Referring to FIG. 8, the locations for P relative to the airfoil section and advantages therefrom described above can also be realized for an unducted fan propulsor system mounted above a horizontal stabilizer. For an unducted fan propulsor mounted to horizontal stabilizers, the foregoing examples and embodiments would be mirrored about the chord line of the airfoil section (again, for purposes of explanation, this chord line may be thought of as an axis passing through θ=0 deg and θ=180 deg in FIG. 11) for the case where the airfoil section 41 produces a lift in the downward direction, such as a horizontal stabilizer, as compared to a wing which produces a lift in the upward direction. The above descriptions for an undermount propulsor can apply, with the location being shifted as shown in FIG. 8 as compared to FIG. 7.

According to the foregoing examples or embodiments, the unducted fan propulsor 38, incorporating the vane assembly described herein, can be incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9. A propulsor that is part of an airplane that operates at a high cruise flight Mach number (e.g., greater than 0.7) encounters velocities near the surfaces of the rotor, vanes, and nacelle that approach or exceed the speed of sound, or Mach 1.0. In general, friction drag increases roughly in proportion to the square of the air velocity. However, as the Mach number increases, a significant contributor to the increase in drag can come from wave drag. Wave drag is a drag resulting from shock waves that form as the flow of air near a surface becomes supersonic (e.g., Mach>1.0).

In addition to the cruise flight Mach number, another factor contributing to increased drag on propulsor surfaces is high non-dimensional cruise fan net thrust based on fan annular area and flight speed. The same acceleration of the air stream by the fan that produces thrust also tends to increase the drag force on the rotor, vanes, and nacelle.

Expressing thrust non-dimensionally in a way that accounts for flight speed, ambient conditions, and fan annular area yields a thrust parameter as follows:

$$\frac{{F}_{n e t}}{{ρ}_{0} {A}_{a n} {V}_{0}^{2}}$$

In the above thrust parameter, Fₙₑₜ is cruise fan net thrust, ρ₀ is ambient air density, V₀ is cruise flight velocity, and Aₐₙ is fan stream tube cross-sectional area at the fan inlet. Fan annular area, Aₐₙ, is computed using a maximum radius as the tip radius of the forward-most rotor blades and a minimum radius as the minimum radius of the fan stream tube entering the fan.

A propulsor that operates at a high cruise fan net thrust parameter (e.g., greater than 0.06) tends to have higher propulsor velocities with risk of higher drag on propulsor surfaces.

According to any of the foregoing examples or embodiments, there may be a particularly beneficial range of a dimensionless cruise fan net thrust parameter normalized by ambient density, cruise flight speed squared, and fan stream tube annular area at fan inlet defined by the following expression:

$$0 \text{.15} > \frac{{F}_{n e t}}{{ρ}_{0} {A}_{a n} {V}_{0}^{2}} > 0.06$$

Both a high cruise flight Mach and high dimensionless cruise fan net thrust parameter contribute to higher drag levels on the propulsor surfaces. Advantageously, the specific unducted fan propulsor positions relative to the wing airfoil section, as described herein, can increase unducted fan propulsor net thrust for a given power input when there is a high cruise flight Mach and a high dimensionless cruise fan net thrust parameter.

Using the conditions described herein, the specific regions for placing the unducted fan propulsor system can be located where there is a relatively higher pressure on the high pressure side of the airfoil, beneath the wings or above the horizontal stabilizers. The higher pressure provides increased thrust from the unducted fan propulsor to thereby offset drag penalties resulting from the installation of unducted fan propulsors.

The foregoing conditions for the placement of the propulsors relative to the wing airfoils can be present for any mounting configuration of the propulsors wing. While the mounting configuration can be fixed, it is contemplated that the mounting configuration could be variable. For example, the mounting configuration of an unducted fan propulsor relative to a wing could be different for takeoff as compared to cruise operating conditions. In such a scenario, the foregoing conditions for placement of the propulsors relative to the wing airfoils can be present in either or both operating conditions, or any other operating condition.

The present disclosure also relates to a three-stream unducted fan propulsor including an embedded electric machine. The unducted fan propulsor includes a primary fan, a mid-fan, and a core engine to produce three distinct thrust streams. The unducted fan propulsor further includes an electric machine operatively coupled to a shaft of the unducted fan propulsor. The present disclosure defines specific operational and architectural relationships between the electric machine, the mid-fan, and other engine components to create an efficient hybrid-electric system. For instance, in some exemplary aspects, an operational relationship is established by a tip speed ratio between a rotor of the electric machine and a blade of the mid-fan. Additional architectural and operational relationships between the primary fan, mid-fan, electric machine, and turbine sections are also contemplated.

In particular, it was determined that combining the specific placement of the unducted fan propulsor, as discussed hereinabove, with the internal architecture of the hybrid three-stream engine, as discussed hereinbelow, may provide complementary benefits. For example, the improved placement of the unducted fan propulsor relative to the airfoil's effective quarter chord point can addresses external aerodynamic efficiency by leveraging the wing's high-pressure flow field to enhance thrust. Further, for example, the hybrid three-stream architecture can addresses internal thermodynamic efficiency and power management of the unducted fan propulsor itself. Integrating these two technologies offers a path to synergistically improving overall propulsion system performance.

The synergistic effect stems, at least in part, from combining a passive aerodynamic enhancement with an active power management system. The propulsor placement provides a baseline thrust improvement at a given power setting by interacting favorably with the wing's airflow, particularly during cruise conditions. The embedded electric machine offers a flexibility to either extract power from a spool or provide supplemental power to the spool. Such an arrangement allows the unducted fan propulsor to be improved at different phases of flight. For instance, the electric machine can provide a power boost during takeoff or climb, while the improved aerodynamic placement of the unducted fan propulsor provides enhanced fuel efficiency during cruise, resulting in an improved performance across the entire flight envelope.

Furthermore, the integration of a hybrid-electric system into an unducted fan propulsor can introduce a series of additional issues, despite the benefits noted above and discussed in more detail hereinbelow. In particular, the architectural and operational parameters of the unducted fan propulsor, as described hereinbelow, has a significant effect on an aerodynamic placement of the unducted fan propulsor. The electric machine sizing relationships (such as one or more of the following ratios: primary fan radius to mid-fan radius ratio, electric machine tip speed to mid fan tip speed, mid fan radius to electric machine tip radius, electric machine length to low pressure turbine length, electric machine tip radius to low pressure turbine last stage blade hub radius, mid fan tip speed to low pressure turbine tip speed, low pressure turbine tip speed to electric machine tip speed, electric machine power to low pressure turbine power, electric machine power to electric machine voltage, electric machine power to electric machine ac rated current, electric machine torque at max speed to electric machine ac rated current, mid fan tip speed to high pressure turbine tip speed, mid fan blade hub radius to electric machine radius, high pressure compressor blade hub radius to electric machine radius, high pressure turbine tip speed to electric machine tip speed, and high pressure turbine length to electric machine length) have a significant influence on the unducted fan propulsor's internal architecture (e.g., sizing, weight, and packaging requirements) and therefore on the unducted fan propulsor's external profile (e.g., of an outer cowling of a turbomachine of the unducted fan propulsor). In such a manner, the design choice of the electric machine has a cascading effect on the external geometry of the unducted fan propulsor, further necessitating the co-development of the unducted fan rotor's architecture as it relates to the electric machine and placement.

For example, it will be appreciated that engineers face an important trade-off between a physically larger, heavier, and slower-rotating electric machine and a smaller, lighter, and faster-rotating electric machine. A smaller, lighter, and faster machine may be desirable for weight savings, but it is limited by mechanical stresses in its rotor and the thermal loads it generates. This type of electric machine selection directly influences an internal architecture of the turbomachine, which directly influences a diameter of the outer cowling at an axial location of the electric machine and an overall shape of the outer cowling.

By way of example, a larger electric machine tip radius to low pressure turbine last stage blade hub radius will result in a higher diameter outer cowling at the axial location of the electric machine, which would affect an aerodynamic interaction between the turbomachine of the unducted fan propulsor and the wing (including a profile of the turbomachine, a weight of the turbomachine, and a packaging of the turbomachine), which would affect the RL/D for the unducted fan propulsor.

By linking the architectural and operational parameters described hereinbelow to the external aerodynamic parameters (RL/D and θ), the present disclosure provides a design approach that can provide for the unducted fan propulsor's geometry to be designed for both internal power management efficiency and external aerodynamic efficiency.

In addition, integration of an electric machine into an unducted fan propulsor can introduce significant mass and packaging challenges that would not otherwise be present. The electric machine, along with its associated power electronics and thermal management systems, can add substantial weight, particularly to an aft end of the unducted fan propulsor. This added mass may shift a center of gravity (CG) of the unducted fan propulsor, which complicates a structural design of a pylon connecting the unducted fan propulsor to the wing, and increases loads on the wing itself. In such a manner, the architectural and operational relationships characterizing a weight of the electric machine can be designed in concert with the external aerodynamic parameters (RL/D and θ) to provide an overall system that provides the desired efficiency improvements without introducing undesirable structural and weight imbalances on the unducted fan propulsor, through the pylon, or on the wing.

In such a manner, as described herein, the architectural and operational relationships can be designed in concert with the external placement relationships (RL/D and θ) to achieve an unducted fan propulsor that achieves desired efficiency improvements internally, as characterized by the one or more architectural and operational parameters, while also allowing for a desired placement of the unducted fan propulsor relative to the wing, as characterized by the RL/D and θ relationship. By considering both the unducted fan propulsor's interaction with the wing and its own internal power management, the resulting propulsion system may achieve a level of efficiency that is improved relative to applying either technology in isolation.

It will be appreciated that in certain aspects of the present disclosure an unducted rotor engine is provided. The unducted rotor engine may be configured as a three-stream gas turbine engine equipped with an embedded electric machine. Aspects of the present disclosure further provide for methods of operating the same. The three-stream engines provided herein are architecturally arranged so as to produce three distinct streams of propulsive thrust that collectively provide the net propulsive thrust of the engine. Certain architectural arrangements of the three-stream gas turbine engines having an embedded electric machine and/or certain operating relationships between components thereof can provide certain advantages over conventional turbofan engines, such as fuel burn benefits, among other advantages.

For instance, in one example aspect, a three-stream engine and methods of operating the same are disclosed. The three-stream engine includes an electric machine operatively coupled with a shaft or spool of the engine, such as a low pressure shaft. Particularly, the electric machine can include a rotor rotatable with the shaft and a stationary stator. The three-stream engine also includes a core engine and a fan section positioned upstream of the fan section. The fan section includes a primary fan and a mid-fan positioned downstream of the primary fan and upstream of the core engine. The primary fan and the mid-fan are operatively coupled with the shaft. In such embodiments, the architectural arrangement and operating relationships of the components of the three-stream engine can be such that, during operation, the three-stream engine defines a tip speed ratio. The tip speed ratio is defined by a tip speed of the rotor of the electric machine to a tip speed of a mid-fan blade of the mid-fan. In some implementations, for example, the tip speed ratio is defined as being equal to or greater than 0.2 and less than or equal to 1.0. In this regard, the electric machine and the mid-fan are architecturally arranged and operated so that the tip speed of the electric machine is equal to or less than the tip speed of the mid-fan. As will be explained herein, various other architectural and operating relationships can be defined by the three-stream engine in combination with the tip speed ratio. Moreover, as explained hereinabove, such a three-stream engine may further be designed to meet certain interaction relationships with a wing of an aircraft including the engine to achieve further benefits.

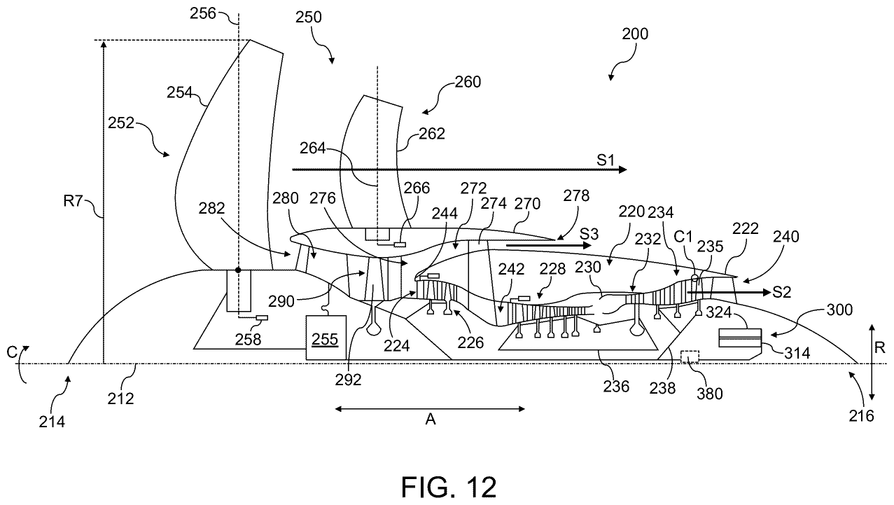

Turning now back to the drawings, FIG. 12 provides a schematic cross-sectional view of a gas turbine engine according to one example embodiment of the present disclosure. Particularly, FIG. 12 provides a gas turbine engine having an unducted fan referred to as “unducted fan propulsor 200”. The unducted fan propulsor 200 of FIG. 12 can be mounted to an aerial vehicle, such as a fixed-wing aircraft, and can produce thrust for propulsion of the aerial vehicle (see, e.g., FIGS. 1 through 11). The unducted fan propulsor 200 is a “three-stream engine” for the embodiment depicted, in that its architecture provides three distinct streams of thrust-producing airflow during operation.

For reference, the unducted fan propulsor 200 defines an axial direction A, a radial direction R, and a circumferential direction C. Moreover, the unducted fan propulsor 200 defines an axial centerline or longitudinal axis 212 that extends along the axial direction A. In general, the axial direction A extends parallel to the longitudinal axis 212, the radial direction R extends outward from and inward to the longitudinal axis 212 in a direction orthogonal to the axial direction A, and the circumferential direction extends three hundred sixty degrees (360°) around the longitudinal axis 212. The unducted fan propulsor 200 extends between a forward end 214 and an aft end 216, e.g., along the axial direction A.

The unducted fan propulsor 200 includes a core engine 218 and a fan section 250 positioned upstream thereof. Generally, the core engine 218 includes, in serial flow order, a compressor section, a combustion section, a turbine section, and an exhaust section. Particularly, as shown in FIG. 12, the core engine 218 includes an engine core 220 and a core cowl 222 that annularly surrounds the engine core 220. The engine core 220 and core cowl 222 define an annular core inlet 224. The core cowl 222 further encloses and supports a booster or low pressure compressor 226 for pressurizing the air that enters the core engine 218 through core inlet 224. A high pressure, multi-stage, axial-flow compressor 228 receives pressurized air from the LP compressor 226 and further increases the pressure of the air. The pressurized air stream flows downstream to a combustor 230 where fuel is injected into the pressurized air stream and ignited to raise the temperature and energy level of the pressurized air.

The high energy combustion products flow from the combustor 230 downstream to a high pressure turbine (“HP turbine”) 232. The high pressure turbine 232 drives the high pressure compressor (“HP compressor”) 228 through a first shaft or HP shaft (“HP shaft”) 236. In this regard, the HP turbine 232 is drivingly coupled with the HP compressor 228. The high energy combustion products then flow to an LP turbine (“LP turbine”) 234. The LP turbine 234 drives the LP compressor (“LP compressor”) 226, components of the fan section 250, and an electric machine 300 through a second shaft or LP shaft (“LP shaft”) 238. In this regard, the LP turbine 234 is drivingly coupled with the LP compressor 226, components of the fan section 250, and the electric machine 300. The LP shaft 238 is coaxial with the HP shaft 236 in this example embodiment. After driving each of the turbines 232, 234, the combustion products exit the core engine 218 through a core exhaust nozzle 240 to produce propulsive thrust. Accordingly, the core engine 218 defines a core flowpath or core duct 242 that extends between the core inlet 224 and the core exhaust nozzle 240. The core duct 242 is an annular duct positioned generally inward of the core cowl 222 along the radial direction R.

The fan section 250 includes a primary fan 252. For the depicted embodiment of FIG. 12, the primary fan 252 is an open rotor or unducted primary fan 252. As depicted, the primary fan 252 includes an array of fan blades 154 (only one shown in FIG. 12). The fan blades 154 are rotatable, e.g., about the longitudinal axis 212. As noted above, the primary fan 252 is drivingly coupled with the LP turbine 234 via the LP shaft 238. The primary fan 252 can be directly coupled with the LP shaft 238, e.g., in a direct-drive configuration. Optionally, as shown in FIG. 12, the primary fan 252 can be coupled with the LP shaft 238 via a speed reduction gearbox 255, e.g., in an indirect-drive or geared-drive configuration.

Moreover, the fan blades 154 can be arranged in equal spacing around the longitudinal axis 212. Each blade 154 has a root and a tip and a span defined therebetween. Each blade 154 defines a central blade axis 256. For this embodiment, each blade 154 of the primary fan 252 is rotatable about their respective central blades axes 256, e.g., in unison with one another. One or more actuators 258 can be controlled to pitch the blades 154 about their respective central blades axes 256. However, in other embodiments, each blade 154 may be fixed or unable to be pitched about its central blade axis 256.

The fan section 250 further includes a fan guide vane array 260 that includes fan guide vanes 262 (only one shown in FIG. 12) disposed around the longitudinal axis 212. For this embodiment, the fan guide vanes 262 are not rotatable about the longitudinal axis 212. Each fan guide vane 262 has a root and a tip and a span defined therebetween. The fan guide vanes 262 may be unshrouded as shown in FIG. 12 or may be shrouded, e.g., by an annular shroud spaced outward from the tips of the fan guide vanes 262 along the radial direction R. Each fan guide vane 262 defines a central blade axis 264. For this embodiment, each fan guide vane 262 of the fan guide vane array 260 is rotatable about their respective central blades axes 264, e.g., in unison with one another. One or more actuators 266 can be controlled to pitch the fan guide vane 262 about their respective central blades axes 264. However, in other embodiments, each fan guide vane 262 may be fixed or unable to be pitched about its central blade axis 264. The fan guide vanes 262 are mounted to a fan cowl 270.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan flowpath or fan duct 272. Incoming air may enter through the fan duct 272 through a fan duct inlet 276 and may exit through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of substantially radially-extending, circumferentially-spaced struts 274 (only one shown in FIG. 12). The struts 274 may each be aerodynamically contoured to direct air flowing thereby. Other struts in addition to struts 274 may be used to connect and support the fan cowl 270 and/or core cowl 222.

The unducted fan propulsor 200 also defines or includes an inlet duct 280. The inlet duct 280 extends between an engine inlet 282 and the core inlet 224/fan duct inlet 276. The engine inlet 282 is defined generally at the forward end of the fan cowl 270 and is positioned between the primary fan 252 and the array of fan guide vanes 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a nose of a splitter 244 of the core cowl 222. The inlet duct 280 is wider than the core duct 242 along the radial direction R. The inlet duct 280 is also wider than the fan duct 272 along the radial direction R.

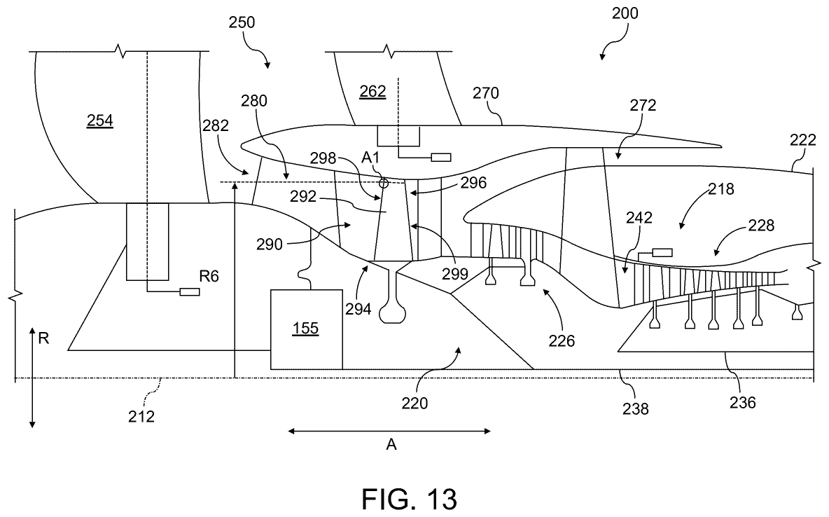

Referring now to FIGS. 12 and 13, FIG. 13 provides a close-up, schematic cross-sectional view of a forward portion of the unducted fan propulsor 200. As depicted, the fan section 250 also includes a mid-fan 290. The mid-fan 290 includes an array of mid-fan blades 292 (only one shown in FIGS. 12 and 13). The mid-fan blades 292 are rotatable, e.g., about the longitudinal axis 212. The mid-fan 290 is drivingly coupled with the LP turbine 234 via the LP shaft 238. The mid-fan blades 292 can be arranged in equal circumferential spacing around the longitudinal axis 212. As shown best in FIG. 13, each mid-fan blade 292 has a root 294 and a tip 296 and a span defined therebetween. Moreover, each mid-fan blade 292 has a leading edge 298 and a trailing edge 299. The mid-fan blades 292 are annularly surrounded or ducted by the fan cowl 270. In this regard, the mid-fan 290 is positioned inward of the fan cowl 270 along the radial direction R. Moreover, for this example embodiment, the mid-fan 290 is positioned within the inlet duct 280 upstream of both the core duct 242 and the fan duct 272.

Accordingly, air flowing through the inlet duct 280 flows across the mid-fan blades 292 and is accelerated downstream thereof, particularly at the tips 296 of the mid-fan blades 292. At least a portion of the air accelerated by the mid-fan blades 292 flows into the fan duct 272 and is ultimately exhausted through the fan exhaust nozzle 278 to produce propulsive thrust. Also, at least a portion of the air accelerated by the mid-fan blades 292 flows into the core duct 242 and is ultimately exhausted through the core exhaust nozzle 240 to produce propulsive thrust. Generally, the mid-fan 290 is a compression device positioned downstream of the engine inlet 282. The mid-fan 290 is operable to accelerate air into the fan duct 272 or secondary bypass passage.

Embodiments of the engine, system, and methods provided herein generate an increased unducted rotor efficiency at and above a threshold power loading (i.e., power/area of rotor airfoil). In certain embodiments, the threshold power loading is 25 horsepower per ft² or greater at cruise altitude. In particular embodiments of the engine, structures and methods provided herein generate power loading between 25 horsepower/ft² and 200 horsepower/ft² at cruise altitude. Cruise altitude has the meaning described hereinabove with reference to the “cruise speed” description.

As such, it will be appreciated that an engine of such a configuration is configured to generate between about 25,000 and 35,000 pounds of thrust during operation at a rated speed.

For the exemplary embodiment of FIG. 12, the primary fan 252 includes twelve (12) fan blades 154. From a loading standpoint, such a blade count may allow a span of each blade 154 to be reduced such that the overall diameter of the primary fan 252 may also be reduced (e.g., to about twelve feet in the exemplary embodiment). That said, in other embodiments, the primary fan 252 may have any suitable blade count and any suitable diameter. In certain suitable embodiments, the primary fan 252 includes at least eight (8) blades 154. In another suitable embodiment, the primary fan 252 may have at least twelve (12) blades 154. In yet another suitable embodiment, the primary fan 252 may have at least fifteen (15) blades 154. In yet another suitable embodiment, the primary fan 252 may have at least eighteen (18) blades 154. In one or more of these embodiments, the primary fan 252 includes twenty-six (26) or fewer blades 154, such as twenty (20) or fewer blades 154. Further, in certain exemplary embodiments, the primary fan 252 may define a diameter of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 16 feet.

In various embodiments, it will be appreciated that the unducted fan propulsor 200 includes a ratio of a quantity of vanes 262 to a quantity of blades 154 that could be less than, equal to, or greater than 1:1. For example, in certain embodiments, the unducted fan propulsor 200 may include a ratio of a quantity of vanes 262 to a quantity of blades 154 between 1:2 and 5:2. The ratio may be tuned based on a variety of factors including a size of the vanes 262 to ensure a desired amount of swirl is removed for an airflow from the primary fan 252.

It should be appreciated that various embodiments of the single unducted rotor engine depicted and described herein may allow for normal subsonic aircraft cruise altitude operation at or above Mach 0.5. In certain embodiments, the engine 200 allows for normal aircraft operation between Mach 0.55 and Mach 0.85 at cruise altitude. In certain embodiments, the engine 200 allows for fan tip speeds (i.e., the tip speeds of the rotor blades 154) at or less than 750 feet per second (fps). As will further be appreciated from the description herein, a loading of the rotor blades 154 of the primary fan 252 or rotor assembly may facilitate such flight speeds.

In addition, the unducted fan propulsor 200 can be arranged to define a primary fan radius to mid-fan radius ratio. The primary fan radius to mid-fan radius ratio is defined as:

$$Primary Fan Radius / Mid - Fan Radius \qquad ( Ratio 1 )$$

The Primary Fan Radius is measured as a radial length or radius spanning along the radial direction R between the longitudinal axis 212 and a leading edge tip of one of the fan blades 154 of the primary fan 252. Particularly, as shown best in FIG. 12, the Primary Fan Radius is measured as Radius R7, which spans along the radial direction R between the longitudinal axis 212 and a leading edge tip of one of the primary fan blades 154. The Mid-Fan Radius is measured as a radial length or radius spanning along the radial direction R between the longitudinal axis 212 and a leading edge tip of one of the mid-fan blades 292 of the mid-fan 290. Particularly, as shown best in FIG. 13, the Mid-Fan Radius is measured as Radius R6, which spans along the radial direction R between the longitudinal axis 212 and a leading edge tip of one of the mid-fan blades 292.

In some embodiments, the unducted fan propulsor 200 defines the primary fan radius to mid-fan radius ratio as being equal to or greater than 2.0 and less than or equal to 6.5. Particularly, in some embodiments, the unducted fan propulsor 200 defines the primary fan radius to mid-fan radius ratio as being at least about 2.0. In other embodiments, the unducted fan propulsor 200 defines the primary fan radius to mid-fan radius ratio as being at least about 2.5. In yet other embodiments, the unducted fan propulsor 200 defines the primary fan radius to mid-fan radius ratio as being at least about 3.0. For instance, in FIG. 12, the primary fan radius to mid-fan radius ratio is slightly greater than 3.0. In some further embodiments, the unducted fan propulsor 200 defines the primary fan radius to mid-fan radius ratio as being at least about 4.0. In yet other embodiments, the unducted fan propulsor 200 defines the primary fan radius to mid-fan radius ratio as being at least about 6.0. In some other embodiments, the unducted fan propulsor 200 defines the primary fan radius to mid-fan radius ratio as being about 6.5. For the embodiments having the stated lower bounds of the primary fan radius to mid-fan radius ratio mentioned in this paragraph, unless stated otherwise, the upper bound of these noted ratios may be up to 6.5. The inventors of the present disclosure have recognized that three-stream engines having a primary fan and mid-fan arranged according to the noted ranges/ratios advantageously balance aerodynamic performance and engine efficiency with mechanical constraints of the primary fan and mid-fan.

With reference to FIG. 12, operation of the unducted fan propulsor 200 may be summarized in the following exemplary manner. During operation, an initial or incoming airflow passes through the fan blades 154 of the primary fan 252 and splits into a first airflow and a second airflow. The first airflow bypasses the engine inlet 282 and flows generally along the axial direction A outward of the fan cowl 270 along the radial direction R. The first airflow accelerated by the primary fan blades 154 passes through the fan guide vanes 262 and continues downstream thereafter to produce a primary propulsion stream or first thrust stream S1. The vast majority of the net thrust produced by the unducted fan propulsor 200 is produced by the first thrust stream S1. The second airflow enters the inlet duct 280 through annular engine inlet 282.

The second airflow flowing downstream through the inlet duct 280 flows through the mid-fan blades 292 of the mid-fan 290 and is consequently compressed. The second airflow flowing downstream of the mid-fan 290 is split by the splitter 244 located at the forward end of the core cowl 222. Particularly, a portion of the second airflow flowing downstream of the mid-fan 290 flows into the core duct 242 through the core inlet 224. The portion of the second airflow that flows into the core duct 242 is progressively compressed by the LP compressor 226 and HP compressor 228 and is ultimately discharged into the combustion section. The discharged pressurized air stream flows downstream to the combustor 230 where fuel is introduced to generate combustion gases or products.

More particularly, the combustor 230 defines an annular combustion chamber that is generally coaxial with the longitudinal centerline axis 212. The combustor 230 receives an annular stream of pressurized air from the HP compressor 228 via a pressure compressor discharge outlet. A portion of this compressor discharge air flows into a mixer (not shown). Fuel is injected by a fuel nozzle to mix with the air thereby forming a fuel-air mixture that is provided to the combustion chamber for combustion. Ignition of the fuel-air mixture is accomplished by one or more suitable igniters, and the resulting combustion gases flow along the axial direction A toward and into an annular, first stage turbine nozzle of the HP turbine 232. The first stage nozzle is defined by an annular flow channel that includes a plurality of radially-extending, circumferentially-spaced nozzle vanes that turn the gases so that they flow angularly and impinge upon the first stage turbine blades of the HP turbine 232. The combustion products exit the HP turbine 232 and flow through the LP turbine 234 and exit the core duct 242 through the core exhaust nozzle 240 to produce a core air stream or second thrust stream S2. For this embodiment, as noted above, the HP turbine 232 drives the HP compressor 228 via the HP shaft 236 and the LP turbine 234 drives the LP compressor 226, the primary fan 252, the mid-fan 290, and the electric machine 300 via the LP shaft 238.

The other portion of the second airflow flowing downstream of the mid-fan 290 is split by the splitter 244 into the fan duct 272. The air enters the fan duct 272 through the fan duct inlet 276. The air flows generally along the axial direction A through the fan duct 272 and is ultimately exhausted from the fan duct 272 through the fan exhaust nozzle 278 to produce a third thrust stream S3.

A “third stream” or third thrust stream S3 as used herein means a secondary air stream capable of increasing fluid energy to produce a minority of total propulsion system thrust. In some embodiments, a pressure ratio of the third stream is higher than that of the primary propulsion stream (e.g., a bypass or propeller driven propulsion stream). The thrust may be produced through a dedicated nozzle or through mixing of the secondary air stream with the primary propulsion stream or a core air stream, e.g., into a common nozzle. In certain exemplary embodiments, an operating temperature of the secondary air stream is less than a maximum compressor discharge temperature for the engine. The operating temperature of the third stream may be less than 350 degrees Fahrenheit (such as less than 300 degrees Fahrenheit, such as less than 350 degrees Fahrenheit, such as less than 300 degrees Fahrenheit, and at least as great as an ambient temperature). In certain exemplary embodiments, these operating temperatures may facilitate heat transfer to or from the third stream and a separate fluid stream. Further, in certain exemplary embodiments, the third stream may contribute less than 50% of the total engine thrust (and at least, e.g., 2% of the total engine thrust) at a takeoff condition, or more particularly while operating at a rated takeoff power at sea level, static flight speed, 86 degree Fahrenheit ambient temperature operating conditions. Furthermore in certain exemplary embodiments, aspects of the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

Although unducted fan propulsor 200 has been described and illustrated in FIG. 12 as representing an example three-stream gas turbine engine operable to produce first thrust stream S1, second thrust stream S2, and third thrust stream S3, it will be appreciated that the inventive aspects of the present disclosure may apply to three-stream gas turbine engines having other configurations.

Further, for the depicted embodiment of FIG. 12, the unducted fan propulsor 200 includes an electric machine operably coupled with a rotating component thereof. In this regard, the unducted fan propulsor 200 is an aeronautical hybrid-electric propulsion machine. Particularly, as shown in FIG. 1, the unducted fan propulsor 200 includes electric machine 300 operatively coupled with the LP shaft 238. The electric machine 300 can be directly mechanically connected to the LP shaft 238, or alternatively, the electric machine 300 can be mechanically coupled with the LP shaft 238 indirectly, e.g., by way of a gearbox 380. Further, although the electric machine 300 is operatively coupled with the LP shaft 238 at an aft end of the LP shaft 238, the electric machine 300 can be coupled with the LP shaft 238 at any suitable location or can be coupled to other rotating components of the unducted fan propulsor 200, such as the HP shaft 236.

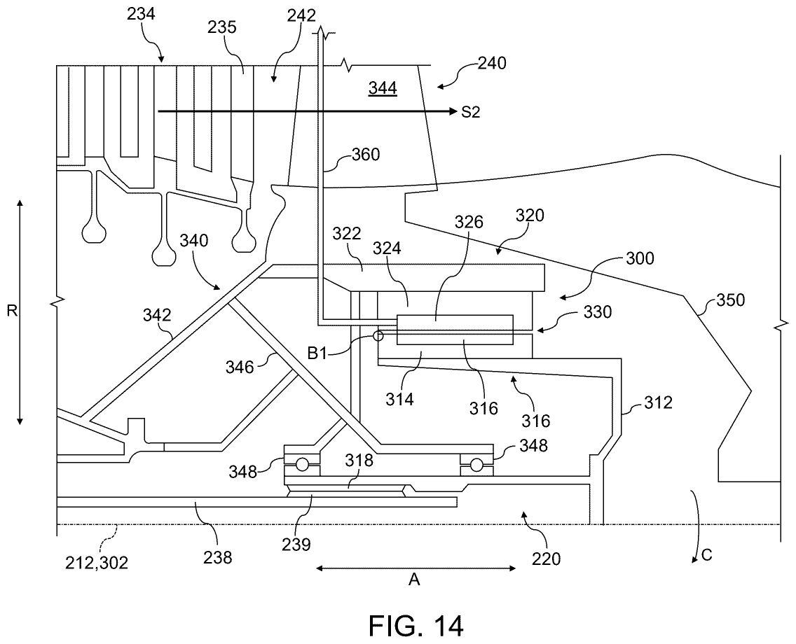

In some embodiments, the electric machine 300 can be an electric motor operable to drive or motor the LP shaft 238, e.g., during an engine burst. In other embodiments, the electric machine 300 can be an electric generator operable to convert mechanical energy into electrical energy. In this way, electrical power generated by the electric machine 300 can be directed to various engine and/or aircraft systems. In some embodiments, the electric machine 300 can be a motor/generator with dual functionality. The electric machine 300 will be further described below with respect to FIG. 14.

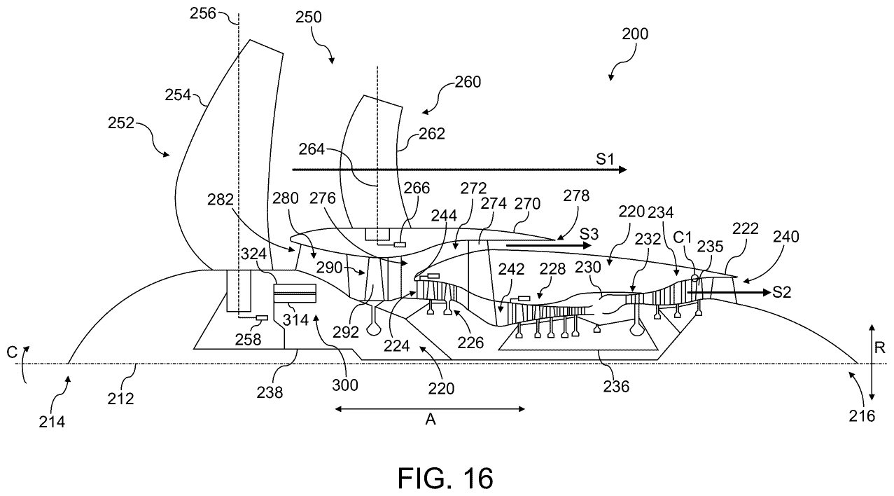

With reference now to FIGS. 12 and 14, FIG. 14 provides a close-up schematic view of the electric machine 300 embedded within the unducted fan propulsor 200. As shown, the electric machine 300 is embedded within the unducted fan propulsor 200 proximate its aft end 216. Particularly, the electric machine 300 is positioned aft of the mid-fan 290 and at least partially overlapping with or aft of the LP turbine 234 along the axial direction A. Moreover, for this embodiment, the electric machine 300 is positioned inward of the core duct 242 along the radial direction R. The electric machine 300 is operatively coupled with the LP shaft 238, as noted above. It will be appreciated that in other exemplary embodiments the electric machine 300 may be positioned at other suitable locations within the unducted fan propulsor 200. For instance, in some embodiments, the electric machine 300 can be coupled with the LP shaft 238 and positioned forward of the mid-fan 290 along the axial direction, e.g., as shown in FIG. 16.

Referring to FIG. 14, the electric machine 300 includes a rotor assembly 310 and a stator assembly 320. The electric machine 300 also defines a centerline 302, which is aligned with or coaxial with the longitudinal axis 212 of the unducted fan propulsor 200 in this example embodiment. The rotor assembly 310 includes a rotor connection member 312 and a rotor 314. The stator assembly 320 similarly includes stator connection member 322 and a stator 324. The rotor 314 of the rotor assembly 310 and the stator 324 of the stator assembly 320 together define an air gap 330 therebetween. Moreover, for this embodiment, the rotor 314 includes a plurality of magnets 316, such as a plurality of permanent magnets, and the stator 324 includes a plurality of windings or coils 326. As such, the electric machine 300 may be referred to as a permanent magnet electric machine. However, in other exemplary embodiments, the electric machine 300 may be configured in any suitable manner. For example, the electric machine 300 may be configured as an electromagnetic electric machine, including a plurality of electromagnets and active circuitry, as an induction type electric machine, a switched reluctance type electric machine, a synchronous AC electric machine, an asynchronous electric machine, or as any other suitable electric generator/motor.

For this embodiment, the rotor assembly 310 of the electric machine 300 is coupled with or attached to the LP shaft 238. In this manner, the rotor assembly 310 is rotatable with the LP shaft 238. The attachment of the rotor assembly 310 to the LP shaft 238 will be described in more detail below. The stator assembly 320 is coupled with or attached to a structural support member 342 of the turbine section. More specifically, the stator connection member 322 extends from the structural support member 342 to the stator 324 to support the stator 324. The structural support member 342 is configured as part of an aft frame assembly 340. The aft frame assembly 340 further includes an aft frame strut 344 extending through the core duct 242 of the core engine 218. The aft frame strut 344 provides structural support for the unducted fan propulsor 200. The structural support member 342 extends from an inner end of the aft frame strut 344 along the radial direction R.

The unducted fan propulsor 200 further includes a cavity wall 350 surrounding at least a portion of the electric machine 300. More specifically, the cavity wall 350 substantially completely surrounds the electric machine 300, extending from a location proximate a forward end of the electric machine 300 to a location aft of the electric machine 300 along the axial direction A. The cavity wall 350 may function as, e.g., a cooling air cavity wall, a sump for cooling fluid, a protective cover for the electric machine 300, etc. For example, in certain embodiments, the unducted fan propulsor 200 may further include a second cavity wall (not shown) to form a buffer cavity surrounding the electric machine 300 and thermally protect the electric machine 300.

During certain operations of the unducted fan propulsor 200, the LP shaft 238 rotates the rotor assembly 310 of the electric machine 300, allowing the electric machine 300 to generate electrical power. Thus, the electric machine 300 is operable in a generator mode. In some embodiments, in addition or alternatively to being operable in a generator mode, the electric machine 300 is operable in a drive mode during certain operations of the unducted fan propulsor 200. In a drive mode, the rotor assembly 310 of the electric machine 300 drives the LP shaft 238. The electric machine 300 is electrically connected to an electric power bus 360. The electric power bus 360 is electrically connected to the electric machine 300 at a location inward of the core duct 242 along the radial direction R. The electric power bus 360 may extend through the core duct 242 (e.g., through the aft frame strut 344) and electrically connect the electric machine 300 to one or more electrical loads (accessory systems, electric/hybrid-electric propulsion devices, etc.), electrical sources (other electric machines, electric energy storage units, etc.), or both. Electrical power can be provided to the electric machine 300 via the electric power bus 360, e.g., when the electric machine 300 is operating in a drive mode, and electrical power generated by the electric machine 300 can be carried or transmitted to electrical systems via the electric power bus 360, e.g., when the electric machine 300 is operating in a generator mode.

As noted above, the rotor assembly 310 is coupled to the LP shaft 238 in this embodiment. As depicted, the rotor connection member 312 extends between the LP shaft 238 and the rotor 314 for connecting the rotor 314 to the LP shaft 238. For the embodiment shown, the rotor connection member 312 is connected to the LP shaft 238 through a splined connection. More particularly, the rotor connection member 312 includes a connection portion having a plurality of teeth 318 extending generally along the axial direction A, and similarly, the LP shaft 238 includes a connection portion having a plurality of teeth 239 extending generally along the axial direction A. The plurality of teeth 318 of the rotor connection member 312 are configured to engage with the plurality of teeth 239 of the LP shaft 238, fixing the two components to one another. In alternative embodiments, the rotor connection member 312 may be coupled to the LP shaft 238 in any other suitable manner. One or more bearings 348 coupled with an extension support member 346 of the aft frame assembly 340 may support the rotor connection member 312 relative to the LP shaft 238.

Although the electric machine 300 has been described and illustrated in FIG. 14 as having a particular configuration, it will be appreciated that the inventive aspects of the present disclosure may apply to electric machines having alternative configurations. For instance, the stator assembly 320 and/or rotor assembly 310 may have different configurations or may be arranged in a different manner than illustrated in FIG. 14. As one example, in some embodiments, the electric machine 300 may have a tapered configuration in which the rotor 314 and the stator 324 may extend lengthwise along the axial direction A at an angle with respect to the longitudinal axis 212, e.g., so that they are not oriented parallel with the longitudinal axis 212.

Notably, the inventors of the present disclosure discovered, during the course developing the aforementioned embodiments, certain operating and geometric relationships between various components of three-stream gas turbine engines having an embedded electric machine that provide certain advantages over conventional turbofan engines. Additionally, the inventors discovered, during the course of conceiving various embodiments of turbomachines (including those illustrated and described above), certain relationships, which if adopted for a turbomachine can simplify the selection, integration or development process for other subsystems residing within the overall architecture, in addition to providing the noted advantages inherent in the selection of one or more these relationships for an engine. As one example, a three-stream engine having an embedded electric machine, such as disclosed in FIGS. 12, 13, and 14 as well as in other noted embodiments provided herein, may include components operating or arranged geometrically in advantageous relationships, as explained in greater detail below. Ultimately, adoption of a three-stream engine having an embedded electric machine as disclosed herein can provide significant fuel burn advantages over conventional turbofans, among other benefits, which also takes into account the operational, integration, and sizing constraints for a turbomachine adopting such an architecture. Additionally, the disclosure informs the skilled artisan of the impact that such an architecture has on an overall propulsive system, how related systems may be selected as suitable or not suitable, where subsystems can be located and what the operational, environmental, etc. requirements may be, based on the relationships defined herein.

With reference now to FIGS. 12, 13, and 14, as noted, the electric machine 300 and the mid-fan 290 are operatively coupled with the LP shaft 238. In this regard, the electric machine 300 and the mid-fan 290 are both tied to the LP shaft 238 and can operate at a tip speed ratio with respect to one another. The tip speed ratio can be constant, particularly during high efficiency operations and excluding situations where the electric machine 300 is decoupled from the LP shaft 238, e.g., by way of a clutch (not shown). The tip speed ratio is defined by a tip speed of the rotor 314 of the electric machine 300 to a tip speed of one of the mid-fan blades 292 of the mid-fan 290. Stated another way, the tip speed ratio may be defined as:

$$EM Tip Speed / Mid - Fan Tip Speed \qquad ( Ratio 2 )$$

The EM Tip Speed is measured at an outermost point of the rotor 314 of the electric machine 300, e.g., at a location B1 depicted in FIG. 14. The outermost point of the rotor 314 is defined as the outermost point of the rotor 314 along the radial direction R with respect to the longitudinal axis 212. The Mid-Fan Tip Speed is measured at a leading edge tip of one of the mid-fan blades 292, e.g., at a location A1 depicted in FIG. 13. The tip speeds can be measured in any suitable units of speed, such as meters per second. The same unit of speed is to be used for both the EM Tip Speed and the Mid-Fan Tip Speed when determining the tip speed ratio. In some embodiments, when the unducted fan propulsor 200 is operated, the rotor 314 of the electric machine 300 has a rotor tip speed being equal to or greater than 50 meters per second and less than or equal to 300 meters per second. In yet other embodiments, when the unducted fan propulsor 200 is operated, the rotor 314 of the electric machine 300 has a rotor tip speed being equal to or greater than 240 meters per second and less than or equal to 290 meters per second. Such a rotor tip speed range is particularly suited for electric machines operated and arranged as shown in FIGS. 12, 14, and 15, e.g., in a “tail cone” or aft position. Such a rotor tip speed range is also particularly suited for electric machines operated and arranged as shown in FIGS. 12, 14, and 15 except that the electric machine has an outer rotor configuration instead of the inner rotor configuration shown in FIGS. 12, 14, and 15. However, as noted, the rotor 314 of the electric machine 300 may have a rotor tip speed being equal to or greater than 50 meters per second and less than or equal to 300 meters per second.

In some embodiments, the unducted fan propulsor 200 is operated so as to define the tip speed ratio as being equal to or greater than 0.2 and less than or equal to 1.0. In this regard, the speed of the tip of the rotor 314 of the electric machine 300 is less than or equal to the leading edge tip speed of one of the mid-fan blades 292 of the mid-fan 290. The range for the tip speed ratio captures the architectural and operating relationship between the mid-fan 290 and the electric machine 300 of the unducted fan propulsor 200, both of which are coupled to the LP shaft 238. The electric machine tip speed defines the mechanical and operating constraints associated with the electric machine 300 while the mid-fan tip speed defines the mechanical and operating constraints associated with the mid-fan 290. The inventors of the present disclosure have recognized that three-stream engines operated so as to define the tip speed ratio within one or more of the noted ranges have certain architectural and operating advantages. For instance, operating a three-stream engine within the noted ranges for the tip speed ratio can prevent unacceptable penalties on the power density of the electric machine 300, can prevent too much tip speed on the mid-fan 290, and can prevent the mechanical capabilities of electrical components of the electric machine 300 from exceeding their limits, among other benefits.

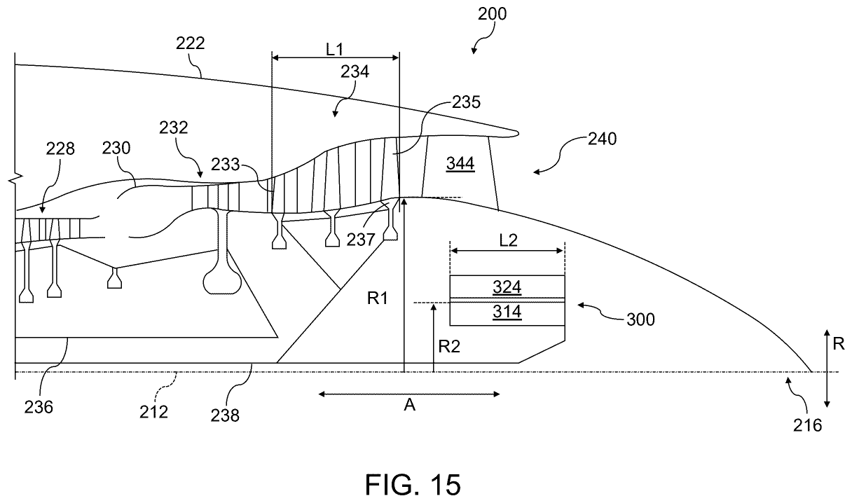

Referring still to FIGS. 12 through 14 and also to FIG. 15, in some embodiments, the unducted fan propulsor 200 can be arranged to define a mid-fan radius to electric machine radius ratio. The mid-fan radius to electric machine radius ratio is defined as:

$$Mid - Fan Radius / EM Tip Radius \qquad ( Ratio 3 )$$

The mid-fan radius to electric machine radius ratio can be a fixed ratio as these two radii can be fixed. The Mid-Fan Radius is measured as a radial length or radius spanning along the radial direction R between the longitudinal axis 212 and a leading edge tip of one of the mid-fan blades 292 of the mid-fan 290. Particularly, as shown best in FIG. 13, the Mid-Fan Radius is measured as Radius R6, which spans along the radial direction R between the longitudinal axis 212 and a leading edge tip of one of the mid-fan blades 292. As shown best in FIG. 15, the EM Tip Radius is measured as a Radius R2 spanning along the radial direction R between the longitudinal axis 212 and an outermost point of the rotor 314 of the electric machine 300.

In some embodiments, the unducted fan propulsor 200 defines the mid-fan radius to electric machine radius ratio as being equal to or greater than 1.33 and less than or equal to 3.8. In some further embodiments, the unducted fan propulsor 200 defines the mid-fan radius to electric machine radius ratio as being equal to or greater than 2.5 and less than or equal to 3.3. In yet other embodiments, the unducted fan propulsor 200 defines the mid-fan radius to electric machine radius ratio as being equal to or greater than 2.9 and less than or equal to 3.2. The ranges for the mid-fan radius to electric machine radius ratio capture the architectural and operating relationship between the electric machine 300 and the mid-fan 290 of the unducted fan propulsor 200, both of which are coupled to the LP shaft 238 in such example embodiments.

Particularly, the inventors of the present disclosure have recognized that three-stream engines having an electric machine and mid-fan arranged according to the noted ranges advantageously balance aerodynamic performance and mechanical constraints of the mid-fan with electric machine performance, mechanical capabilities of electrical components of the electric machine, physical space required for the electric machine, and thermal management of the electric machine. For instance, in accordance with the noted ranges for the mid-fan radius to electric machine radius ratio, the mid-fan may be positioned far enough from the longitudinal axis so that a satisfactory thrust contribution is produced by the third stream and so that acceptable efficiency is achieved, and further, the mid-fan is positioned close enough to the longitudinal axis so that shock losses from supersonic tip speeds do not unduly affect performance and so that the weight of the mid-fan is acceptable. The noted ranges allow for the mid-fan to be arranged to achieve these advantages whilst preventing unacceptable penalties on the power density of the electric machine as well as preventing the mechanical capabilities of electrical components of the electric machine from exceeding their limits.

Referring still to FIGS. 12 through 15, in some embodiments, the unducted fan propulsor 200 can be arranged to define an electric machine length to LP turbine length ratio. The electric machine length to LP turbine length ratio is defined by an axial length of the electric machine 300 to an axial length of the LP turbine 234. Stated another way, the electric machine length to LP turbine length ratio may be defined as:

$$EM Length / LPT Length \qquad ( Ratio 4 )$$

The electric machine length to LP turbine length ratio can be a fixed ratio as the axial length of the electric machine 300 and the axial length of the LP turbine 234 are fixed. The EM Length is measured as the axial length of the electric machine 300. Particularly, as illustrated in FIG. 15, the axial length of the electric machine 300 is defined as a length L2 spanning along the axial direction A between a leading edge of the rotor 314 and a trailing edge of the rotor 314 of the electric machine 300. The LPT Length is measured as the axial length of the LP turbine 234. More specifically, as shown best in FIG. 15, the axial length of the LP turbine 234 is defined as a length L1 spanning along the axial direction A between a leading edge of a hub of one of the first stage turbine blades 233 of the LP turbine 234 to a trailing edge of a hub of one of the last stage turbine blades 235 of the LP turbine 234. The same unit of length is to be used for both the EM Length and the LPT Length when determining the electric machine length to LP turbine length ratio.

In some embodiments, the electric machine 300 and the LP turbine 234 of the unducted fan propulsor 200 define the electric machine length to LP turbine length ratio as being equal to or greater than 0.01 and less than or equal to 3.0. In other embodiments, the electric machine length to LP turbine length ratio is equal to or greater than 0.01 and less than or equal to 0.5, equal to or greater than 0.3 and less than or equal to 1.0, or greater than 1.0 and less than or equal to 3.0, or greater than 2.0 and less than or equal to 3.0. The ranges for the electric machine length to LP turbine length ratio capture the architectural and operating relationship between the electric machine 300 and the LP turbine 234 of the unducted fan propulsor 200, both of which are coupled to the LP shaft 238 in such example embodiments. More specifically, the inventors of the present disclosure have recognized that three-stream engines having an electric machine and LP turbine arranged according to the noted range advantageously balance weight and loading or efficiency considerations of the LP turbine with the space, size, and performance requirements of the electric machine.

Referring still to FIGS. 12 through 15, in some embodiments, the unducted fan propulsor 200 can be arranged to define an electric machine tip radius to LP turbine last stage hub radius ratio. The electric machine tip radius to LP turbine last stage hub radius ratio may be defined as:

$$EM Tip Radius / LPT Last Stage Blade Hub Radius \qquad ( Ratio 5 )$$

The electric machine tip radius to LP turbine last stage hub radius ratio can be a fixed ratio as these two radii can be fixed. The EM Tip Radius is measured as a Radius R2 spanning along the radial direction R between the longitudinal axis 212 and an outermost point of the rotor 314 of the electric machine 300. The LPT Last Stage Blade Hub Radius is measured as a radial length or radius spanning along the radial direction R between the longitudinal axis 212 and an outermost point of a hub of one of the last stage turbine blades 235 of the LP turbine 234. Particularly, as shown best in FIG. 15, the LPT Last Stage Blade Hub Radius is measured as Radius R1, which spans along the radial direction R between the longitudinal axis 212 and an outermost point taken at the trailing edge of a hub 237 of one of the last stage turbine blades 235 of the LP turbine 234. The outermost point taken at the trailing edge of the hub 237 is the outermost point of the hub 237 with respect to the longitudinal axis 212 along the radial direction R.

In some embodiments, the LP turbine 234 and the electric machine 300 of the unducted fan propulsor 200 define the electric machine tip radius to LP turbine last stage hub radius ratio as being equal to or greater than 0.1 and less than or equal to 1.0, or equal to or greater than 0.1 and less than or equal to 0.5, or equal to or greater than 0.4 and less than or equal to 1.0, or equal to or greater than 0.7 and less than or equal to 1.0. The ranges for the electric machine tip radius to LP turbine last stage hub radius ratio capture the architectural and operating relationship between the electric machine 300 and the LP turbine 234 of the unducted fan propulsor 200, both of which are coupled to the LP shaft 238.

The inventors of the present disclosure have recognized that three-stream engines having an electric machine and LP turbine arranged according to the noted range advantageously balances the geometry constraints and operating performance and efficiency of the LP turbine and electric machine, and also accounts for thermal constraints associated with the electric machine, particularly for three-stream engines having an embedded electric machine positioned as shown best in FIGS. 12, 14, and 15. Specifically, the inventors have recognized that architectures with the noted range result in two optimizations. In accordance with the noted range of the electric machine tip radius to LP turbine last stage hub radius ratio, the LP turbine is positioned far enough from the longitudinal axis to provide satisfactory turbine efficiency as well as physical space for the electric machine while not being positioned too far from the longitudinal axis to make installation and packaging of the engine unworkable. Further, in accordance with the noted range of the electric machine tip radius to LP turbine last stage hub radius ratio, the electric machine is positioned far enough from the longitudinal axis to provide satisfactory electric machine performance whilst also accounting for the thermal constraints associated with the electric machine.

In addition, as noted previously, the mid-fan 290 and the LP turbine 234 are operatively coupled with the LP shaft 238. In this regard, the mid-fan 290 and the LP turbine 234 are both tied to the LP shaft 238 and can operate so as to define a mid-fan tip speed to LP turbine tip speed ratio. The mid-fan tip speed to LP turbine tip speed ratio can be constant, particularly during high efficiency operations of the unducted fan propulsor 200. The mid-fan tip speed to LP turbine tip speed ratio is defined by a tip speed of one of the mid-fan blades 292 of the mid-fan 290 to a tip speed of a last stage turbine blade 235 (see FIGS. 12 and 14) of the LP turbine 234. Stated another way, the mid-fan tip speed to LP turbine tip speed ratio may be defined as:

$$Mid - Fan Tip Speed / LPT Tip Speed \qquad ( Ratio 6 )$$

As noted above, the Mid-Fan Tip Speed is measured at a leading edge tip of one of the mid-fan blades 292, e.g., at a location A1 depicted in FIG. 13. The LPT Tip Speed is measured at a leading edge tip of one of the last stage turbine blades 235 of the LP turbine 234, e.g., at a location CI depicted in FIG. 1.

In some embodiments, the unducted fan propulsor 200 is operated so as to define the mid-fan tip speed to LP turbine tip speed ratio as being equal to or greater than 0.7 and less than or equal to 1.5. In yet other embodiments, the unducted fan propulsor 200 is operated so as to define the mid-fan tip speed to LP turbine tip speed ratio as being equal to or greater than 0.8 and less than or equal to 1.2. In some further embodiments, the unducted fan propulsor 200 is operated so as to define the mid-fan tip speed to LP turbine tip speed ratio as being equal to or greater than 0.9 and less than or equal to 1.1. Such measurements can be taken at a red line speed of the unducted fan propulsor 200 or at any other speed.

The inventors of the present disclosure have recognized that three-stream engines operated so as to define the mid-fan tip speed to LP turbine tip speed ratio within one or more of the noted ranges have certain architectural and operating advantages. Particularly, operating a three-stream engine within the noted ranges for the mid-fan tip speed to LP turbine tip speed ratio can ensure that the radius of the mid-fan (i.e., a radial length or radius spanning along the radial direction R between the longitudinal axis and a leading edge tip of one of the mid-fan blades of the mid-fan) is optimized relative to the LP turbine architecture. For instance, when the mid-fan radius is too large, the tip speed of the mid-fan may drive unacceptable aerodynamic losses. Moreover, mechanical stresses on the mid-fan may become excessive. In contrast, when the mid-fan radius is too small, the average velocity in the LP turbine blade passage may become too high, which may drive increased aerodynamic losses. Alternatively, the hub radii of the mid-fan blades may need to be reduced to pass the required flow. Consequently, this may increase the engine length due to duct slope limitations and other packaging constraints. The inventors of the present disclosure have taken these considerations into account in developing the noted ranges for the mid-fan tip speed to LP turbine tip speed ratio.

Further, as noted above, the electric machine 300 and the LP turbine 234 are operatively coupled with the LP shaft 238. In this regard, the electric machine 300 and the LP turbine 234 are both tied to the LP shaft 238 and can operate so as to define an LP turbine tip speed to electric machine tip speed ratio. The LP turbine tip speed to electric machine tip speed ratio can be constant, particularly during high efficiency operations and excluding situations where the electric machine 300 is decoupled from the LP shaft 238. The LP turbine tip speed to electric machine tip speed ratio is defined by a tip speed taken at a leading edge of a last stage turbine blade 235 (see FIGS. 12 and 14) of the LP turbine 234 to a tip speed of the rotor 314 of the electric machine 300. Stated another way LP turbine tip speed to electric machine tip speed ratio may be defined as:

$$LPT Tip Speed / EM Tip Speed \qquad ( Ratio 7 )$$

The LPT Tip Speed is measured at a leading edge tip of one of the last stage turbine blades 235 of the LP turbine 234, e.g., at a location CI depicted in FIG. 1. The EM Tip Speed is measured at an outermost point of the rotor 314 of the electric machine 300, e.g., at a location B1 depicted in FIG. 14. As noted previously the outermost point of the rotor 314 is defined as the outermost point of the rotor 314 along the radial direction R with respect to the longitudinal axis 212.

In some embodiments, the unducted fan propulsor 200 is operated so as to define the LP turbine tip speed to electric machine tip speed ratio as being equal to or greater than 0.1 and less than or equal to 1.0, equal to or greater than 0.1 and less than or equal to 0.3, or equal to or greater than 0.5 and less than or equal to 0.9. Such measurements can be taken at a red line speed of the unducted fan propulsor 200 or at any other speed, notwithstanding situations where the electric machine 300 is decoupled from the LP shaft 238. The inventors of the present disclosure have recognized that three-stream engines operated so as to define the LP turbine tip speed to electric machine tip speed ratio within one or more of the noted ranges have certain architectural and operating advantages. For instance, operating a three-stream engine within the noted ranges for the LP turbine tip speed to electric machine tip speed ratio can prevent unacceptable penalties on the power density of the electric machine, can prevent too much tip speed on the LP turbine, can prevent the mechanical capabilities of electrical components of the electric machine 300 from exceeding their limits, among other benefits.

Referring to FIGS. 12 through 15, in some embodiments, the unducted fan propulsor 200 and the electric machine 300 embedded therein are operated so as to define an electric machine power to LP turbine power ratio. The unit of measure for the power output by the electric machine is to be kW and the unit of measure for the power output by the LP turbine is to be horsepower hp when determining the electric machine power to LP turbine power ratio, or stated another way, kW/hp.

$$EM Power / LPT Power \qquad ( Ratio 8 )$$

In some embodiments, the LP turbine 234 and the electric machine 300 of the unducted fan propulsor 200 define the electric machine power to LP turbine power ratio as being equal to or greater than 0.01 and less than or equal to 1.0. In some embodiments, the LP turbine 234 and the electric machine 300 of the unducted fan propulsor 200 can define the electric machine power to LP turbine power ratio as being equal to or greater than 0.01 and less than or equal to 1.0 at flight idle, equal to or greater than 0.01 and less than or equal to 0.2 at flight idle, equal to or greater than 0.1 and less than or equal to 0.45 at flight idle, or equal to or greater than 0.45 and less than or equal to 1.0 at flight idle. Flight idle, as used herein, refers to an engine speed in flight at a given altitude with a throttle set to a minimum, or idle, position. The engine speed may increase with an increase in altitude based on, e.g., ambient air conditions. The inventors of the present disclosure have recognized that three-stream engines having an electric machine and LP turbine arranged and operated according to the noted ranges advantageously balance the geometric and physical space constraints, thermal needs, efficiency, and performance of the electric machine and LP turbine.

With reference still to FIGS. 12 through 15, in some embodiments, the unducted fan propulsor 200, and more particularly, the electric machine 300 embedded therein is operated so as to define a power to voltage ratio. The power to voltage ratio can be constant, particularly during high efficiency operations and excluding situations where the electric machine 300 is decoupled from the LP shaft 238. The power to voltage ratio is defined by an electrical power output by the electric machine 300 in kilowatts to a voltage level of the electric machine 300 in volts of direct current. Stated another way, the power to voltage ratio may be defined as:

$$EM Power / EM Voltage \qquad ( Ratio 9 )$$

As noted, the EM Power is measured as the electrical power output by the electric machine 300 in kilowatts. In some embodiments, the electrical power output by the electric machine 300 ranges from 200 kilowatts to 3 megawatts (200 kW-3MW). Further, the EM Voltage is measured as the voltage level of the electric machine 300 in volts of direct current Vdc. In some embodiments, the voltage level of the electric machine 300 ranges from 270 Vdc to 3 k Vdc. Accordingly, the unit of measure for power is to be kW and the unit of measure for voltage is to be Vdc when determining the power to voltage ratio, or stated another way, kW/Vdc. Such measurements can be taken at a red line speed of the unducted fan propulsor 200 or at any other speed, notwithstanding situations where the electric machine 300 is decoupled from the LP shaft 238.

In some embodiments, the electric machine 300 of the unducted fan propulsor 200 is operated so as to define the power to voltage ratio as being equal to or greater than 0.3 and less than or equal to 2.0. In yet other embodiments, the electric machine 300 of the unducted fan propulsor 200 is operated so as to define the power to voltage ratio as being equal to or greater than 0.35 and less than or equal to 0.5, or equal to or greater than 0.4 and 0.5. The noted ranges for the power to voltage ratio capture the operating relationship between the electrical power associated with the electric machine and the voltage associated with the electric machine.

The inventors of the present disclosure have recognized that three-stream engines having an electric machine arranged as shown and described and operated according to the noted ranges advantageously balances the physical space required for the electric machine, the physical space needed between electrically conducting components of the electric machine, and partial discharge considerations with electric current levels and consequently increased weight of cables and busbars associated with the electric machine and/or power systems of the aircraft. Generally, for higher values of the ratio, more physical space is available and the electric machine is less susceptible to undesirable partial discharge while higher electric current levels and thus weight associated with cables and busbars are expected. The lower the value of the ratio, lower electric current levels and thus weight associated with cables and busbars are to be expected while there is less physical space available and the electric machine is more susceptible to undesirable partial discharge. The power to voltage ratio being equal to or greater than 0.35 and less than or equal to 0.5 is particularly suited for electric machines operated and arranged as shown in FIGS. 12, 14, and 15, e.g., in a “tail cone” or aft position. However, as noted, the power to voltage ratio may be equal to or greater than 0.3 and less than or equal to 2.0.

With reference still to FIGS. 12 through 15, in some embodiments, the unducted fan propulsor 200, and more particularly, the electric machine 300 embedded therein is operated so as to define a power to AC rated current ratio. The power to AC rated current ratio can be constant, particularly during high efficiency operations and excluding situations where the electric machine 300 is decoupled from the LP shaft 238. The power to AC rated current ratio is defined by an electrical power associated with the electric machine 300 in kilowatts (e.g., electrical power output by the electric machine 300) to an AC rated current of the electric machine in ampere root mean square (arms). Stated another way, the power to AC rated current ratio may be defined as:

$$EM Power / EM AC Rated Current \qquad ( Ratio 10 )$$

As noted, the EM Power is measured as the electrical power output by the electric machine 300 in kilowatts. In some embodiments, the electrical power output by the electric machine 300 ranges from 200 kilowatts to 3 megawatts (200 kW-3MW). Further, the EM AC Rated Current is measured as the AC rated current associated with an AC side of the electric machine 300 in ampere root mean square (arms). Accordingly, the unit of measure for power is to be kW and the unit of measure for voltage is to be arms when determining the power to AC rated current ratio, or stated another way, kW/arms. Such measurements can be taken at a red line speed of the unducted fan propulsor 200 or at any other speed, notwithstanding situations where the electric machine 300 is decoupled from the LP shaft 238.

In some embodiments, the electric machine 300 of the unducted fan propulsor 200 is operated so as to define the power to AC rated current ratio as being equal to or greater than as being equal to or greater than 0.2 and less than or equal to 2.5. In yet other embodiments, the electric machine 300 of the unducted fan propulsor 200 is operated so as to define the power to AC rated current ratio as being equal to or greater than as being equal to or greater than 0.6 and less than or equal to 2.0, or equal to or greater than 0.2 and less than or equal to 1.2, equal to or greater than 1.8 and less than or equal to 2.5, or equal to or greater than 1.2 and less than or equal to 1.8. The noted ranges for the power to AC rated current ratio capture the operating relationship between the electrical power associated with the electric machine and the AC rated current associated with the electric machine.

The inventors of the present disclosure have recognized that three-stream engines having an electric machine arranged as shown and described and operated according to the noted ranges advantageously balances the physical space required for the electric machine, the physical space needed between electrically conducting components of the electric machine, and partial discharge considerations with electric current levels and consequently increased weight of cables and busbars associated with the electric machine and/or power systems of the aircraft. Generally, for lower values of the power to AC rated current ratio, more physical space is available and the electric machine is less susceptible to undesirable partial discharge while higher electric current levels and thus weight associated with cables and busbars are expected. The higher values of the power to AC rated current ratio, lower electric current levels and thus weight associated with cables and busbars are to be expected while there is less physical space available and the electric machine is more susceptible to undesirable partial discharge. The power to AC rated current ratio being equal to or greater than 0.6 and less than or equal to 2.0 is particularly suited for electric machines operated and arranged as shown in FIGS. 12, 14, and 15, e.g., in a “tail cone” or aft position. However, as noted, the power to AC rated current ratio may be equal to or greater than 0.2 and less than or equal to 2.5.

Referring still to FIGS. 12 through 15, in some embodiments, the unducted fan propulsor 200, and more particularly, the electric machine 300 embedded therein is operated so as to define a torque at maximum speed to AC rated current ratio. The torque at maximum speed to AC rated current ratio is defined by a torque associated with a rotor of the electric machine at maximum speed of the electric machine in newton meters to an AC rated current of the electric machine in ampere root mean square. Stated another way, the torque at maximum speed to AC rated current ratio may be defined as:

$$EM Torque at Max Speed / EM AC Rated Current \qquad ( Ratio 11 )$$

In some embodiments, the electric machine 300 of the unducted fan propulsor 200 is operated so as to define the torque at maximum speed to AC rated current ratio as being equal to or greater than as being equal to or greater than 0.1 and less than or equal to 6.0. In yet other embodiments, the electric machine 300 of the unducted fan propulsor 200 is operated so as to define the power to AC rated current ratio as being equal to or greater than as being equal to or greater than 0.6 and less than or equal to 1.0. The range for the torque at maximum speed to AC rated current ratio captures the operating relationship between the torque associated with a rotor of the electric machine and the AC rated current associated with the electric machine.

The inventors of the present disclosure have recognized that three-stream engines having an electric machine arranged as shown and described and operated according to the noted ranges advantageously balance the torque associated with the rotor of the electric machine with the electric current at the AC side of the electric machine. The torque at maximum speed to AC rated current ratio being equal to or greater than 0.6 and less than or equal to 1.0 is particularly suited for electric machines operated and arranged as shown in FIGS. 12, 14, and 15, e.g., in a “tail cone” or aft position. However, as noted, the torque at maximum speed to AC rated current ratio may be equal to or greater than 0.1 and less than or equal to 6.0.

In some embodiments, the unducted fan propulsor 200 of FIGS. 12 through 15 and/or the three-stream engine of FIG. 16 may define a combination of the ratios noted above. For instance, the unducted fan propulsor 200 of FIGS. 12 through 15 may be arranged and operated to define any suitable combination of Ratio 1, Ratio 2, Ratio 3, Ratio 4, Ratio 5, Ratio 6, Ratio 7, Ratio 8, Ratio 9, Ratio 10, and Ratio 11. Embodiments of the unducted fan propulsor may be arranged and operated to define a single one of the above-noted ratios or some combination thereof.

Various examples are provided below. For each example embodiment, the unducted fan propulsor may include a primary fan and a mid-fan. Each example unducted fan propulsor may be arranged to define a primary fan radius to mid-fan radius ratio as being equal to or greater than 2.0 and less than or equal to 6.5. In some example embodiments, for example, the unducted fan propulsor may be arranged to define the primary fan radius to mid-fan radius ratio as being as being at least about 3.0 and less than 4.0.

EXAMPLE 1: An unducted fan propulsor having a micro-hybridization configuration has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine is operable to output 350 kW at flight idle. The electric machine has a rotor rotatable with the LP shaft. The unducted fan propulsor is arranged to define an electric machine length to LP turbine length ratio. The electric machine length to LP turbine length ratio is defined by an axial length of the electric machine to an axial length of the LP turbine. The electric machine length is a length spanning along an axial direction defined by the unducted fan propulsor between a leading edge of the rotor and a trailing edge of the rotor of the electric machine. The LP turbine length is a length spanning along the axial direction between a leading edge of a hub of one of the first stage turbine blades of the LP turbine to a trailing edge of a hub of one of the last stage turbine blades of the LP turbine. The unducted fan propulsor defines the electric machine length to LP turbine length ratio as 0.32.

EXAMPLE 2: An unducted fan propulsor being a part of a distributed propulsion system has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine is operable to output 3 MW. The electric machine has a rotor rotatable with the LP shaft. The unducted fan propulsor is arranged to define an electric machine length to LP turbine length ratio. The electric machine length to LP turbine length ratio is defined by an axial length of the electric machine to an axial length of the LP turbine. The electric machine length is a length spanning along an axial direction defined by the unducted fan propulsor between a leading edge of the rotor and a trailing edge of the rotor of the electric machine. The LP turbine length is a length spanning along the axial direction between a leading edge of a hub of one of the first stage turbine blades of the LP turbine to a trailing edge of a hub of one of the last stage turbine blades of the LP turbine. The unducted fan propulsor defines the electric machine length to LP turbine length ratio as 3.0.

EXAMPLE 3: An unducted fan propulsor having a micro-hybridization configuration has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine is operable to output 350 kW at flight idle. The electric machine has a rotor rotatable with the LP shaft. The unducted fan propulsor is arranged to define an electric machine tip radius to LP turbine last stage hub radius ratio. The electric machine tip radius spans along a radial direction R defined by the unducted fan propulsor between a longitudinal axis of the engine and an outermost point of the rotor of the electric machine. The LP turbine last stage hub radius spans along the radial direction R between the longitudinal axis of the engine and an outermost point of a hub of one of the last stage turbine blades of the LP turbine. The unducted fan propulsor defines the electric machine tip radius to LP turbine last stage hub radius ratio as 0.48.

EXAMPLE 4: An unducted fan propulsor being a part of a distributed propulsion system has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine is operable to output 3 MW. The electric machine has a rotor rotatable with the LP shaft. The unducted fan propulsor is arranged to define an electric machine tip radius to LP turbine last stage hub radius ratio. The electric machine tip radius spans along a radial direction R defined by the unducted fan propulsor between a longitudinal axis of the engine and an outermost point of the rotor of the electric machine. The LP turbine last stage hub radius spans along the radial direction R between the longitudinal axis of the engine and an outermost point of a hub of one of the last stage turbine blades of the LP turbine. The unducted fan propulsor defines the electric machine tip radius to LP turbine last stage hub radius ratio as being less than or equal to 0.48.

EXAMPLE 5: An unducted fan propulsor having a micro-hybridization configuration has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine has a rotor rotatable with the LP shaft. The unducted fan propulsor is arranged to define an electric machine power to LP turbine power ratio. The unit of measure for the power output by the electric machine is measured in kilowatts (kW) and the unit of measure for the power output by the LP turbine is measured in horsepower (hp). The unducted fan propulsor, when operated at 37,000 feet, defines the electric machine power to LP turbine power ratio as 0.62.

EXAMPLE 6: An unducted fan propulsor having a micro-hybridization configuration has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine has a rotor rotatable with the LP shaft. The unducted fan propulsor is arranged to define an electric machine power to LP turbine power ratio. The unit of measure for the power output by the electric machine is measured in kilowatts (kW) and the unit of measure for the power output by the LP turbine is measured in horsepower (hp). The unducted fan propulsor, when operated at 14,000 feet, defines the electric machine power to LP turbine power ratio as 0.41.

EXAMPLE 7: An unducted fan propulsor being a part of a distributed propulsion system has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine has a rotor rotatable with the LP shaft. The electric machine is operable to output between 3 MW and 15 MW, including the endpoints. The unducted fan propulsor is arranged to define an electric machine power to LP turbine power ratio. The unit of measure for the power output by the electric machine is measured in kilowatts (kW) and the unit of measure for the power output by the LP turbine is measured in horsepower (hp). The unducted fan propulsor, when operated, defines the electric machine power to LP turbine power ratio as 0.2.

EXAMPLE 8: An unducted fan propulsor has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine has a rotor rotatable with the LP shaft. The unducted fan propulsor is arranged to define a mid-fan tip speed to LP turbine tip speed ratio as being about equal to 1.0.

EXAMPLE 9: An unducted fan propulsor has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes an LP turbine. The unducted fan propulsor also includes an electric machine operatively coupled with the LP shaft. The electric machine has a rotor rotatable with the LP shaft. The unducted fan propulsor is arranged and operated so as to define an LP turbine tip speed to electric machine tip speed ratio as being equal to or greater than 0.1 and less than or equal to 1.0. Such measurements can be taken at a red line speed of the unducted fan propulsor 200 or at any other speed, notwithstanding situations where the electric machine 300 is decoupled from the LP shaft.

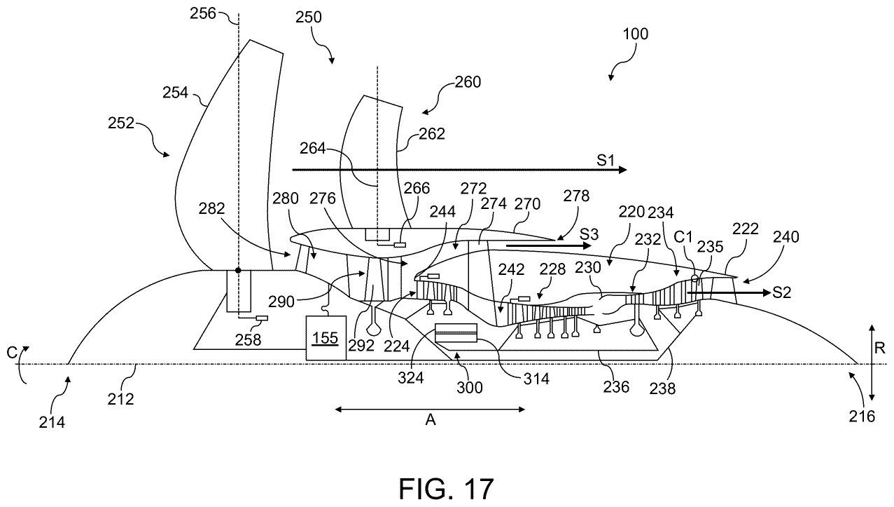

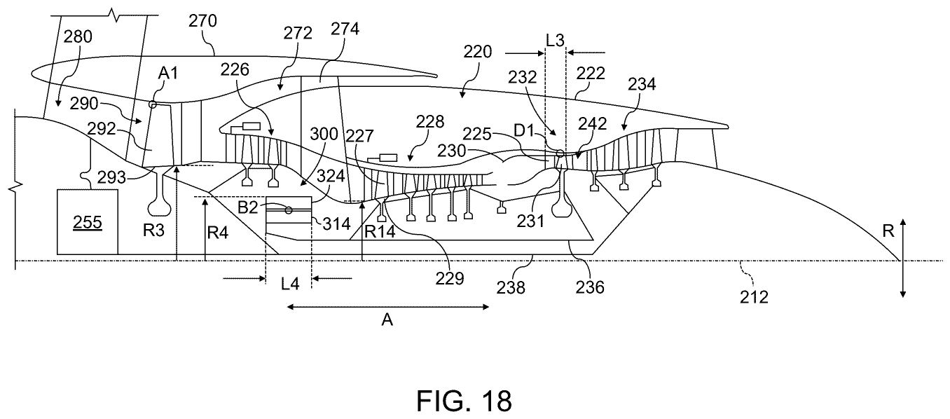

Referring now to FIGS. 17 and 18, FIG. 17 provides a schematic cross-sectional view of another exemplary unducted fan propulsor 200 according to various embodiments of the present disclosure. FIG. 18 provides a close-up, schematic cross-sectional view of the three-stream gas turbine engine 200 of FIG. 17. The unducted fan propulsor 200 of FIGS. 17 and 18 is configured in a similar manner to the unducted fan propulsor 200 of FIGS. 12 through 15 except as provided below.

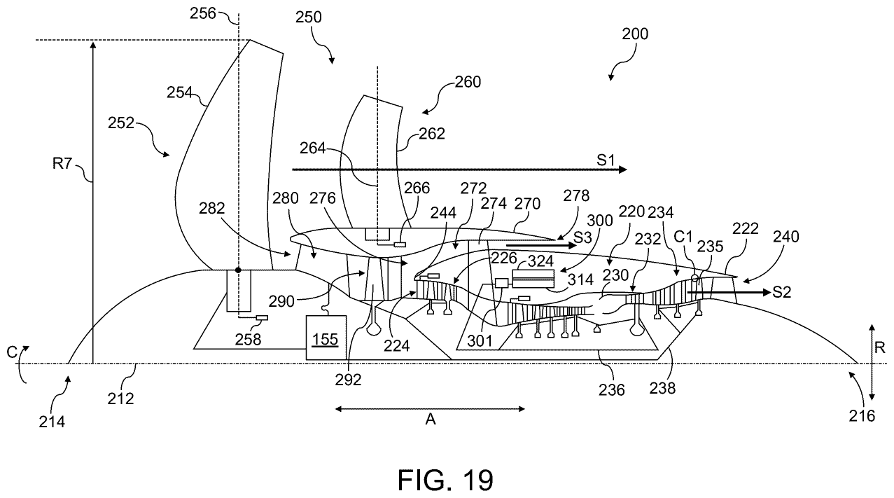

As depicted, for this embodiment, the electric machine 300 is operatively coupled with the HP shaft 236. Particularly, for this embodiment, the rotor 314 of the electric machine 300 is directly mechanically coupled with the HP shaft 236. The electric machine 300 is positioned forward of the HP compressor 228 but aft of the mid-fan 290 along the axial direction A. Moreover, the electric machine 300 is positioned inward of the core duct 242 along the radial direction R. The rotor 314 is rotatably about its centerline, which is coaxial with the longitudinal axis 212 in this example embodiment, relative to the stator 324. In this manner, as will be appreciated, the electric machine 300 can generate electrical power, e.g., when operated in a generator mode, or may drive the HP shaft 236, e.g., when operated in a drive mode. In other example embodiments, the electric machine 300 of the unducted fan propulsor 200 of FIGS. 17 and 18 can be positioned in other suitable locations. For instance, in some embodiments, the electric machine 300 can be positioned within the core cowl 222 as depicted in FIG. 19. For the embodiment of FIG. 19, the electric machine 300 is indirectly mechanically coupled with the HP shaft 236 via a gearbox 301.

Notably, the inventors of the present disclosure have recognized or otherwise discovered that there are certain operating and geometric relationships between various components of a three-stream gas turbine engine having an embedded electric machine coupled with a HP shaft or spool that provide certain advantages over conventional turbofan engines. As one example, an unducted fan propulsor having an electric machine operatively coupled with an HP shaft of the engine, such as disclosed in FIG. 17 as well as in other noted embodiments provided herein, may include components operating or arranged geometrically in advantageous relationships that ultimately provide significant fuel burn advantages over conventional turbofans, among other benefits.

As shown in FIGS. 17 and 18, the mid-fan 290 is operatively coupled with the LP shaft 238 and the HP turbine 232 is operatively coupled with the HP shaft 236. In this regard, the unducted fan propulsor 200 can operate at a mid-fan tip speed to HP turbine tip speed ratio. The mid-fan tip speed to HP turbine tip speed ratio can be constant. The mid-fan tip speed to HP turbine tip speed ratio is defined by a tip speed of one of the mid-fan blades 292 of the mid-fan 290 to a tip speed of one of the last stage turbine blades 231 of the HP turbine 232. Stated another way, the mid-fan tip speed to HP turbine tip speed ratio may be defined as:

$$Mid - Fan Tip Speed / HPT Tip Speed \qquad ( Ratio 12 )$$

The Mid-Fan Tip Speed is measured at a leading edge tip of one of the mid-fan blades 292, e.g., at a location A1 depicted in FIG. 18. The HPT Tip Speed is measured at a leading edge tip of one of the last stage turbine blades 231 of the HP turbine 232, e.g., at a location D1 depicted in FIG. 18. For the depicted embodiment of FIG. 18, the last stage turbine blades 231 of the HP turbine 232 is also the first stage as there is only one stage of HP turbine blades in this example embodiment.

In some embodiments, the unducted fan propulsor 200 is operated so as to define the mid-fan tip speed to HP turbine tip speed ratio as being equal to or greater than 0.7 and less than or equal to 1.5. In yet other embodiments, the unducted fan propulsor 200 is operated so as to define the mid-fan tip speed to HP turbine tip speed ratio as being equal to or greater than 0.8 and less than or equal to 1.2. In some further embodiments, the unducted fan propulsor 200 is operated so as to define the mid-fan tip speed to HP turbine tip speed ratio as being equal to or greater than 0.9 and less than or equal to 1.1, or about 1.0. Such measurements can be taken at a red line speed of the unducted fan propulsor 200 or at any other speed.

The inventors of the present disclosure have recognized that unducted fan propulsors operated so as to define the mid-fan tip speed to HP turbine tip speed ratio within one or more of the noted ranges have certain architectural and operating advantages. Particularly, operating an unducted fan propulsor within the noted ranges for the mid-fan tip speed to HP turbine tip speed ratio can ensure that the radius of the mid-fan (i.e., a radial length or radius spanning along the radial direction R between the longitudinal axis and a leading edge tip of one of the mid-fan blades of the mid-fan) is optimized relative to the HP turbine architecture. For instance, when the mid-fan radius is too large, the tip speed of the mid-fan may drive unacceptable aerodynamic losses. Moreover, mechanical stresses on the mid-fan may become excessive. In contrast, when the mid-fan radius is too small, the average velocity in the HP turbine blade passage may become too high, which may drive increased aerodynamic losses. The inventors of the present disclosure have taken these considerations into account in developing the noted ranges for the mid-fan tip speed to HP turbine tip speed ratio.

Referring to FIGS. 17 and 18, in some embodiments, the unducted fan propulsor 200 can be arranged to define a mid-fan hub radius to electric machine radius ratio. The mid-fan hub radius to electric machine radius ratio may be defined as:

$$Mid - Fan Blade Hub Radius / EM Radius \qquad ( Ratio 13 )$$

The mid-fan hub radius to electric machine radius ratio can be a fixed ratio as these two radii can be fixed. The Mid-Fan Blade Hub Radius is measured as a radial length or radius spanning along the radial direction R between the longitudinal axis 212 and an outermost point of a hub of one of the mid-fan blades 292 of the mid-fan 290. Particularly, as shown best in FIGS. 16 and 18, the Mid-Fan Blade Hub Radius is measured as Radius R3, which spans along the radial direction R between the longitudinal axis 212 and an outermost point taken at the trailing edge of a hub 293 of one of the mid-fan blades 292 of the mid-fan 290. The outermost point taken at the trailing edge of the hub 293 is the outermost point of the hub 293 with respect to the longitudinal axis 212 along the radial direction R.

The EM Radius is measured as a Radius R4 spanning along the radial direction R between the longitudinal axis 212 and an outermost point of the rotor 314 or the stator 324 depending on which one is positioned outward of the other along the radial direction R. For instance, when the rotor 314 is positioned outward of the stator 324 along the radial direction R (i.e., when the electric machine 300 has an outer-rotor configuration), the outermost point is taken as the outermost point of the rotor 314. In contrast, when the stator 324 is positioned outward of the rotor 314 along the radial direction R, (i.e., when the electric machine 300 has an inner-rotor configuration as shown in FIG. 16), the outermost point is taken as the outermost point of the stator 324.

In some embodiments, the mid-fan 290 and the electric machine 300 of the unducted fan propulsor 200 define the mid-fan hub radius to electric machine radius ratio as being equal to or greater than 0.1 and less than or equal to 1.0, equal to or greater than 0.1 and less than or equal to 0.4, equal to or greater than 0.4 and less than or equal to 0.8, or equal to or greater than 0.6 and less than or equal to 1.0. In this manner, the outermost point taken at the trailing edge of the hub 293 is positioned even with or outward of the outermost point of the rotor 314 or stator 324 of the electric machine 300 along the radial direction R (depending on which one is positioned outward of the other along the radial direction R). The inventors of the present disclosure have recognized that unducted fan propulsors having an electric machine and mid-fan arranged according to the noted ranges advantageously balance the geometry constraints and operating performance and efficiency of the mid-fan and electric machine, and also accounts for thermal constraints associated with the electric machine, particularly for unducted fan propulsors having an embedded electric machine positioned as shown best in FIGS. 17 and 18.

Further, in some embodiments, the unducted fan propulsor 200 can be arranged to define a HP compressor blade hub radius to electric machine tip radius ratio. The HP compressor hub radius to electric machine radius ratio may be defined as:

$$HPC Blade Hub Radius / EM Radius \qquad ( Ratio 14 )$$

The HP compressor hub radius to electric machine radius ratio can be a fixed ratio as these two radii can be fixed. As shown best in FIG. 18, the HPC Blade Hub Radius is measured as a radial length or Radius R5 spanning along the radial direction R between the longitudinal axis 212 and an outermost point taken at a leading edge of a hub 229 of one of the first stage blades 227 of the HP compressor 228. The EM Radius is measured as a Radius R4 spanning along the radial direction R between the longitudinal axis 212 and an outermost point of the rotor 314 or the stator 324 depending on which one is positioned outward of the other along the radial direction R.

In some embodiments, the HP compressor 228 and the electric machine 300 of the unducted fan propulsor 200 define the HP compressor hub radius to electric machine radius ratio as being equal to or greater than 0.1 and less than or equal to 1.0, equal to or greater than 0.1 and less than or equal to 0.25, equal to or greater than 0.25 and less than or equal to 0.5, or equal to or greater than 0.5 and less than or equal to 1.0. In this manner, the outermost point taken at a leading edge of a hub 229 of one of the first stage blades 227 of the HP compressor 228 is positioned even with or outward of the outermost point of the rotor 314 or stator 324 of the electric machine 300 along the radial direction R (depending on which one is positioned outward of the other along the radial direction R).

The inventors of the present disclosure have recognized that unducted fan propulsors having an electric machine coupled with the HP shaft and HP compressor arranged according to the noted ranges advantageously balance the geometry constraints and operating performance and efficiency of the HP compressor and electric machine, and also account for thermal constraints associated with the electric machine, particularly for unducted fan propulsors having an embedded electric machine positioned as shown best in FIGS. 17 and 18.

With reference still to FIGS. 17 and 18, as noted for this embodiment, the HP turbine 232 is operatively coupled with the HP shaft 236 and the electric machine 300 is operatively coupled with the HP shaft 236 as well. In this regard, the unducted fan propulsor 200 can operate at a HP turbine tip speed to electric machine tip speed ratio. The HP turbine tip speed to electric machine tip speed ratio can be constant, except when the electric machine 300 is decoupled from the HP shaft 236, e.g., by way of a clutch (not shown). The HP turbine tip speed to electric machine tip speed ratio is defined by a tip speed of one of the last stage turbine blades 231 of the HP turbine 232 to a tip speed of the rotor 314 of the electric machine 300. Stated another way, the HP turbine tip speed to electric machine tip speed ratio may be defined as:

$$HPT Tip Speed / EM Tip Speed \qquad ( Ratio 15 )$$

The HPT Tip Speed is measured at a leading edge tip of one of the last stage turbine blades 231 of the HP turbine 232, e.g., at a location D1 depicted in FIG. 18. The EM Tip Speed is measured at an outermost point of the rotor 314 of the electric machine 300, e.g., at a location B2 depicted in FIG. 18. As noted previously the outermost point of the rotor 314 is defined as the outermost point of the rotor 314 along the radial direction R with respect to the longitudinal axis 212.

In some embodiments, the unducted fan propulsor 200 is operated so as to define the HP turbine tip speed to electric machine tip speed ratio as being equal to or greater than 0.1 and less than or equal to 1.0, equal to or greater than 0.1 and less than or equal to 0.3, equal to or greater than 0.3 and less than or equal to 0.6, equal to or greater than 0.4 and less than or equal to 1.0. Such measurements can be taken at a red line speed of the unducted fan propulsor 200 or at any other speed. The inventors of the present disclosure have recognized that unducted fan propulsors operated so as to define the HP turbine tip speed to electric machine tip speed ratio within one or more of the noted ranges have certain architectural and operating advantages. For instance, operating an unducted fan propulsor within the noted ranges for the HP turbine tip speed to electric machine tip speed ratio can prevent unacceptable penalties on the power density of the electric machine, can prevent too much tip speed on the HP turbine and HP compressor, and can prevent the mechanical capabilities of electrical components of the electric machine from exceeding their limits, among other benefits.

In some embodiments, the unducted fan propulsor 200 depicted in FIGS. 17 and 18 can be arranged to define a HP turbine length to electric machine length ratio. The HP turbine length to electric machine length ratio is defined by an axial length of the HP turbine 232 to an axial length of the electric machine 300. Stated another way, the HP turbine length to electric machine length ratio may be defined as:

$$HPT Length / EM Length \qquad ( Ratio 16 )$$

The HP turbine length to electric machine length ratio can be a fixed ratio as the axial length of the HP turbine 232 and the axial length of the electric machine 300 are fixed. The HPT Length is measured as the axial length of the HP turbine 232. As shown best in FIG. 18, the axial length of the HP turbine 232 is defined as a length L3 spanning along the axial direction A between a leading edge of one of the first stage turbine nozzles 225 of the HP turbine 232 to a trailing edge of one of the last stage turbine blades 231 of the HP turbine 232. The EM Length is measured as the axial length of the electric machine 300. As illustrated in FIG. 18, the axial length of the electric machine 300 is defined as a length L4 spanning along the axial direction A between a leading edge of the rotor 314 of the electric machine 300 and a trailing edge of the rotor 314 of the electric machine 300.

In some embodiments, the HP turbine 232 and the electric machine 300 of the unducted fan propulsor 200 define the HP turbine length to electric machine length ratio as being equal to or greater than 0.1 and less than or equal to 1.5, equal to or greater than 0.1 and less than or equal to 0.5, equal to or greater than 0.5 and less than or equal to 0.85, or equal to or greater than 0.85 and less than or equal to 1.5. The ranges for the HP turbine length to electric machine length ratio capture the architectural and operating relationship between the electric machine and the HP turbine of the unducted fan propulsor, both of which are coupled to the HP shaft in such example embodiments. More specifically, the inventors of the present disclosure have recognized that unducted fan propulsors having an electric machine and HP turbine arranged according to the noted ranges advantageously balance weight and loading or efficiency considerations of the HP turbine with the performance requirements of the electric machine.

With reference still to FIGS. 17 and 18, in some embodiments, the unducted fan propulsor 200, and more particularly, the electric machine 300 embedded therein is operated so as to define a power to voltage ratio, wherein the electric machine 300 is operatively coupled with the HP shaft 236. The power to voltage ratio can be constant, particularly during high efficiency operations and excluding situations where the electric machine 300 is decoupled from the HP shaft 236. The power to voltage ratio is defined by an electrical power output by the electric machine 300 in kilowatts to a voltage level of the electric machine 300 in volts of direct current. Stated another way, the power to voltage ratio may be defined as:

$$EM Power / EM Voltage \qquad ( Ratio 17 )$$

As noted, the EM Power is measured as the electrical power output by the electric machine 300 in kilowatts. In some embodiments, the electrical power output by the electric machine 300 ranges from 200 kilowatts to 1 megawatts (200 kW-1MW). Further, the EM Voltage is measured as the voltage level of the electric machine 300 in volts of direct current Vdc. In some embodiments, the voltage level of the electric machine 300 ranges from 270 Vdc to 3 k Vdc.

In some embodiments, the electric machine 300 of the unducted fan propulsor 200 is operated so as to define the power to voltage ratio as being equal to or greater than 0.3 and less than or equal to 2.0, equal to or greater than 0.3 and less than or equal to 1.1, equal to or greater than 0.3 and less than or equal to 0.6, or equal to or greater than 0.6 and less than or equal to 1.1, or equal to or greater than 1.0 and less than or equal to 2.0. Such measurements can be taken at a red line speed of the unducted fan propulsor 200 or at any other speed, notwithstanding situations where the electric machine 300 is decoupled from the LP shaft 238.

The inventors of the present disclosure have recognized that unducted fan propulsors having an electric machine arranged as shown and described and operated according to the noted ranges advantageously balance the physical space required for the electric machine, the physical space needed between electrically conducting components of the electric machine, and partial discharge considerations with electric current levels and consequently increased weight of cables and busbars associated with the electric machine and/or power systems of the aircraft.

In some embodiments, the unducted fan propulsor 200 of FIGS. 17 and 18 and/or the unducted fan propulsor of FIG. 19 may define a combination of the ratios noted above. For instance, the unducted fan propulsor 200 of FIGS. 17 and 18 may be arranged and operated to define any suitable combination of Ratio 1, Ratio 12, Ratio 13, Ratio 14, Ratio 15, Ratio 16, and Ratio 17. Embodiments of the unducted fan propulsor may be arranged and operated to define a single one of the above-noted ratios or some combination thereof.

Various examples are provided below. For each example embodiment, the unducted fan propulsor may include a primary fan and a mid-fan. Each example unducted fan propulsor may be arranged to define a primary fan radius to mid-fan radius ratio as being equal to or greater than 2.0 and less than or equal to 6.5. In some example embodiments, for example, the unducted fan propulsor may be arranged to define the primary fan radius to mid-fan radius ratio as being as being at least about 3.0 and less than 4.0.

EXAMPLE 10: An unducted fan propulsor has an LP shaft, a primary fan operatively coupled with the shaft, e.g., via a gearbox and connecting fan rotor, a mid-fan positioned downstream of the primary fan and directly operatively coupled with the LP shaft, the mid-fan having mid-fan blades. The third stream further includes a HP turbine operatively coupled with a HP shaft. The unducted fan propulsor also includes an electric machine operatively coupled with the HP shaft. The electric machine has a rotor rotatable with the HP shaft. The unducted fan propulsor is arranged to define a mid-fan tip speed to HP turbine tip speed ratio. The mid-fan tip speed is measured at a leading edge tip of one of the mid-fan blades. The high pressure tip speed is measured at a leading edge tip of one of the last stage turbine blades of the HP turbine. The unducted fan propulsor defines the mid-fan tip speed to HP turbine tip speed ratio as 1.0.

EXAMPLE 11: An unducted fan propulsor has an LP shaft, a primary fan operatively coupled with the LP shaft, e.g., via a gearbox and connecting fan rotor, a mid-fan positioned downstream of the primary fan and directly operatively coupled with the LP shaft, the mid-fan having mid-fan blades. The third stream further includes a HP turbine operatively coupled with a HP shaft. The unducted fan propulsor also includes an electric machine operatively coupled with the HP shaft. The electric machine has a rotor rotatable with the HP shaft. The unducted fan propulsor is arranged to define a HP turbine tip speed to electric machine tip speed ratio. The HP turbine tip speed is measured at a leading edge tip of one of the last stage turbine blades of the HP turbine and the electric machine tip speed is measured at an outermost point of the rotor of the electric machine. The unducted fan propulsor defines the HP turbine tip speed to electric machine tip speed ratio as 0.4.

EXAMPLE 12: An unducted fan propulsor has an LP shaft, a primary fan operatively coupled with the LP shaft, e.g., via a gearbox and connecting fan rotor, a mid-fan positioned downstream of the primary fan and directly operatively coupled with the LP shaft, the mid-fan having mid-fan blades. The third stream further includes a HP turbine operatively coupled with a HP shaft. The unducted fan propulsor also includes an electric machine operatively coupled with the HP shaft. The electric machine has a rotor rotatable with the HP shaft. The unducted fan propulsor is arranged to define a HP turbine length to electric machine length ratio. The HP turbine length is measured as the axial length of the HP turbine, i.e., a length spanning along the axial direction between a leading edge of one of the first stage turbine nozzles of the HP turbine to a trailing edge of one of the last stage turbine blades of the HP turbine. The electric machine length is measured as the axial length of the electric machine. The unducted fan propulsor defines the HP turbine length to electric machine length ratio as 1.3.

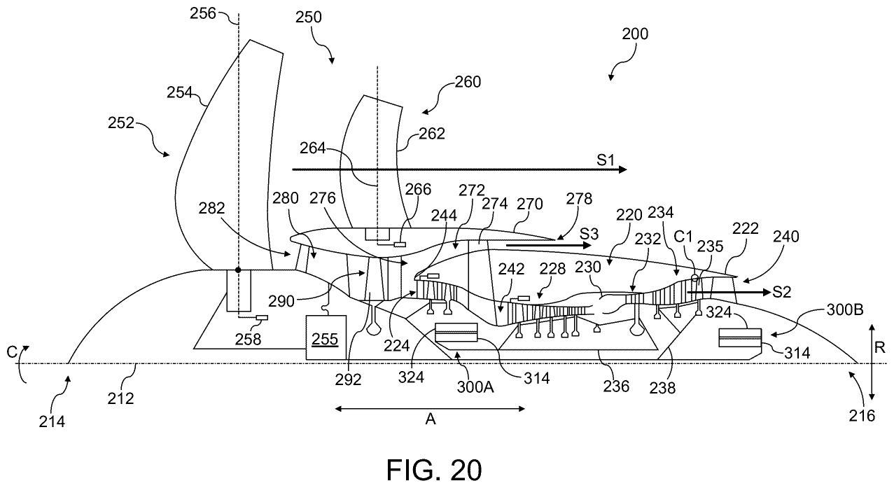

With reference now to FIG. 20, FIG. 20 provides a schematic cross-sectional view of a three-stream gas turbine engine 200 according to various embodiments of the present disclosure. The unducted fan propulsor 200 of FIG. 20 is configured in a similar manner to the unducted fan propulsor 200 of FIGS. 12 through 15 and FIGS. 17 and 18 except as provided below.

For this embodiment, the three-stream gas turbine engine 200 includes a first electric machine 300A operatively coupled with a first shaft or HP shaft 236 and a second electric machine 300B operatively coupled with a second shaft or LP shaft 238. The electric machines 300A, 300B can be mechanically connected to their respective shafts 236, 238 directly or indirectly, e.g., by way of a gearbox. The first electric machine 300A is positioned in the same location as the electric machine 300 of FIGS. 17 and 18 and the second electric machine 300B is positioned in the same location as the electric machine 300 of FIGS. 12 through 16 in this example embodiment. However, in other embodiments, the electric machines 300A, 300B may be positioned in other suitable locations. In some embodiments, the unducted fan propulsor 200 of FIG. 20 may define one or more of the ratios noted herein.

Notably, the inventors of the present disclosure have recognized that there are certain operating relationships between various components of a three-stream gas turbine engine having a first embedded electric machine operatively coupled with a HP shaft or spool and a second embedded electric machine operatively coupled with an LP shaft or spool that provide certain advantages over conventional turbofan engines.

For instance, with reference to FIG. 20, the unducted fan propulsor 200 can operate so as to define a second electric machine power to first electric machine power ratio. The second electric machine power to first electric machine power ratio can be constant, particularly during high efficiency operations of the unducted fan propulsor 200 and excluding situations where the first electric machine 300A is decoupled from the HP shaft 236 and/or the second electric machine 300B is decoupled form the LP shaft 238. The second electric machine power to first electric machine power ratio is defined by an electrical power output by the second electric machine in kilowatts to an electrical power output by the first electric machine in kilowatts. Stated another way, the second electric machine power to first electric machine power ratio may be defined as:

$$Second EM Power / Fi rst EM Power \qquad ( Ratio 18 )$$

In some embodiments, the unducted fan propulsor 200 is operated so as to define the second electric machine power to first electric machine power ratio as being equal to or greater than 0.1 and less than or equal to 1.5. In yet other embodiments, the unducted fan propulsor 200 is operated so as to define the second electric machine power to first electric machine power ratio as being equal to or greater than 0.5 and less than or equal to 1.2, equal to or greater than 0.5 and less than or equal to 0.75, equal to or greater than 0.75 and less than or equal to 1.2. In some further embodiments, the unducted fan propulsor 200 is operated so as to define the second electric machine power to first electric machine power ratio as being equal to or greater than 0.6 and less than or equal to 0.9. Such measurements can be taken at a red line speed of the unducted fan propulsor 200 or at any other speed. In some implementations, the electrical power output of the second electric machine ranges from 200 kilowatts to 3 megawatts and the electrical power output of the first electric machine ranges from 200 kilowatts to 1 megawatt.

The inventors of the present disclosure have recognized that unducted fan propulsors having a second electric machine and a first electric machine arranged and operated according to the noted ranges advantageously balances the geometric and physical space constraints, thermal needs, efficiency, and performance of the first and second electric machines.

In some embodiments, the unducted fan propulsor 200 of FIG. 20 may define a combination of the ratios noted above. For instance, the unducted fan propulsor 200 of FIG. 20 may be arranged and operated to define any suitable combination of Ratio 1 to Ratio 18. Embodiments of the unducted fan propulsor may be arranged and operated to define a single one of the above-noted ratios or some combination thereof.

EXAMPLE 13: An unducted fan propulsor has an LP shaft, a primary fan operatively coupled with the LP shaft, e.g., via a gearbox and connecting fan rotor, a mid-fan positioned downstream of the primary fan and directly operatively coupled with the LP shaft, the mid-fan having mid-fan blades. The unducted fan propulsor further includes a first electric machine mechanically coupled with the LP shaft. The third stream also includes a HP shaft and a second electric machine mechanically coupled thereto. The unducted fan propulsor is arranged to define a second electric machine power to first electric machine power ratio. The unducted fan propulsor defines the second electric machine power to first electric machine power ratio as 0.7.

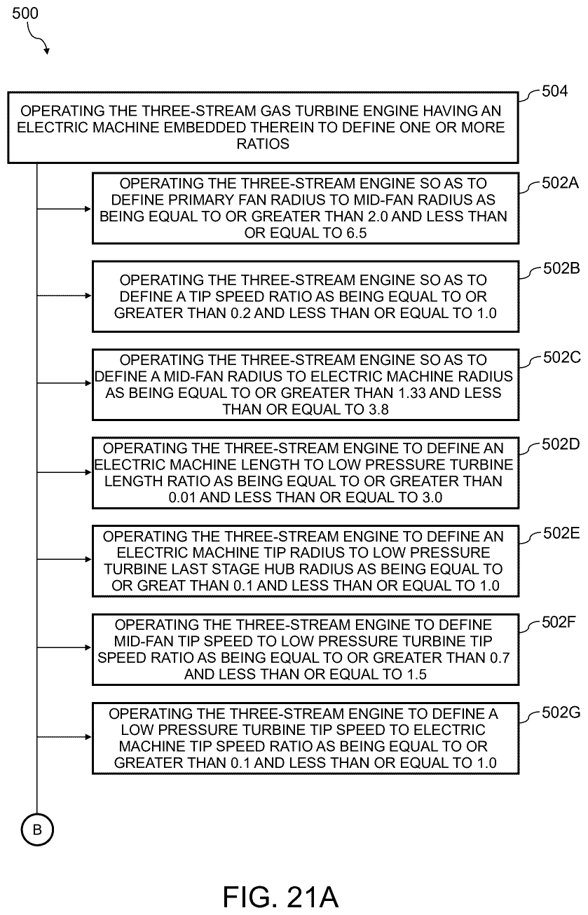

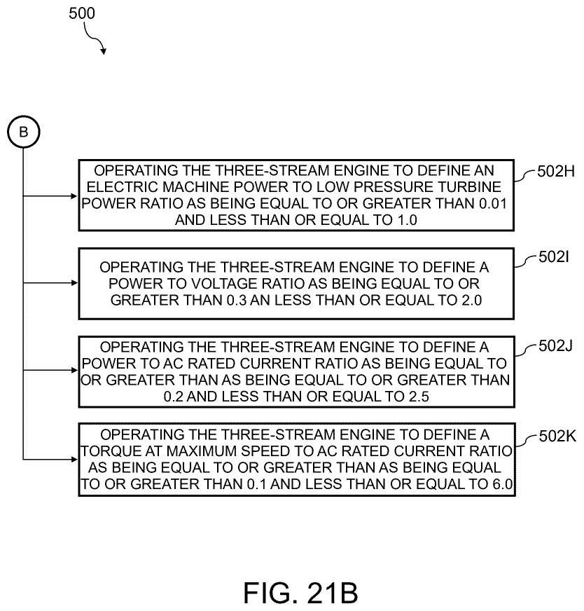

FIGS. 21A and 21B provides a flow diagram for a method (500) of operating an unducted fan propulsor according to one example embodiment of the present disclosure. For instance, method (500) can be used to operate the three-stream gas turbine engine of FIGS. 12 through 15, FIG. 16, or any other unducted fan propulsor having an embedded electric machine operatively coupled with a shaft of the engine, such as an LP shaft. It will be appreciated that method (500) is discussed herein to describe exemplary aspects of the present subject matter and is not intended to be limiting.

At (502), the method (500) includes operating a three-stream gas turbine engine having an electric machine embedded therein to define one or more ratios, such as the ratios set forth in (502A) through (502K).

In some implementations, the unducted fan propulsor defines a radial direction and has an inlet duct, a core duct in flow communication with the inlet duct, and a fan duct in flow communication with the inlet duct and positioned outward of the core duct along the radial direction. In such implementations, the mid-fan can be positioned within the inlet duct upstream of the core duct and the fan duct. Further, in some implementations, the unducted fan propulsor has a fan positioned upstream of the mid-fan and operatively coupled with the shaft (e.g., an LP shaft). In some implementations, the fan is unducted, e.g., as shown in FIG. 1. In addition, in such implementations, the mid-fan is positioned between the fan and an LP compressor along an axial direction defined by the unducted fan propulsor. Further, in such implementations, a root of a mid-fan blade is positioned inward of a root of a fan blade of the fan along the radial direction.

Furthermore, in some implementations, the unducted fan propulsor has an engine core and the electric machine is positioned within the engine core. In this regard, the electric machine is embedded within the unducted fan propulsor. For instance, in some implementations, the electric machine can be positioned inward of the core duct along the radial direction. Moreover, in some implementations, the electric machine is coupled to the shaft (e.g., an LP shaft) aft of the mid-fan, e.g., as shown in FIG. 1. In yet other implementations, the electric machine is coupled to the shaft (e.g., an LP shaft) forward of the mid-fan. Further, in some implementations, the electric machine is directly connected to the shaft. In some alternative implementations, the electric machine is indirectly coupled with the shaft, e.g., by way of a gearbox.

At (502A), the method (500) includes operating the three-stream gas turbine engine to define a primary fan radius to mid-fan radius as being equal to or greater than 2.0 and less than or equal to 6.5. In such implementations, the three-stream gas turbine engine has a primary fan having a plurality of fan blades. The primary fan radius to mid-fan radius ratio is defined by a radius spanning between a longitudinal axis defined by the three-stream gas turbine engine and a leading edge tip of one of the fan blades to a radius spanning between the longitudinal axis and a leading edge tip of one of the mid-fan blades. In some other implementations, the unducted fan propulsor defines the primary fan radius to mid-fan radius ratio as being at least about 2.0. In other implementations, the unducted fan propulsor defines the primary fan radius to mid-fan radius ratio as being at least about 2.5. In yet other implementations, the unducted fan propulsor defines the primary fan radius to mid-fan radius ratio as being at least about 3.0. In some further implementations, the unducted fan propulsor defines the primary fan radius to mid-fan radius ratio as being at least about 4.0. In yet other implementations, the unducted fan propulsor defines the primary fan radius to mid-fan radius ratio as being at least about 6.0. In some other implementations, the unducted fan propulsor defines the primary fan radius to mid-fan radius ratio as being about 6.5.

At (502B), in addition or alternatively to operating the three-stream gas turbine engine at (502A), the method (500) includes operating the three-stream gas turbine engine to define a tip speed ratio as being equal to or greater than 0.2 and less than or equal to 1.0, the tip speed ratio being defined by a tip speed of a rotor of the electric machine to a tip speed of a mid-fan blade of a mid-fan. In such implementations, the electric machine and the mid-fan are both operatively coupled with a shaft of the three-stream gas turbine engine. The electric machine and the mid-fan can both be operatively coupled with an LP shaft of the three-stream gas turbine engine, for example.

At (502C), in addition or alternatively to operating the three-stream gas turbine engine at (502A) and/or at (502B), the method (500) includes operating the three-stream gas turbine engine to define a mid-fan radius to electric machine radius ratio as being equal to or greater than 1.33 and less than or equal to 3.8. In some further implementations, the unducted fan propulsor 200 defines the mid-fan radius to electric machine radius ratio as being equal to or greater than 2.5 and less than or equal to 3.3. In yet other implementations, the unducted fan propulsor 200 defines the mid-fan radius to electric machine radius ratio as being equal to or greater than 2.9 and less than or equal to 3.2.

At (502D), in addition or alternatively to operating the three-stream gas turbine engine at (502A) and/or at (502B) and/or at (502C), the method (500) includes operating the three-stream gas turbine engine to define an electric machine length to LP turbine length ratio as being equal to or greater than 0.01 and less than or equal to 3.0. The range for the electric machine length to LP turbine length ratio captures the architectural and operating relationship between the electric machine and the LP turbine. The electric machine length is a length spanning between a leading edge and a trailing edge of the rotor of the electric machine along the axial direction. The length of the LP turbine is a length spanning between a leading edge of a hub of one of the first stage turbine blades of the LP turbine to a trailing edge of a hub of one of the last stage turbine blades of the LP turbine.

At (502E), in addition or alternatively to operating the three-stream gas turbine engine at (502A) and/or at (502B) and/or at (502C) and/or at (502D), the method (500) includes operating the three-stream gas turbine engine to define the electric machine tip radius to LP turbine last stage hub radius ratio as being equal to or greater than 0.1 and less than or equal to 1.0. The electric machine tip radius is a length or radius spanning between the longitudinal axis and an outermost point of the rotor of the electric machine. The LP turbine last stage hub radius is a length or radius spanning between a longitudinal axis defined by the unducted fan propulsor and an outermost point taken at a trailing edge of a hub of a last stage turbine blade of an LP turbine operatively coupled with the shaft.

At (502F), in addition or alternatively to operating the three-stream gas turbine engine at (502A) and/or at (502B) and/or at (502C) and/or at (502D) and/or at (502E), the method (500) includes operating the three-stream gas turbine engine to define a mid-fan tip speed to LP turbine tip speed ratio as being equal to or greater than 0.7 and less than or equal to 1.5. In such implementations, the mid-fan tip speed to LP turbine tip speed ratio is defined by a tip speed of a mid-fan blade of a mid-fan to a tip speed of a last stage turbine blade of an LP turbine. In some further implementations, the three-stream gas turbine engine is operated so as to define the mid-fan tip speed to LP turbine tip speed ratio as being equal to or greater than 0.8 and less than or equal to 1.2.

At (502G), in addition or alternatively to operating the three-stream gas turbine engine at (502A) and/or at (502B) and/or at (502C) and/or at (502D) and/or (502E) and/or at (502F), the method (500) includes operating the three-stream gas turbine engine to define an LP turbine tip speed to electric machine tip speed ratio as being equal to or greater than 0.1 and less than or equal to 1.0.

At (502H), in addition or alternatively to operating the three-stream gas turbine engine at (502A) and/or at (502B) and/or at (502C) and/or at (502D) and/or at (502E) and/or at (502F) and/or at (502G), the method (500) includes operating the three-stream gas turbine engine to define an electric machine power to LP turbine power ratio as being equal to or greater than 0.01 and less than or equal to 1.0. The unit of measure for the power output by the electric machine is to be kW and the unit of measure for the power output by the LP turbine is to be horsepower hp when determining the electric machine power to LP turbine power ratio.

At (5021), in addition or alternatively to operating the three-stream gas turbine engine at (502A) and/or at (502B) and/or at (502C) and/or at (502D) and/or at (502E) and/or at (502F) and/or at (502G) and/or at (502H), the method (500) includes operating the three-stream gas turbine engine so that the electric machine defines a power to voltage ratio as being equal to or greater than 0.3 and less than or equal to 2.0. In yet other implementations, operating the three-stream gas turbine engine so that the electric machine defines the power to voltage ratio as being equal to or greater than 0.35 and less than or equal to 0.5. The range for the power to voltage ratio captures the operating relationship between the electrical power associated with the electric machine and the voltage associated with the electric machine. In such implementations, the power to voltage ratio is defined by an electrical power output by the electric machine in kilowatts to a voltage level of the electric machine in volts of direct current. Further, in some implementations, the electrical power output of the electric machine ranges from 200 kilowatts to 3 megawatts. Further, in some implementations, the voltage level of the electric machine ranges between 270 volts of direct current and 3,000 volts of direct current.

At (502J), in addition or alternatively to operating the three-stream gas turbine engine at (502A) and/or at (502B) and/or at (502C) and/or at (502D) and/or at (502E) and/or at (502F) and/or at (502G) and/or at (502H) and/or at (5021), the method (500) includes operating the three-stream gas turbine engine so that the electric machine defines a power to AC rated current ratio as being equal to or greater than as being equal to or greater than 0.2 and less than or equal to 2.5. In yet other implementations, the electric machine of the unducted fan propulsor is operated so as to define the power to AC rated current ratio as being equal to or greater than as being equal to or greater than 0.6 and less than or equal to 2.0. The range for the power to AC rated current ratio captures the operating relationship between the electrical power associated with the electric machine and the AC rated current associated with the electric machine.

At (502K), in addition or alternatively to operating the three-stream gas turbine engine at (502A) and/or at (502B) and/or at (502C) and/or at (502D) and/or at (502E) and/or at (502F) and/or at (502G) and/or at (502H) and/or at (5021) and/or at (502J), the method (500) includes operating the three-stream gas turbine engine so that the electric machine defines a torque at maximum speed to AC rated current ratio as being equal to or greater than as being equal to or greater than 0.1 and less than or equal to 6.0. In yet other implementations, the electric machine of the unducted fan propulsor is operated so as to define the power to AC rated current ratio as being equal to or greater than as being equal to or greater than 0.6 and less than or equal to 1.0. The range for the torque at maximum speed to AC rated current ratio captures the operating relationship between the torque associated with a rotor of the electric machine and the AC rated current associated with the electric machine.

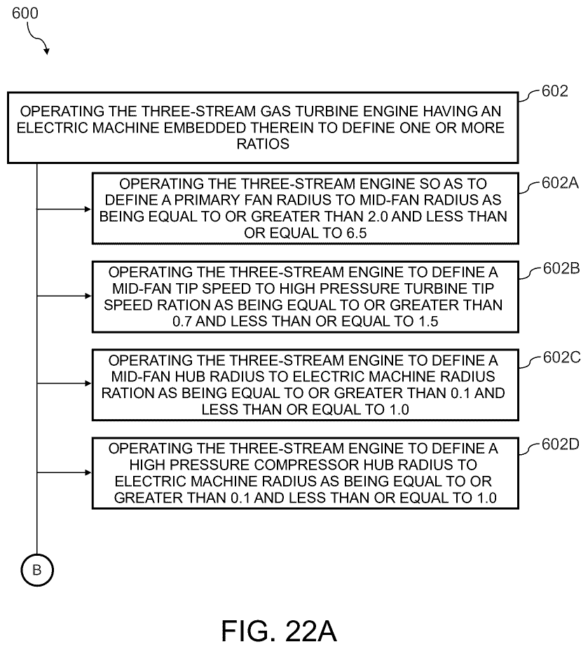

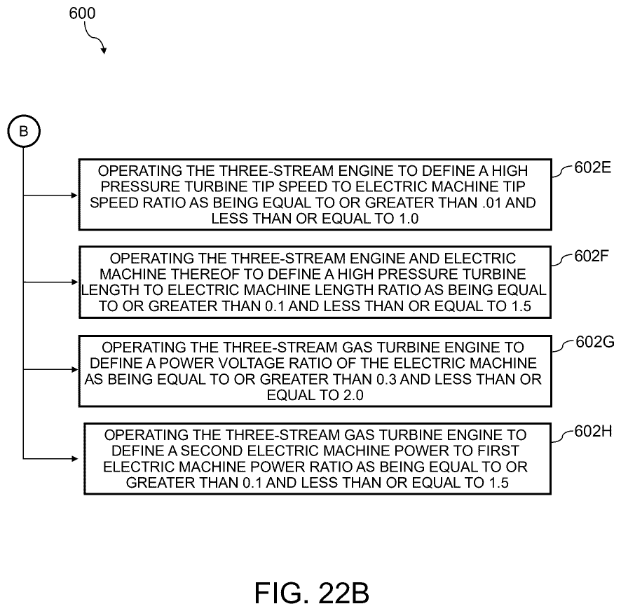

FIGS. 22A and 22B provide a flow diagram for a method (600) of operating an unducted fan propulsor according to one example embodiment of the present disclosure. For instance, method (600) can be used to operate the three-stream gas turbine engine of FIGS. 17 and 18 or any other unducted fan propulsor having an embedded electric machine operatively coupled with a shaft or spool of the engine, such as a HP shaft. It will be appreciated that method (600) is discussed herein to describe exemplary aspects of the present subject matter and is not intended to be limiting. Reference may be made to FIGS. 17 and 18 below to provide context to method (600).

At (602), the method (600) includes operating a three-stream gas turbine engine having an electric machine embedded therein to define one or more ratios, such as the ratios set forth in (602A) through (602H).

In some implementations, the unducted fan propulsor defines a radial direction and has an inlet duct, a core duct in flow communication with the inlet duct, and a fan duct in flow communication with the inlet duct and positioned outward of the core duct along the radial direction. In such implementations, the mid-fan can be positioned within the inlet duct upstream of the core duct and the fan duct. Further, in some implementations, the unducted fan propulsor has a fan positioned upstream of the mid-fan and operatively coupled with the second shaft (e.g., an LP shaft). In some implementations, the fan is unducted, e.g., as shown in FIG. 1. In other implementations, the fan is ducted, e.g., as shown in FIG. 16. In addition, in such implementations, the mid-fan is positioned between the fan and an LP compressor along an axial direction defined by the unducted fan propulsor. Further, in such implementations, a root of a mid-fan blade is positioned inward of a root of a fan blade of the fan along the radial direction.

Furthermore, in some implementations, the unducted fan propulsor has an engine core and the electric machine is positioned within the engine core. In this regard, the electric machine is embedded within the unducted fan propulsor. For instance, in some implementations, the electric machine can be positioned inward of the core duct along the radial direction. Moreover, in some implementations, the electric machine is coupled to the first shaft (e.g., an HP shaft) aft of the mid-fan and forward of a HP compressor, e.g., as shown in FIG. 17. In yet other implementations, the electric machine is coupled to the first shaft forward of the mid-fan. Further, in some implementations, the electric machine is directly connected to the first shaft, e.g., as shown in FIGS. 17 and 18. In some alternative implementations, the electric machine is indirectly coupled with the first shaft, e.g., by way of a gearbox.

At (602A), the method (600) includes operating the three-stream gas turbine engine to define a primary fan radius to mid-fan radius as being equal to or greater than 2.0 and less than or equal to 6.5. In such implementations, the three-stream gas turbine engine has a primary fan having a plurality of fan blades. The primary fan radius to mid-fan radius ratio is defined by a radius spanning between a longitudinal axis defined by the three-stream gas turbine engine and a leading edge tip of one of the fan blades to a radius spanning between the longitudinal axis and a leading edge tip of one of the mid-fan blades. In some other implementations, the unducted fan propulsor defines the primary fan radius to mid-fan radius ratio as being at least about 2.0. In other implementations, the unducted fan propulsor defines the primary fan radius to mid-fan radius ratio as being at least about 2.5. In yet other implementations, the unducted fan propulsor defines the primary fan radius to mid-fan radius ratio as being at least about 3.0. In some further implementations, the unducted fan propulsor defines the primary fan radius to mid-fan radius ratio as being at least about 4.0. In yet other implementations, the unducted fan propulsor defines the primary fan radius to mid-fan radius ratio as being at least about 6.0. In some other implementations, the unducted fan propulsor defines the primary fan radius to mid-fan radius ratio as being about 6.5.

At (602B), in addition or alternatively to operating the three-stream gas turbine engine at (602A), the method (600) includes operating the unducted fan propulsor so as to define a mid-fan tip speed to HP turbine tip speed ratio as being equal to or greater than 0.7 and less than or equal to 1.5. The mid-fan tip speed to HP turbine tip speed ratio being defined by a tip speed of a mid-fan blade of a mid-fan to a tip speed of a last stage turbine blade of a HP turbine.

At (602C), in addition or alternatively to operating the three-stream gas turbine engine at (602A) and/or at (602B), the method (600) includes operating the unducted fan propulsor so as to define a mid-fan hub radius to electric machine radius ratio as being equal to or greater than 0.1 and less than or equal to 1.0. In such implementations, the mid-fan hub radius to electric machine radius ratio is defined by a radius spanning between a longitudinal axis defined by the three-stream gas turbine engine and an outermost point taken at a trailing edge of a hub of the mid-fan blade of the mid-fan to a radius spanning between the longitudinal axis and an outermost point of the rotor or a stator of the electric machine depending on which one is positioned outward of the other along a radial direction defined by the three-stream gas turbine engine.

At (602D), in addition or alternatively to operating the three-stream gas turbine engine at (602A) and/or at (602B) and/or at (602C), the method (600) includes operating the three-stream gas turbine engine to define a HP compressor hub radius to electric machine radius ratio as being equal to or greater than 0.1 and less than or equal to 1.0. In such implementations, the HP compressor hub radius to electric machine radius ratio is defined by a radius spanning between a longitudinal axis defined by the three-stream gas turbine engine and an outermost point taken at a leading edge of a hub of a first stage blade of a HP compressor operatively coupled with the first shaft to a radius spanning between the longitudinal axis and an outermost point of the rotor or a stator of the electric machine depending on which one is positioned outward of the other along a radial direction defined by the three-stream gas turbine engine.

At (602E), in addition or alternatively to operating the three-stream gas turbine engine at (602A) and/or at (602B) and/or at (602C) and/or at (602D), the method (600) includes operating the three-stream gas turbine engine so as to define a HP turbine tip speed to electric machine tip speed ratio as being equal to or greater than 0.1 and less than or equal to 1.0. The HP turbine tip speed to electric machine tip speed ratio is defined by a tip speed of a first stage turbine blade of the HP turbine to a tip speed of a rotor of the electric machine.

At (602F), in addition or alternatively to operating the three-stream gas turbine engine at (602A) and/or at (602B) and/or at (602C) and/or at (602D) and/or at (602E), the method (600) includes operating the three-stream gas turbine engine so as to define a HP turbine length to electric machine length ratio as being equal to or greater than 0.1 and less than or equal to 1.5. The HP turbine length to electric machine length ratio is defined by a length of the HP turbine operatively coupled with the first shaft to a length of the electric machine spanning between a leading edge and a trailing edge of the rotor of the electric machine along an axial direction defined by the three-stream gas turbine engine.

At (602G), in addition or alternatively to operating the three-stream gas turbine engine at (602A) and/or at (602B) and/or at (602C) and/or at (602D) and/or at (602E) and/or at (602F), the method (600) includes operating the three-stream gas turbine engine to define a power to voltage ratio of the electric machine as being equal to or greater than 0.3 and less than or equal to 2.0. In such implementations, the power to voltage ratio is defined by an electrical power output by the electric machine in kilowatts to a voltage level of the electric machine in volts of direct current. Further, in some implementations, the electrical power output of the electric machine ranges from 200 kilowatts to 1 megawatt. Further, in some implementations, the voltage level of the electric machine ranges between 270 volts of direct current and 3,000 volts of direct current. In some implementations, the electrical power output of the electric machine ranges from 200 kilowatts to 1 megawatt and the voltage level of the electric machine ranges between 270 volts of direct current and 3,000 volts of direct current.

At (602H), in addition or alternatively to operating the three-stream gas turbine engine at (602A) and/or at (602B) and/or at (602C) and/or at (602D) and/or at (602E), the method (600) includes operating the three-stream gas turbine engine so as to define a second electric machine power to first electric machine power ratio as being equal to or greater than 0.1 and less than or equal to 1.5. In such implementations, the electric machine is a first electric machine, and wherein the three stream engine further comprises a second electric machine operatively coupled with the second shaft. In some implementations, the first shaft is a HP shaft of the unducted fan propulsor and the second shaft is an LP shaft of the unducted fan propulsor.

Further aspects of the disclosure are provided by the subject matter of the following clauses:

Clause 1: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

In the preceding clause, the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

In any of the preceding clauses, the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

In any of the preceding clauses, the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

In any of the preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

In any of the preceding clauses, the rotating blades diameter is between 8 to 16 feet or between 12 to 16 feet. In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

Clause 2: An aircraft is provided including a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein 0.065<RL/D<1.98 and θ is between 187° and 340°, and wherein RL/D and θ of the P of the unducted fan propulsor adhere to the following expressions:

$$\frac{R L}{D} + \frac{( \begin{matrix}\sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.72 \; 25 * {cos}^{2} ( θ )} > 0$$

$$and$$

$$\frac{R L}{D} + \frac{( \begin{matrix}- \sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.72 \; 25 * {cos}^{2} ( θ )} < 0.$$

In the preceding clause, 0.254<RL/D<1.86 and θ is between 199° and 306°, and the P of the unducted fan propulsor is defined by the following expressions:

$$\frac{R L}{D} + \frac{( \begin{matrix}\sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0.$$

In any of the two preceding clauses, 0.369<RL/D<1.43 and θ is between 204° and 291°, and the P of the unducted fan propulsor is defined by the following expressions:

$$\frac{R L}{D} + \frac{( \begin{matrix}\sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0.$$

In any of the three preceding clauses: 0.477<RL/D<0.9455 and θ is between 211° and 274°, and the P of the unducted fan propulsor is defined by the following expressions:

$$\frac{R L}{D} + \frac{( \begin{matrix}\sqrt{\begin{matrix}0.01069156 * [ 0.036 * {sin}^{2} ( θ ) - 0.3485 * \\ {cos}^{2} ( θ ) + 0.5418 * sin ( θ ) * cos ( θ ) ]\end{matrix}} + \\ 0.139167 * sin ( θ ) + 0.020812 * cos ( θ )\end{matrix} )}{0.2209 * {sin}^{2} ( θ ) + 0.0484 * {cos}^{2} ( θ )} > 0$$

$$and$$

$$\frac{R L}{D} + \frac{( \begin{matrix}- \sqrt{\begin{matrix}0.01069156 * [ 0.036 * {sin}^{2} ( θ ) - 0.3485 * \\ {cos}^{2} ( θ ) + 0.5418 * sin ( θ ) * cos ( θ ) ]\end{matrix}} + \\ 0.139167 * sin ( θ ) + 0.020812 * cos ( θ )\end{matrix} )}{0.2209 * {sin}^{2} ( θ ) + 0.0484 * {cos}^{2} ( θ )} < 0.$$

In any of the four preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

Clause 3: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein RL/D≤2 and θ is between 187° and 342°.

In any of the preceding clauses, 0.15≤RL/D.

In any of the preceding clauses, 0.35≤RL/D, and preferably RL/D is about 0.72.

In any of the preceding clauses, wherein θ is between 198° and 310°, and preferably between 205° and 285°.

In any of the preceding clauses, the unducted fan propulsor operates at a cruise flight Mach M₀ of between 0.5 and 0.9, preferably between 0.7 and 0.9, and more preferably between 0.75 and 0.9.

In any of the preceding clauses, the unducted fan propulsor has a dimensionless cruise fan net thrust parameter expressed as follows:

$$0 \text{.15} > \frac{{F}_{n e t}}{{ρ}_{0} {A}_{a n} {V}_{0}^{2}} > 0.06 ,$$

wherein Fₙₑₜ is cruise fan net thrust, po is ambient air density, V₀ is cruise flight velocity, and Aₐₙ is annular cross-sectional area perpendicular to an axis of rotation of a rotor axis of rotation.

In any of the preceding clauses, the unducted fan propulsor is undermounted to the airfoil with one or more intermediate structures.

In any of the foregoing clauses, the P of the unducted fan propulsor is variable to accommodate different operating conditions.

In any of the preceding clauses, the aircraft includes a plurality of the unducted fan propulsors.

In the preceding clause, the plurality of the unducted fan propulsors may be each mounted to the same airfoil, such as a wing or horizontal stabilizer; or the plurality of the unducted fan propulsors may be each mounted to different airfoils, such as a wing or horizontal stabilizer; or combinations thereof.

In any of the preceding clauses, wherein the unducted propulsor has two arrays of blades and only one of the array of blades is rotating.

Clause 4: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of counterclockwise rotating blades arranged in a forward array and a plurality clockwise rotating blades arranged in a rearward array, wherein one of the forward and rearward array of blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 5: An aircraft is provided that includes a fuselage; an airfoil extending from the fuselage, the airfoil having an airfoil section and the airfoil section having an effective quarter chord point (QC), and a plurality of rotating blades defining a maximum outer diameter (D); a point (P) located at an intersection of the CL and a line perpendicular to the CL that passes through a midpoint between leading and trailing edges nearest the root of one of the plurality of blades, and an ellipse origin positioning line (EOR) having a length (EORL) extending from the QC to an ellipse origin (OR) and at an angle θ measured positive in a counter-clockwise direction when the high pressure side of the airfoil section is below the airfoil section, and measured positive in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 6: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein 0.065<RL/D<1.98 and θ is between 187° and 340°; and wherein RL/D and θ of the P of the unducted fan propulsor adhere to the following expressions:

$$\frac{R L}{D} + \frac{( \begin{matrix}\sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.72 \; 25 * {cos}^{2} ( θ )} > 0$$

$$and$$

$$\frac{R L}{D} + \frac{( \begin{matrix}- \sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.72 \; 25 * {cos}^{2} ( θ )} < 0.$$

The aircraft of Clause 6, wherein:
0.254<RL/D<1.86 and θ is between 199° and 306°, and
the P of the unducted fan propulsor is defined by the following expressions:

$$\frac{R L}{D} + \frac{( \begin{matrix}\sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0.$$

The aircraft of Clause 6, wherein:
0.369<RL/D<1.43 and θ is between 204° and 291°, and
the P of the unducted fan propulsor is defined by the following expressions:

$$\frac{R L}{D} + \frac{( \begin{matrix}\sqrt{\begin{matrix}0.09923 * [ 0.2964 * {sin}^{2} ( θ ) - 0.36 * \\ {cos}^{2} ( θ ) + 0.66 * sin ( θ ) * cos ( θ ) ]\end{matrix}} + \\ 0.3675 * sin ( θ ) + 0.0891 * cos ( θ )\end{matrix} )}{0.49 * {sin}^{2} ( θ ) + 0.2025 * {cos}^{2} ( θ )} > 0$$

$$and$$

$$\frac{R L}{D} + \frac{( \begin{matrix}- \sqrt{\begin{matrix}0.09923 * [ 0.2964 * {sin}^{2} ( θ ) - 0.36 * \\ {cos}^{2} ( θ ) + 0.66 * sin ( θ ) * cos ( θ ) ]\end{matrix}} + \\ 0.3675 * sin ( θ ) + 0.0891 * cos ( θ )\end{matrix} )}{0.49 * {sin}^{2} ( θ ) + 0.2025 * {cos}^{2} ( θ )} < 0.$$

The aircraft of Clause 6, wherein:
0.477<RL/D<0.9455 and θ is between 211° and 274°, and
the P of the unducted fan propulsor is defined by the following expressions:

$$\frac{R L}{D} + \frac{( \begin{matrix}\sqrt{\begin{matrix}0.01069156 * [ 0.036 * {sin}^{2} ( θ ) - 0.3485 * \\ {cos}^{2} ( θ ) + 0.5418 * sin ( θ ) * cos ( θ ) ]\end{matrix}} + \\ 0.139167 * sin ( θ ) + 0.020812 * cos ( θ )\end{matrix} )}{0.2209 * {sin}^{2} ( θ ) + 0.0484 * {cos}^{2} ( θ )} > 0$$

$$and$$

$$\frac{R L}{D} + \frac{( \begin{matrix}- \sqrt{\begin{matrix}0.01069156 * [ 0.036 * {sin}^{2} ( θ ) - 0.3485 * \\ {cos}^{2} ( θ ) + 0.5418 * sin ( θ ) * cos ( θ ) ]\end{matrix}} + \\ 0.139167 * sin ( θ ) + 0.020812 * cos ( θ )\end{matrix} )}{0.2209 * {sin}^{2} ( θ ) + 0.0484 * {cos}^{2} ( θ )} < 0.$$

The aircraft of Clause 6, wherein the unducted fan propulsor is undermounted to the airfoil with one or more intermediate structures.

The aircraft of Clause 6, wherein the P of the unducted fan propulsor is variable to accommodate different operating conditions.

Clause 7: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein RL/D≤2 and θ is between 187° and 342°.

The aircraft of Clause 7, wherein 0.15≤RL/D.

The aircraft of Clause 7, wherein 0.35≤RL/D, and preferably RL/D is about 0.72.

The aircraft of Clause 7, wherein θ is between 198° and 310°, and preferably between 205° and 285°.

The aircraft of Clause 7, wherein the unducted fan propulsor operates at a cruise flight Mach M₀ of between 0.5 and 0.9, preferably between 0.7 and 0.9, and more preferably between 0.75 and 0.9.

The aircraft of Clause 7, wherein the unducted fan propulsor has a dimensionless cruise fan net thrust parameter expressed as follows:

$$0.15 > \frac{{F}_{n e t}}{{ρ}_{0} {A}_{a n} {V}_{0}^{2}} > 0.06 ,$$

wherein Fₙₑₜ is cruise fan net thrust, ρ₀ is ambient air density, V₀ is cruise flight velocity, and Aₐₙ is annular cross-sectional area perpendicular to an axis of rotation of a rotor axis of rotation.

The aircraft of Clause 7, wherein the unducted fan propulsor is undermounted to the airfoil with one or more intermediate structures.

The aircraft of Clause 7, wherein the P of the unducted fan propulsor is variable to accommodate different operating conditions.

Clause 8: A method of assembly, comprising: using an aircraft body comprising a fuselage and an airfoil extending from the fuselage, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a line HP perpendicular to the axial centerline CL that passes through the axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position; wherein 0.07<RL/D<2.0 and θ is between 187° and 342.0°.

The method of Clause 8, wherein 0.15≤RL/D.

The method of Clause 8, wherein 0.35≤RL/D, and preferably RL/D is about 0.72.

The method of Clause 8, wherein θ is between 198° and 310°, and preferably between 205° and 285°.

The method of Clause 8, wherein the unducted fan propulsor operates at a cruise flight Mach M₀ of between 0.5 and 0.9, preferably between 0.7 and 0.9, and more preferably between 0.75 and 0.9.

The method of Clause 8, wherein the unducted fan propulsor has a dimensionless cruise fan net thrust parameter expressed as follows:

$$0.15 > \frac{{F}_{n e t}}{{ρ}_{0} {A}_{a n} {V}_{0}^{2}} > 0.06 ,$$

wherein Fₙₑₜ is cruise fan net thrust, po is ambient air density, V₀ is cruise flight velocity, and Aₐₙ is annular cross-sectional area perpendicular to an axis of rotation of a rotor axis of rotation.

The method of Clause 8, wherein the unducted fan propulsor is undermounted to the airfoil with one or more intermediate structures.

The method of Clause 8, wherein the P of the unducted fan propulsor is variable to accommodate different operating conditions.

Clause 9: A method of assembly, comprising: using an aircraft body comprising a fuselage and an airfoil extending from the fuselage, the airfoil having an airfoil section with a leading edge (LE) and a trailing edge (TE), a chord extending between the LE and TE, and an effective quarter chord point (QC) along the chord measured from the LE, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

The method of Clause 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The method of Clause 9, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The method of Clause 9, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

Clause 10: An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.

Clause 11: An aircraft comprising:
a fuselage;
a pair of horizontal stabilizers extending relative to the fuselage,
two or more unducted fan propulsors, each of the unducted fan propulsors is mounted relative to one of the horizontal stabilizers on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a clockwise direction when the high pressure side of the airfoil section is above the airfoil section when viewed looking from an outboard position towards an inboard position of the wing; wherein 0.07≤RL/D≤2.0 and θ is between 187° and 342°.

In any of the preceding clauses, the unducted fan propulsor is undermounted to the airfoil, such as a wing, with one or more intermediate structures.

In any of the preceding clauses, the P of the unducted fan propulsor is variable to accommodate different operating conditions.

In any of the preceding clauses the drive mechanism may be a gas turbine engine and associated transmission to delivers torque from the drive mechanism to the propeller assembly.

In any of the preceding clauses, the unducted fan propulsor is incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9.

In any of the preceding clauses, the unducted fan propulsors is connected to the wing (or horizontal stabilizer) through a pylon.

In any of the preceding clauses, the rotating blades diameter (D) may be between 8 to 16 feet or 12 to 16 feet.

In any of the preceding clauses, each of the propulsors including a drive mechanism comprising a gas turbine engine assembly comprising in serial order a compressor, combustor, HP turbine and power turbine.

In any of the preceding clauses, the propulsor having a pitch angle between −5 and +5 degrees, or −3 and 0 degrees.

In any of the preceding clauses, the propulsor having an inward toe angle of between 0 and 5 degrees, or 1 and 3 degrees.

In any of the preceding clauses, the rotating blades diameter is between 8 to 16 feet or between 12 to 16 feet.

In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

### First Set of Clauses

1. A method, comprising: operating a three-stream gas turbine engine having an electric machine embedded therein to define a tip speed ratio as being equal to or greater than 0.2 and less than or equal to 1.0, the tip speed ratio being defined by a tip speed of a rotor of the electric machine to a tip speed of a mid-fan blade of a mid-fan, the electric machine and the mid-fan both being operatively coupled with a shaft of the three-stream gas turbine engine.

2. The method of any preceding clause, wherein the three-stream gas turbine engine has a primary fan having a plurality of fan blades, and wherein the three-stream gas turbine engine defines a primary fan radius to mid-fan radius as being equal to or greater than 2.0 and less than or equal to 6.5, the primary fan radius to mid-fan radius ratio being defined by a radius spanning between a longitudinal axis defined by the three-stream gas turbine engine and a leading edge tip of one of the fan blades to a radius spanning between the longitudinal axis and a leading edge tip of one of the mid-fan blades.

3. The method of any preceding clause, wherein the three-stream gas turbine engine and the electric machine define a mid-fan radius to electric machine radius ratio as being equal to or greater than 1.33 and less than or equal to 3.8, the mid-fan radius to electric machine radius ratio being defined by a radius spanning between a longitudinal axis defined by the three-stream gas turbine engine and a leading edge tip of one of the mid-fan blades of the mid-fan to a radius spanning between the longitudinal axis and an outermost point of the rotor of the electric machine.

4. The method of any preceding clause, wherein operating the three-stream gas turbine engine further comprises operating the three-stream gas turbine engine so as to define a power to voltage ratio of the electric machine as being equal to or greater than 0.3 and less than or equal to 2.0, the power to voltage ratio being defined by an electrical power output by the electric machine in kilowatts to a voltage level of the electric machine in volts of direct current.

4A. The method of any preceding clause, wherein operating the three-stream gas turbine engine further comprises operating the three-stream gas turbine engine so as to define a power to voltage ratio of the electric machine as being equal to or greater than 0.35 and less than or equal to 0.5, the power to voltage ratio being defined by an electrical power output by the electric machine in kilowatts to a voltage level of the electric machine in volts of direct current.

4B. The method of any preceding clause, wherein operating the three-stream gas turbine engine further comprises operating the three-stream gas turbine engine so as to define a power to voltage ratio of the electric machine as being equal to or greater than 0.4 and less than or equal to 0.5, the power to voltage ratio being defined by an electrical power output by the electric machine in kilowatts to a voltage level of the electric machine in volts of direct current.

5. The method of any preceding clause, wherein the electrical power output of the electric machine ranges from 100 kilowatts to 3 megawatts and the voltage level of the electric machine ranges from 270 volts of direct current to 3,000 volts of direct current.

6. The method of any preceding clause, wherein operating the three-stream gas turbine engine further comprises operating the three-stream gas turbine engine so as to define a power to voltage ratio of the electric machine as being equal to or greater than 0.35 and less than or equal to 0.5, the power to voltage ratio being defined by an electrical power output by the electric machine in kilowatts to a voltage level of the electric machine in volts of direct current.

7. The method of any preceding clause, wherein the electrical power output of the electric machine ranges from 100 kilowatts to 3 megawatts and the voltage level of the electric machine ranges from 270 volts of direct current to 3,000 volts of direct current.

8. The method of any preceding clause, wherein in operating the three-stream gas turbine engine, the rotor of the electric machine has a rotor tip speed being equal to or greater than 50 meters per second and less than or equal to 200 meters per second.

9. The method of any preceding clause, wherein in operating the three-stream gas turbine engine, the rotor of the electric machine has a rotor tip speed being equal to or greater than 140 meters per second and less than or equal to 190 meters per second.

10. The method of any preceding clause, wherein operating the three-stream gas turbine engine further comprises operating the three-stream gas turbine engine so as to define a power to AC rated current ratio of the electric machine as being equal to or greater than 0.2 and less than or equal to 2.5, the power to AC rated current ratio being defined by an electrical power output by the electric machine in kilowatts to an AC rated current of the electric machine in ampere root mean square.

10A. The method of any preceding clause, wherein operating the three-stream gas turbine engine further comprises operating the three-stream gas turbine engine so as to define a power to AC rated current ratio of the electric machine as being equal to or greater than 0.2 and less than or equal to 1.2, the power to AC rated current ratio being defined by an electrical power output by the electric machine in kilowatts to an AC rated current of the electric machine in ampere root mean square.

10B. The method of any preceding clause, wherein operating the three-stream gas turbine engine further comprises operating the three-stream gas turbine engine so as to define a power to AC rated current ratio of the electric machine as being equal to or greater than 1.8 and less than or equal to 2.5, the power to AC rated current ratio being defined by an electrical power output by the electric machine in kilowatts to an AC rated current of the electric machine in ampere root mean square.

10C. The method of any preceding clause, wherein operating the three-stream gas turbine engine further comprises operating the three-stream gas turbine engine so as to define a power to AC rated current ratio of the electric machine as being equal to or greater than 1.2 and less than or equal to 1.8, the power to AC rated current ratio being defined by an electrical power output by the electric machine in kilowatts to an AC rated current of the electric machine in ampere root mean square.

10D. The method of any preceding clause, wherein operating the three-stream gas turbine engine further comprises operating the three-stream gas turbine engine so as to define a power to AC rated current ratio of the electric machine as being equal to or greater than 0.6 and less than or equal to 2.0, the power to AC rated current ratio being defined by an electrical power output by the electric machine in kilowatts to an AC rated current of the electric machine in ampere root mean square.

11. The method of any preceding clause, wherein operating the three-stream gas turbine engine further comprises operating the three-stream gas turbine engine so as to define a torque at maximum speed to AC rated current ratio as being equal to or greater than as being equal to or greater than 0.1 and less than or equal to 6.0.

12. A three-stream gas turbine engine, comprising: a shaft; a primary fan operatively coupled with the shaft; a mid-fan positioned downstream of the primary fan and operatively coupled with the shaft, the mid-fan having mid-fan blades; an electric machine operatively coupled with the shaft, the electric machine having a stator and a rotor, the rotor rotatable with the shaft, and wherein, when operated, the three-stream gas turbine engine defines a tip speed ratio as being equal to or greater than 0.2 and less than or equal to 1.0, the tip speed ratio being defined by a tip speed of the rotor of the electric machine to a tip speed of one of the mid-fan blades.

13. The three-stream gas turbine engine of any preceding clause, wherein the three-stream gas turbine engine defines a mid-fan radius to electric machine radius ratio as being equal to or greater than 1.33 and less than or equal to 3.8, the mid-fan radius to electric machine radius ratio being defined by a radius spanning between a longitudinal axis defined by the three-stream gas turbine engine and a leading edge tip of one of the mid-fan blades of the mid-fan to a radius spanning between the longitudinal axis and an outermost point of the rotor of the electric machine.

14. The three-stream gas turbine engine of any preceding clause, wherein, when operated, the three-stream gas turbine engine defines a power to voltage ratio of the electric machine as being equal to or greater than 0.3 and less than or equal to 2.0, the power to voltage ratio being defined by an electrical power output by the electric machine in kilowatts to a voltage level of the electric machine in volts of direct current, and wherein the electrical power output of the electric machine ranges from 100 kilowatts to 3 megawatts and the voltage level of the electric machine ranges from 270 volts of direct current to 3,000 volts of direct current.

14A. The three-stream gas turbine engine of any preceding clause, wherein, when the three-stream gas turbine engine is operated, the rotor of the electric machine has a rotor tip speed being equal to or greater than 50 meters per second and less than or equal to 200 meters per second.

15. The three-stream gas turbine engine of any preceding clause, wherein the three-stream gas turbine engine further comprises: a primary fan positioned upstream of the mid-fan and operatively coupled with the shaft; an engine core; a core cowl surrounding the engine core; a core duct being defined between the engine core and the core cowl; a fan cowl surrounding the core cowl; a fan duct being defined between the core cowl and the fan cowl; an inlet duct in flow communication with the core duct and the fan duct, the inlet duct being defined between the engine core and the fan cowl, the mid-fan being positioned within the inlet duct.

16. A three-stream gas turbine engine, comprising: a shaft; a primary fan operatively coupled with the shaft; a mid-fan positioned downstream of the primary fan and operatively coupled with the shaft, the mid-fan having mid-fan blades; an electric machine operatively coupled with the shaft, the electric machine having a rotor rotatable with the shaft, and wherein the three-stream gas turbine engine defines a mid-fan radius to electric machine radius ratio as being equal to or greater than 1.33 and less than or equal to 3.8, the mid-fan radius to electric machine radius ratio being defined by a radius spanning between a longitudinal axis defined by the three-stream gas turbine engine and a leading edge tip of one of the mid-fan blades of the mid-fan to a radius spanning between the longitudinal axis and an outermost point of the rotor of the electric machine.

17. The three-stream gas turbine engine of any preceding clause, wherein the shaft is an LP shaft.

18. The three-stream gas turbine engine of any preceding clause, wherein the three-stream gas turbine engine defines the mid-fan radius to electric machine radius ratio as being equal to or greater than 2.5 and less than or equal to 3.3.

19. The three-stream gas turbine engine of any preceding clause, wherein the three-stream gas turbine engine defines the mid-fan radius to electric machine radius ratio as being equal to or greater than 2.9 and less than or equal to 3.2.

20. The three-stream gas turbine engine of any preceding clause, wherein the three-stream gas turbine engine defines an axial direction, and wherein the electric machine is positioned aft of the mid-fan and at least partially overlapping with or aft of an LP turbine of the three-stream gas turbine engine along the axial direction.

21. A three-stream gas turbine engine, comprising: an LP shaft; a HP shaft; a primary fan operatively coupled with the LP shaft, the primary fan having primary fan blades; a mid-fan positioned downstream of the primary fan and operatively coupled with the LP shaft, the mid-fan having mid-fan blades; an electric machine operatively coupled with the LP shaft or the HP shaft, and wherein the three-stream gas turbine engine defines a primary fan radius to mid-fan radius ratio as being equal to or greater than 2.0 and less than or equal to 6.5, the primary fan radius to mid-fan radius ratio being defined by a radius spanning between a longitudinal axis defined by the three-stream gas turbine engine and a leading edge tip of one of the blades of the primary fan to a radius spanning between the longitudinal axis and a leading edge tip of one of the mid-fan blades of the mid-fan.

22. The three-stream gas turbine engine of claim 21, wherein the electric machine is operatively coupled with the LP shaft.

23. The three-stream gas turbine engine of claim 21, wherein the electric machine is operatively coupled with the HP shaft.

24. The three-stream gas turbine engine of clause 21, wherein the primary fan is an unducted fan.

25. The three-stream gas turbine engine of clause 21, wherein the three-stream gas turbine engine defines the primary fan radius to mid-fan radius ratio as being equal to or greater than 3.0 and less than or equal to 6.5.

26. The three-stream gas turbine engine of clause 21, wherein the three-stream gas turbine engine and the electric machine define a mid-fan radius to electric machine radius ratio as being equal to or greater than 1.33 and less than or equal to 3.8, the mid-fan radius to electric machine radius ratio being defined by a radius spanning between the longitudinal axis and a leading edge tip of one of the mid-fan blades of the mid-fan to a radius spanning between the longitudinal axis and an outermost point of a rotor of the electric machine.

27. The three-stream gas turbine engine of clause 21, wherein the three-stream gas turbine engine and the electric machine define a mid-fan radius to electric machine radius ratio as being equal to or greater than 2.9 and less than or equal to 3.2, the mid-fan radius to electric machine radius ratio being defined by a radius spanning between the longitudinal axis and a leading edge tip of one of the mid-fan blades of the mid-fan to a radius spanning between the longitudinal axis and an outermost point of a rotor of the electric machine.

28. The three-stream gas turbine engine of clause 21, further comprising: an LP turbine operatively coupled with the LP shaft, and wherein the three-stream gas turbine engine defines an axial direction, and wherein the three-stream gas turbine engine defines an electric machine length to LP turbine length ratio as being equal to or greater than 0.01 and less than or equal to 3.0, the electric machine length to LP turbine length ratio being defined by a length of the LP turbine to a length of the electric machine, the length of the electric machine spanning between a leading edge and a trailing edge of a rotor of the electric machine along the axial direction, the length of the LP turbine spanning between a leading edge of a hub of a first stage turbine blade of the LP turbine to a trailing edge of a hub of a last stage turbine blade of the LP turbine.

29. The three-stream gas turbine engine of clause 21, further comprising: an LP turbine operatively coupled with the LP shaft, and wherein the three-stream gas turbine engine defines an axial direction, and wherein the three-stream gas turbine engine defines an electric machine tip radius to LP turbine last stage hub radius ratio as being equal to or greater than 0.1 and less than or equal to 1.0, the electric machine tip radius to LP turbine last stage hub radius ratio being defined by a radius spanning between a longitudinal axis defined by the three-stream gas turbine engine and an outermost point of a rotor of the electric machine to a radius spanning between the longitudinal axis and an outermost point of a hub of a last stage turbine blade of the LP turbine.

30. The three-stream gas turbine engine of clause 21, further comprising: an engine core; a core cowl surrounding the engine core; a core duct being defined between the engine core and the core cowl; a fan cowl surrounding the core cowl; a fan duct being defined between the core cowl and the fan cowl; an inlet duct in flow communication with the core duct and the fan duct, the inlet duct being defined between the engine core and the fan cowl, the mid-fan being positioned within the inlet duct, the electric machine being positioned within the engine core.

### Second Set of Clauses

1. A three-stream gas turbine engine defining an axial direction, the three-stream gas turbine engine comprising: a shaft; a primary fan operatively coupled with the shaft; a mid-fan positioned downstream of the primary fan and operatively coupled with the shaft, the mid-fan having mid-fan blades; an LP turbine operatively coupled with the shaft; an electric machine operatively coupled with the shaft, the electric machine having a stator and a rotor, the rotor rotatable with the shaft, and wherein the three-stream gas turbine engine defines an electric machine length to LP turbine length ratio as being equal to or greater than 0.01 and less than or equal to 3.0, the electric machine length to LP turbine length ratio being defined by a length of the LP turbine to a length of the electric machine spanning between a leading edge and a trailing edge of the rotor of the electric machine along the axial direction, the length of the LP turbine spanning between a leading edge of a hub of a first stage turbine blade of the LP turbine to a trailing edge of a hub of a last stage turbine blade of the LP turbine.

2. The three-stream gas turbine engine of any preceding clause, wherein the three-stream gas turbine engine has a primary fan having a plurality of fan blades, and wherein the three-stream gas turbine engine defines a primary fan radius to mid-fan radius as being equal to or greater than 2.0 and less than or equal to 6.5, the primary fan radius to mid-fan radius ratio being defined by a radius spanning between a longitudinal axis defined by the three-stream gas turbine engine and a leading edge tip of one of the fan blades to a radius spanning between the longitudinal axis and a leading edge tip of one of the mid-fan blades.

3. The three-stream gas turbine engine of any preceding clause, wherein the three-stream gas turbine engine further defines an electric machine tip radius to LP turbine last stage hub radius ratio as being equal to or greater than 0.1 and less than or equal to 1.0, the electric machine tip radius to LP turbine last stage hub radius ratio being defined by a radius spanning between a longitudinal axis defined by the unducted fan propulsor and an outermost point of the rotor of the electric machine to a radius spanning between the longitudinal axis and an outermost point of a hub of a last stage turbine blade of the LP turbine.

4. The three-stream gas turbine engine of any preceding clause, wherein, when operated, the three-stream gas turbine engine defines an electric machine power to LP turbine power ratio as being equal to or greater than 0.01 and less than or equal to 1.0 at flight idle.

4A. The three-stream gas turbine engine of any preceding clause, wherein, when operated, the three-stream gas turbine engine defines an electric machine power to LP turbine power ratio as being equal to or greater than 0.01 and less than or equal to 0.2 at flight idle.

4B. The three-stream gas turbine engine of any preceding clause, wherein, when operated, the three-stream gas turbine engine defines an electric machine power to LP turbine power ratio as being equal to or greater than 0.1 and less than or equal to 0.45 at flight idle.

4C. The three-stream gas turbine engine of any preceding clause, wherein, when operated, the three-stream gas turbine engine defines an electric machine power to LP turbine power ratio as being equal to or greater than 0.45 and less than or equal to 1.0 at flight idle.

5. The three-stream gas turbine engine of any preceding clause, wherein, when operated, the three-stream gas turbine engine defines a power to voltage ratio of the electric machine as being equal to or greater than 0.3 and less than or equal to 2.0, the power to voltage ratio being defined by an electrical power output by the electric machine in kilowatts to a voltage level of the electric machine in volts of direct current, and wherein the electrical power output of the electric machine ranges from 100 kilowatts to 3 megawatts and the voltage level of the electric machine ranges from 270 volts of direct current to 3,000 volts of direct current.

6. The three-stream gas turbine engine of any preceding clause, further comprising: a primary fan positioned upstream of the mid-fan and operatively coupled with the shaft; an engine core; a core cowl surrounding the engine core; a core duct being defined between the engine core and the core cowl; a fan cowl surrounding the core cowl; a fan duct being defined between the core cowl and the fan cowl; an inlet duct in flow communication with the core duct and the fan duct, the inlet duct being defined between the engine core and the fan cowl, the mid-fan being positioned within the inlet duct.

7. The three-stream gas turbine engine of any preceding clause, wherein the unducted fan propulsor defines a radial direction, the unducted fan propulsor further comprising: an engine core; a core cowl surrounding the engine core; a core duct being defined between the engine core and the core cowl; a fan cowl surrounding the core cowl; a fan duct being defined between the core cowl and the fan cowl; an inlet duct in flow communication with the core duct and the fan duct, the inlet duct being defined between the engine core and the fan cowl, the electric machine being directly mechanically coupled with the shaft and positioned inward of the core duct along the radial direction.

7A. The three-stream gas turbine engine of any preceding clause, wherein the three-stream gas turbine engine defines the electric machine length to LP turbine length ratio as being equal to or greater than 0.01 and less than or equal to 0.5.

7B. The three-stream gas turbine engine of any preceding clause, wherein the three-stream gas turbine engine defines the electric machine length to LP turbine length ratio as being equal to or greater than 0.3 and less than or equal to 1.0.

7C. The three-stream gas turbine engine of any preceding clause, wherein the three-stream gas turbine engine defines the electric machine length to LP turbine length ratio as being equal to or greater than 1.0 and less than or equal to 3.0.

7D. The three-stream gas turbine engine of any preceding clause, wherein the three-stream gas turbine engine defines the electric machine length to LP turbine length ratio as being equal to or greater than 2.0 and less than or equal to 3.0.

8. A three-stream gas turbine engine, comprising: a shaft; a primary fan operatively coupled with the shaft; a mid-fan positioned downstream of the primary fan and operatively coupled with the shaft, the mid-fan having mid-fan blades; an LP turbine; an electric machine operatively coupled with the shaft, the electric machine having a stator and a rotor, the rotor rotatable with the shaft, and wherein the three-stream gas turbine engine further defines an electric machine tip radius to LP turbine last stage hub radius ratio as being equal to or greater than 0.1 and less than or equal to 1.0.

8A. The three-stream gas turbine engine of any preceding clause, wherein the three-stream gas turbine engine defines the electric machine tip radius to LP turbine last stage hub radius ratio as being equal to or greater than 0.1 and less than or equal to 0.5.

8B. The three-stream gas turbine engine of any preceding clause, wherein the three-stream gas turbine engine defines the electric machine tip radius to LP turbine last stage hub radius ratio as being equal to or greater than 0.4 and less than or equal to 1.0.

8C. The three-stream gas turbine engine of any preceding clause, wherein the three-stream gas turbine engine defines the electric machine tip radius to LP turbine last stage hub radius ratio as being equal to or greater than 0.7 and less than or equal to 1.0.

9. The three-stream gas turbine engine of any preceding clause, wherein the three-stream gas turbine engine defines an axial direction, and wherein the three-stream gas turbine engine defines an electric machine length to LP turbine length ratio as being equal to or greater than 0.01 and less than or equal to 3.0, the electric machine length to LP turbine length ratio being defined by a length of the LP turbine to a length of the electric machine spanning between a leading edge and a trailing edge of the rotor of the electric machine along the axial direction, the length of the LP turbine spanning between a leading edge of a hub of a first stage turbine blade of the LP turbine to a trailing edge of a hub of a last stage turbine blade of the LP turbine.

10. The three-stream gas turbine engine of any preceding clause, wherein, when operated, the three-stream gas turbine engine defines an electric machine power to LP turbine power ratio as being equal to or greater than 0.01 and less than or equal to 1.0 at flight idle.

11. The three-stream gas turbine engine of any preceding clause, wherein the three-stream gas turbine engine defines an axial direction, and wherein the electric machine is positioned aft of the mid-fan and at least partially overlapping with or aft of the LP turbine along the axial direction.

12. The three-stream gas turbine engine of any preceding clause, wherein the primary fan is an unducted fan.

13. The three-stream gas turbine engine of any preceding clause, further comprising: an engine core; a core cowl surrounding the engine core; a core duct being defined between the engine core and the core cowl; a fan cowl surrounding the core cowl; a fan duct being defined between the core cowl and the fan cowl; an inlet duct in flow communication with the core duct and the fan duct, the inlet duct being defined between the engine core and the fan cowl, the electric machine being directly mechanically coupled with the shaft and embedded within the engine core.

14. The three-stream gas turbine engine of any preceding clause, wherein the three-stream gas turbine engine defines a mid-fan radius to electric machine radius ratio as being equal to or greater than 2.5 and less than or equal to 3.3, the mid-fan radius to electric machine radius ratio being defined by a radius spanning between a longitudinal axis defined by the three-stream gas turbine engine and a leading edge tip of one of the mid-fan blades of the mid-fan to a radius spanning between the longitudinal axis and an outermost point of the rotor of the electric machine.

15. The three-stream gas turbine engine of any preceding clause, wherein the primary fan has a plurality of fan blades, and wherein the three-stream gas turbine engine defines a primary fan radius to mid-fan radius as being equal to or greater than 2.0 and less than or equal to 6.5, the primary fan radius to mid-fan radius ratio being defined by a radius spanning between a longitudinal axis defined by the three-stream gas turbine engine and a leading edge tip of one of the fan blades to a radius spanning between the longitudinal axis and a leading edge tip of one of the mid-fan blades.

16. A method, comprising: operating a three-stream gas turbine engine having an electric machine embedded therein to define a mid-fan tip speed to LP turbine tip speed ratio as being equal to or greater than 0.7 and less than or equal to 1.5, the mid-fan tip speed to LP turbine tip speed ratio being defined by a tip speed of a mid-fan blade of a mid-fan to a tip speed of a last stage turbine blade of an LP turbine, the mid-fan being operatively coupled with a shaft of the three-stream gas turbine engine and the LP turbine being operatively coupled with the shaft.

17. The method of any preceding clause, wherein operating the three-stream gas turbine engine further comprises operating the three-stream gas turbine engine so as to define the mid-fan tip speed to LP turbine tip speed ratio as being equal to or greater than 0.8 and less than or equal to 1.2.

18. The method of any preceding clause, wherein operating the three-stream gas turbine engine further comprises operating the three-stream gas turbine engine so as to define an LP turbine tip speed to electric machine tip speed ratio as being equal to or greater than 0.1 and less than or equal to 1.0.

18A. The method of any preceding clause, wherein operating the three-stream gas turbine engine further comprises operating the three-stream gas turbine engine so as to define an LP turbine tip speed to electric machine tip speed ratio as being equal to or greater than 0.1 and less than or equal to 0.3.

18B. The method of any preceding clause, wherein operating the three-stream gas turbine engine further comprises operating the three-stream gas turbine engine so as to define an LP turbine tip speed to electric machine tip speed ratio as being equal to or greater than 0.5 and less than or equal to 0.9.

19. The method of any preceding clause, wherein operating the three-stream gas turbine engine further comprises operating the three-stream gas turbine engine so as to define a power to voltage ratio of the electric machine as being equal to or greater than 0.3 and less than or equal to 2.0, the power to voltage ratio being defined by an electrical power output by the electric machine in kilowatts to a voltage level of the electric machine in volts of direct current.

20. The method of any preceding clause, wherein operating the three-stream gas turbine engine further comprises operating the three-stream gas turbine engine so as to define a power to AC rated current ratio of the electric machine as being equal to or greater than 0.2 and less than or equal to 2.5, the power to AC rated current ratio being defined by an electrical power output by the electric machine in kilowatts to an AC rated current of the electric machine in ampere root mean square.

### Third Set of Clauses

1. A method, comprising: operating a three-stream gas turbine engine having an electric machine embedded therein to define a mid-fan tip speed to HP turbine tip speed ratio as being equal to or greater than 0.7 and less than or equal to 1.5, the mid-fan tip speed to HP turbine tip speed ratio being defined by a tip speed of a mid-fan blade of a mid-fan to a tip speed of a last stage turbine blade of a HP turbine, the electric machine and the HP turbine being operatively coupled with a first shaft of the three-stream gas turbine engine and the mid-fan being operatively coupled with a second shaft of the three-stream gas turbine engine.

2. The method of any preceding clause, wherein operating the three-stream gas turbine engine further comprises operating the three-stream gas turbine engine so as to define the mid-fan tip speed to HP turbine tip speed ratio as being equal to or greater than 0.8 and less than or equal to 1.2.

3. The method of any preceding clause, wherein operating the three-stream gas turbine engine further comprises operating the three-stream gas turbine engine so as to define the mid-fan tip speed to HP turbine tip speed ratio as being equal to or greater than 0.9 and less than or equal to 1.1.

4. The method of any preceding clause, wherein the three-stream gas turbine engine has a primary fan having a plurality of fan blades, and wherein the three-stream gas turbine engine defines a primary fan radius to mid-fan radius as being equal to or greater than 2.0 and less than or equal to 6.5, the primary fan radius to mid-fan radius ratio being defined by a radius spanning between a longitudinal axis defined by the three-stream gas turbine engine and a leading edge tip of one of the fan blades to a radius spanning between the longitudinal axis and a leading edge tip of one of the mid-fan blades.

5. The method of any preceding clause, wherein the first shaft is a HP shaft and the second shaft is an LP shaft.

6. The method of any preceding clause, wherein operating the three-stream gas turbine engine further comprises operating the three-stream gas turbine engine so as to define a HP turbine tip speed to electric machine tip speed ratio as being equal to or greater than 0.1 and less than or equal to 1.0, the HP turbine tip speed to electric machine tip speed ratio being defined by a tip speed of a first stage turbine blade of the HP turbine to a tip speed of a rotor of the electric machine.

7. The method of any preceding clause, wherein operating the three-stream gas turbine engine further comprises operating the three-stream gas turbine engine so as to define a power to voltage ratio as being equal to or greater than 0.3 and less than or equal to 2.0, the power to voltage ratio being defined by an electrical power output by the electric machine in kilowatts to a voltage level of the electric machine in volts of direct current.

7A. The method of any preceding clause, wherein operating the three-stream gas turbine engine further comprises operating the three-stream gas turbine engine so as to define a power to voltage ratio as being equal to or greater than 0.3 and less than or equal to 1.1, the power to voltage ratio being defined by an electrical power output by the electric machine in kilowatts to a voltage level of the electric machine in volts of direct current.

7B. The method of any preceding clause, wherein operating the three-stream gas turbine engine further comprises operating the three-stream gas turbine engine so as to define a power to voltage ratio as being equal to or greater than 0.3 and less than or equal to 0.6, the power to voltage ratio being defined by an electrical power output by the electric machine in kilowatts to a voltage level of the electric machine in volts of direct current.

7C. The method of any preceding clause, wherein operating the three-stream gas turbine engine further comprises operating the three-stream gas turbine engine so as to define a power to voltage ratio as being equal to or greater than 0.6 and less than or equal to 1.1, the power to voltage ratio being defined by an electrical power output by the electric machine in kilowatts to a voltage level of the electric machine in volts of direct current.

7D. The method of any preceding clause, wherein operating the three-stream gas turbine engine further comprises operating the three-stream gas turbine engine so as to define a power to voltage ratio as being equal to or greater than 1.0 and less than or equal to 2.0, the power to voltage ratio being defined by an electrical power output by the electric machine in kilowatts to a voltage level of the electric machine in volts of direct current.

8. The method of any preceding clause, wherein the electrical power output by the electric machine ranges from 100 kilowatts to 1 megawatt and the voltage level of the electric machine ranges from 270 volts of direct current to 3,000 volts of direct current.

9. The method of any preceding clause, wherein the electric machine is a first electric machine, and wherein the three stream engine further comprises a second electric machine operatively coupled with the second shaft, and wherein operating the three-stream gas turbine engine further comprises operating the three-stream gas turbine engine so as to define a second electric machine power to first electric machine power ratio as being equal to or greater than 0.1 and less than or equal to 1.5.

9A. The method of any preceding clause, wherein the electric machine is a first electric machine, and wherein the three stream engine further comprises a second electric machine operatively coupled with the second shaft, and wherein operating the three-stream gas turbine engine further comprises operating the three-stream gas turbine engine so as to define a second electric machine power to first electric machine power ratio as being equal to or greater than 0.5 and less than or equal to 1.2.

9B. The method of any preceding clause, wherein the electric machine is a first electric machine, and wherein the three stream engine further comprises a second electric machine operatively coupled with the second shaft, and wherein operating the three-stream gas turbine engine further comprises operating the three-stream gas turbine engine so as to define a second electric machine power to first electric machine power ratio as being equal to or greater than 0.5 and less than or equal to 0.75.

9C. The method of any preceding clause, wherein the electric machine is a first electric machine, and wherein the three stream engine further comprises a second electric machine operatively coupled with the second shaft, and wherein operating the three-stream gas turbine engine further comprises operating the three-stream gas turbine engine so as to define a second electric machine power to first electric machine power ratio as being equal to or greater than 0.75 and less than or equal to 1.2.

9D. The method of any preceding clause, wherein the electric machine is a first electric machine, and wherein the three stream engine further comprises a second electric machine operatively coupled with the second shaft, and wherein operating the three-stream gas turbine engine further comprises operating the three-stream gas turbine engine so as to define a second electric machine power to first electric machine power ratio as being equal to or greater than 0.6 and less than or equal to 0.9.

10. The method of any preceding clause, wherein operating the three-stream gas turbine engine further comprises operating the three-stream gas turbine engine so as to define a mid-fan hub radius to electric machine radius ratio as being equal to or greater than 0.1 and less than or equal to 1.0, the mid-fan hub radius to electric machine radius ratio being defined by a radius spanning between a longitudinal axis defined by the three-stream gas turbine engine and an outermost point taken at a trailing edge of a hub of a mid-fan blade of the mid-fan to a radius spanning between the longitudinal axis and an outermost point of the rotor or a stator of the electric machine depending on which one is positioned outward of the other along a radial direction defined by the three-stream gas turbine engine.

11. The method of any preceding clause, wherein operating the three-stream gas turbine engine further comprises operating the three-stream gas turbine engine so as to define a HP compressor hub radius to electric machine radius ratio as being equal to or greater than 0.1 and less than or equal to 1.0, the HP compressor hub radius to electric machine radius ratio being defined by a radius spanning between a longitudinal axis defined by the three-stream gas turbine engine and an outermost point taken at a leading edge of a hub of a first stage blade of a HP compressor operatively coupled with the first shaft to a radius spanning between the longitudinal axis and an outermost point of a rotor or a stator of the electric machine depending on which one is positioned outward of the other along a radial direction defined by the three-stream gas turbine engine.

12. The method of any preceding clause, wherein operating the three-stream gas turbine engine further comprises operating the three-stream gas turbine engine so as to define a HP turbine length to electric machine length ratio as being equal to or greater than 0.1 and less than or equal to 1.5, the HP turbine length to electric machine length ratio being defined by a length of the HP turbine operatively coupled with the first shaft to a length of the electric machine spanning between a leading edge and a trailing edge of the rotor of the electric machine along an axial direction defined by the three-stream gas turbine engine.

12A. The method of any preceding clause, wherein operating the three-stream gas turbine engine further comprises operating the three-stream gas turbine engine so as to define a HP turbine length to electric machine length ratio as being equal to or greater than 0.1 and less than or equal to 0.5.

12B. The method of any preceding clause, wherein operating the three-stream gas turbine engine further comprises operating the three-stream gas turbine engine so as to define a HP turbine length to electric machine length ratio as being equal to or greater than 0.5 and less than or equal to 0.85.

12C. The method of any preceding clause, wherein operating the three-stream gas turbine engine further comprises operating the three-stream gas turbine engine so as to define a HP turbine length to electric machine length ratio as being equal to or greater than 0.85 and less than or equal to 1.5.

13. A three-stream gas turbine engine, comprising: an LP shaft; a primary fan operatively coupled with the LP shaft; a mid-fan positioned downstream of the primary fan and operatively coupled with the LP shaft, the mid-fan having mid-fan blades; a HP shaft; an electric machine operatively coupled with the HP shaft, the electric machine having a rotor rotatable with the HP shaft, and wherein the unducted fan propulsor defines a mid-fan hub radius to electric machine radius ratio as being equal to or greater than 0.1 and less than or equal to 1.0, the mid-fan hub radius to electric machine radius ratio being defined by a radius spanning between a longitudinal axis defined by the three-stream gas turbine engine and an outermost point taken at a trailing edge of a hub of the mid-fan blade of the mid-fan to a radius spanning between the longitudinal axis and an outermost point of the rotor or a stator of the electric machine depending on which one is positioned outward of the other along a radial direction defined by the three-stream gas turbine engine.

13A. The three-stream gas turbine engine of any preceding clause, wherein the unducted fan propulsor defines a mid-fan hub radius to electric machine radius ratio as being equal to or greater than 0.1 and less than or equal to 0.4.

13B. The three-stream gas turbine engine of any preceding clause, wherein the unducted fan propulsor defines a mid-fan hub radius to electric machine radius ratio as being equal to or greater than 0.4 and less than or equal to 0.8.

13C. The three-stream gas turbine engine of any preceding clause, wherein the unducted fan propulsor defines a mid-fan hub radius to electric machine radius ratio as being equal to or greater than 0.6 and less than or equal to 1.0.

14. The three-stream gas turbine engine of any preceding clause, further comprising: a HP turbine having last stage turbine blades, and wherein, when operated, the three-stream gas turbine engine defines a mid-fan tip speed to HP turbine tip speed ratio as being equal to or greater than 0.7 and less than or equal to 1.5, the mid-fan tip speed to HP turbine tip speed ratio being defined by a tip speed of one of the mid-fan blades to a tip speed of one of the last stage turbine blades.

15. The three-stream gas turbine engine of any preceding clause, further comprising: a HP turbine operatively coupled with the first shaft and having first stage turbine blades, and wherein the three-stream gas turbine engine defines a longitudinal axis and a radial direction, and wherein the three-stream gas turbine engine defines a HP compressor hub radius to electric machine radius ratio as being equal to or greater than 0.1 and less than or equal to 1.0, the HP compressor hub radius to electric machine radius ratio being defined by a radius spanning between the longitudinal axis and an outermost point taken at a leading edge of a hub of one of the first stage blades to a radius spanning between the longitudinal axis and an outermost point of a rotor or a stator of the electric machine depending on which one is positioned outward of the other along the radial direction.

15A. The three-stream gas turbine engine of any preceding clause, wherein the three-stream gas turbine engine defines the HP compressor hub radius to electric machine radius ratio as being equal to or greater than 0.1 and less than or equal to 0.25.

15B. The three-stream gas turbine engine of any preceding clause, wherein the three-stream gas turbine engine defines the HP compressor hub radius to electric machine radius ratio as being equal to or greater than 0.25 and less than or equal to 0.5.

15C. The three-stream gas turbine engine of any preceding clause, wherein the three-stream gas turbine engine defines the HP compressor hub radius to electric machine radius ratio as being equal to or greater than 0.5 and less than or equal to 1.0.

16. The three-stream gas turbine engine of any preceding clause, further comprising: a HP turbine operatively coupled with the first shaft and having first stage turbine blades, and wherein the three-stream gas turbine engine defines an axial direction, and wherein the three-stream gas turbine defines a HP turbine length to electric machine length ratio as being equal to or greater than 0.1 and less than or equal to 1.5, the HP turbine length to electric machine length ratio being defined by a length of the HP turbine to a length of the electric machine spanning between a leading edge and a trailing edge of a rotor of the electric machine along the axial direction.

17. The three-stream gas turbine engine of any preceding clause, wherein the three-stream gas turbine engine has a primary fan having a plurality of fan blades, and wherein the three-stream gas turbine engine defines a primary fan radius to mid-fan radius as being equal to or greater than 2.0 and less than or equal to 6.5, the primary fan radius to mid-fan radius ratio being defined by a radius spanning between a longitudinal axis defined by the three-stream gas turbine engine and a leading edge tip of one of the fan blades to a radius spanning between the longitudinal axis and a leading edge tip of one of the mid-fan blades.

18. A method, comprising: operating a three-stream gas turbine engine having a primary fan, a mid-fan positioned downstream of the primary fan, and an electric machine embedded therein to define a HP turbine tip speed to electric machine tip speed ratio as being equal to or greater than 0.1 and less than or equal to 1.0, the HP turbine tip speed to electric machine tip speed ratio being defined by a tip speed of a first stage turbine blade of a HP turbine to a tip speed of a rotor of the electric machine, the electric machine and the HP turbine being operatively coupled with a first shaft of the three-stream gas turbine engine and the mid-fan and the primary fan being operatively coupled with a second shaft of the three-stream gas turbine engine.

18A. The method of any preceding clause, wherein operating the three-stream gas turbine engine further comprises operating the three-stream gas turbine engine so as to define the HP turbine tip speed to electric machine tip speed ratio as being equal to or greater than 0.1 and less than or equal to 0.3.

18B. The method of any preceding clause, wherein operating the three-stream gas turbine engine further comprises operating the three-stream gas turbine engine so as to define the HP turbine tip speed to electric machine tip speed ratio as being equal to or greater than 0.3 and less than or equal to 0.6.

18C. The method of any preceding clause, wherein operating the three-stream gas turbine engine further comprises operating the three-stream gas turbine engine so as to define the HP turbine tip speed to electric machine tip speed ratio as being equal to or greater than 0.4 and less than or equal to 1.0.

19. The method of any preceding clause, wherein operating the three-stream gas turbine engine further comprises operating the three-stream gas turbine engine so as to define a power to voltage ratio as being equal to or greater than 0.3 and less than or equal to 2.0, the power to voltage ratio being defined by an electrical power output by the electric machine in kilowatts to a voltage level of the electric machine in volts of direct current.

20. The method of any preceding clause, wherein operating the three-stream gas turbine engine further comprises operating the three-stream gas turbine engine so as to define a mid-fan tip speed to HP turbine tip speed ratio as being equal to or greater than 0.7 and less than or equal to 1.5, the mid-fan tip speed to HP turbine tip speed ratio being defined by a tip speed of a mid-fan blade of the mid-fan to a tip speed of a last stage turbine blade of the HP turbine.

### Fourth Set of Clauses

1. A three-stream gas turbine engine, comprising: an LP shaft; a HP shaft; a primary fan operatively coupled with the LP shaft, the primary fan having primary fan blades; a mid-fan positioned downstream of the primary fan and operatively coupled with the LP shaft, the mid-fan having mid-fan blades; an electric machine operatively coupled with the LP shaft or the HP shaft, and wherein the three-stream gas turbine engine defines a primary fan radius to mid-fan radius ratio as being equal to or greater than 2.0 and less than or equal to 6.5, the primary fan radius to mid-fan radius ratio being defined by a radius spanning between a longitudinal axis defined by the three-stream gas turbine engine and a leading edge tip of one of the blades of the primary fan to a radius spanning between the longitudinal axis and a leading edge tip of one of the mid-fan blades of the mid-fan.

2. A method, comprising: operating a three-stream gas turbine engine having an electric machine embedded therein to define a tip speed ratio as being equal to or greater than 0.2 and less than or equal to 1.0, the tip speed ratio being defined by a tip speed of a rotor of the electric machine to a tip speed of a mid-fan blade of a mid-fan, the electric machine and the mid-fan both being operatively coupled with a shaft of the three-stream gas turbine engine.

3. A three-stream gas turbine engine, comprising: a shaft; a primary fan operatively coupled with the shaft; a mid-fan positioned downstream of the primary fan and operatively coupled with the shaft, the mid-fan having mid-fan blades; an electric machine operatively coupled with the shaft, the electric machine having a rotor rotatable with the shaft, and wherein the three-stream gas turbine engine defines a mid-fan radius to electric machine radius ratio as being equal to or greater than 1.33 and less than or equal to 3.8, the mid-fan radius to electric machine radius ratio being defined by a radius spanning between a longitudinal axis defined by the three-stream gas turbine engine and a leading edge tip of one of the mid-fan blades of the mid-fan to a radius spanning between the longitudinal axis and an outermost point of the rotor of the electric machine.

4. A three-stream gas turbine engine defining an axial direction, the three-stream gas turbine engine comprising: a shaft; a primary fan operatively coupled with the shaft; a mid-fan positioned downstream of the primary fan and operatively coupled with the shaft, the mid-fan having mid-fan blades; an LP turbine operatively coupled with the shaft; an electric machine operatively coupled with the shaft, the electric machine having a stator and a rotor, the rotor rotatable with the shaft, and wherein the three-stream gas turbine engine defines an electric machine length to LP turbine length ratio as being equal to or greater than 0.01 and less than or equal to 3.0, the electric machine length to LP turbine length ratio being defined by a length of the LP turbine to a length of the electric machine spanning between a leading edge and a trailing edge of the rotor of the electric machine along the axial direction, the length of the LP turbine spanning between a leading edge of a hub of a first stage turbine blade of the LP turbine to a trailing edge of a hub of a last stage turbine blade of the LP turbine.

5. A three-stream gas turbine engine, comprising: a shaft; a primary fan operatively coupled with the shaft; a mid-fan positioned downstream of the primary fan and operatively coupled with the shaft, the mid-fan having mid-fan blades; an LP turbine; an electric machine operatively coupled with the shaft, the electric machine having a stator and a rotor, the rotor rotatable with the shaft, and wherein the three-stream gas turbine engine further defines an electric machine tip radius to LP turbine last stage hub radius ratio as being equal to or greater than 0.1 and less than or equal to 1.0.

6. A method, comprising: operating a three-stream gas turbine engine having an electric machine embedded therein to define a mid-fan tip speed to LP turbine tip speed ratio as being equal to or greater than 0.7 and less than or equal to 1.5, the mid-fan tip speed to LP turbine tip speed ratio being defined by a tip speed of a mid-fan blade of a mid-fan to a tip speed of a last stage turbine blade of an LP turbine, the mid-fan being operatively coupled with a shaft of the three-stream gas turbine engine and the LP turbine being operatively coupled with the shaft.

7. A method, comprising: operating a three-stream gas turbine engine so as to define an LP turbine tip speed to electric machine tip speed ratio as being equal to or greater than 0.1 and less than or equal to 1.0.

8. A method, comprising: operating a three-stream gas turbine engine so as to define an electric machine power to LP turbine power ratio as being equal to or greater than 0.01 and less than or equal to 1.0 at flight idle.

9. A method, comprising: operating a three-stream gas turbine engine so as to define a power to voltage ratio as being equal to or greater than 0.3 and less than or equal to 2.0, the power to voltage ratio being defined by an electrical power output by an electric machine in kilowatts to a voltage level of the electric machine in volts of direct current, a mid-fan of the three-stream gas turbine engine and the electric machine being operatively coupled with a same shaft of the three-stream gas turbine engine.

10. A method, comprising: operating a three-stream gas turbine engine so as to define a power to AC rated current ratio of an electric machine of the three-stream gas turbine engine as being equal to or greater than 0.2 and less than or equal to 2.5, the power to AC rated current ratio being defined by an electrical power output by the electric machine in kilowatts to an AC rated current of the electric machine in ampere root mean square.

11. A method, comprising: operating a three-stream gas turbine engine so as to define a torque at maximum speed to AC rated current ratio as being equal to or greater than as being equal to or greater than 0.1 and less than or equal to 6.0.

12. A method, comprising: operating a three-stream gas turbine engine having an electric machine embedded therein to define a mid-fan tip speed to HP turbine tip speed ratio as being equal to or greater than 0.7 and less than or equal to 1.5, the mid-fan tip speed to HP turbine tip speed ratio being defined by a tip speed of a mid-fan blade of a mid-fan to a tip speed of a last stage turbine blade of a HP turbine, the electric machine and the HP turbine being operatively coupled with a first shaft of the three-stream gas turbine engine and the mid-fan being operatively coupled with a second shaft of the three-stream gas turbine engine.

13. A three-stream gas turbine engine, comprising: an LP shaft; a primary fan operatively coupled with the LP shaft; a mid-fan positioned downstream of the primary fan and operatively coupled with the LP shaft, the mid-fan having mid-fan blades; a HP shaft; an electric machine operatively coupled with the HP shaft, the electric machine having a rotor rotatable with the HP shaft, and wherein the unducted fan propulsor defines a mid-fan hub radius to electric machine radius ratio as being equal to or greater than 0.1 and less than or equal to 1.0, the mid-fan hub radius to electric machine radius ratio being defined by a radius spanning between a longitudinal axis defined by the three-stream gas turbine engine and an outermost point taken at a trailing edge of a hub of the mid-fan blade of the mid-fan to a radius spanning between the longitudinal axis and an outermost point of the rotor or a stator of the electric machine depending on which one is positioned outward of the other along a radial direction defined by the three-stream gas turbine engine.

14. A three-stream gas turbine engine, comprising: an LP shaft; a primary fan operatively coupled with the LP shaft; a mid-fan positioned downstream of the primary fan and operatively coupled with the LP shaft, the mid-fan having mid-fan blades; a HP shaft; a HP turbine operatively coupled with the HP shaft and having first stage turbine blades; and an electric machine operatively coupled with the HP shaft, the electric machine having a rotor rotatable with the HP shaft, and wherein the three-stream gas turbine engine defines a longitudinal axis and a radial direction, and wherein the three-stream gas turbine engine defines a HP compressor hub radius to electric machine radius ratio as being equal to or greater than 0.1 and less than or equal to 1.0, the HP compressor hub radius to electric machine radius ratio being defined by a radius spanning between the longitudinal axis and an outermost point taken at a leading edge of a hub of one of the first stage blades to a radius spanning between the longitudinal axis and an outermost point of a rotor or a stator of the electric machine depending on which one is positioned outward of the other along the radial direction.

15. A method, comprising: operating a three-stream gas turbine engine having a primary fan, a mid-fan positioned downstream of the primary fan, and an electric machine embedded therein to define a HP turbine tip speed to electric machine tip speed ratio as being equal to or greater than 0.1 and less than or equal to 1.0, the HP turbine tip speed to electric machine tip speed ratio being defined by a tip speed of a first stage turbine blade of a HP turbine to a tip speed of a rotor of the electric machine, the electric machine and the HP turbine being operatively coupled with a first shaft of the three-stream gas turbine engine and the mid-fan and the primary fan being operatively coupled with a second shaft of the three-stream gas turbine engine.

16. A three-stream gas turbine engine, comprising: an LP shaft; a primary fan operatively coupled with the LP shaft; a mid-fan positioned downstream of the primary fan and operatively coupled with the LP shaft, the mid-fan having mid-fan blades; a HP shaft; an electric machine operatively coupled with the HP shaft, the electric machine having a rotor rotatable with the HP shaft; and a HP turbine operatively coupled with the HP shaft and having first stage turbine blades, and wherein the three-stream gas turbine engine defines an axial direction, and wherein the three-stream gas turbine defines a HP turbine length to electric machine length ratio as being equal to or greater than 0.1 and less than or equal to 1.5, the HP turbine length to electric machine length ratio being defined by a length of the HP turbine to a length of the electric machine spanning between a leading edge and a trailing edge of a rotor of the electric machine along the axial direction.

17. A method, comprising: operating a three-stream gas turbine engine so as to define a power to voltage ratio as being equal to or greater than 0.3 and less than or equal to 2.0, the power to voltage ratio being defined by an electrical power output by an electric machine in kilowatts to a voltage level of the electric machine in volts of direct current, the three-stream gas turbine engine having a mid-fan operatively coupled with an LP shaft thereof and the electric machine being operatively coupled with a HP shaft of the three-stream gas turbine engine.

18. A method, comprising: operating a three-stream gas turbine engine having a first electric machine operatively coupled with a first shaft of the three-stream gas turbine engine and a second electric machine operatively coupled with a second shaft of the three-stream gas turbine engine so as to define a second electric machine power to first electric machine power ratio as being equal to or greater than 0.1 and less than or equal to 1.5.

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; wherein the unducted fan propulsor comprises a turbomachine defining an inlet duct, a secondary fan located downstream of the rotating blades and positioned within the inlet duct, and an electric machine, wherein during operation of the unducted fan propulsor, the unducted fan propulsor defines a tip speed ratio equal to or greater than 0.2 and less than or equal to 1.0, the tip speed ratio being defined by a tip speed of a rotor of the electric machine to a tip speed of a blade of the secondary fan.

The aircraft of any of the preceding clauses, wherein the unducted fan propulsor comprises a shaft, and wherein the electric machine and the secondary fan are both operatively coupled with the shaft.

The aircraft of any of the preceding clauses, wherein the unducted fan propulsor defines a primary fan radius of the rotating blades to secondary fan radius of the secondary fan equal to or greater than 2.0 and less than or equal to 6.5.

The aircraft of any of the preceding clauses, wherein the unducted fan propulsor and the electric machine define a secondary fan radius to electric machine radius ratio equal to or greater than 1.33 and less than or equal to 3.8.

The aircraft of any of the preceding clauses, wherein during operation of the unducted fan propulsor, the electric machine defines a power to voltage ratio equal to or greater than 0.3 and less than or equal to 2.0.

The aircraft of any of the preceding clauses, wherein the unducted fan propulsor comprises a low pressure shaft, wherein the turbomachine comprises a turbine section comprising a low pressure turbine operatively coupled with the low pressure shaft, wherein the unducted fan propulsor defines an electric machine length to low pressure turbine length ratio equal to or greater than 0.01 and less than or equal to 3.0.

The aircraft of any of the preceding clauses, wherein the unducted fan propulsor defines an electric machine tip radius to low pressure turbine last stage hub radius ratio as being equal to or greater than 0.1 and less than or equal to 1.0.

The aircraft of any of the preceding clauses, wherein during operation of the unducted fan propulsor, the unducted fan propulsor defines a secondary fan tip speed to high pressure turbine tip speed ratio equal to or greater than 0.7 and less than or equal to 1.5.

The aircraft of any of the preceding clauses, wherein 0.15≤RL/D.

The aircraft of any of the preceding clauses, wherein 0.35≤RL/D, and preferably RL/D is about 0.72.

The aircraft of any of the preceding clauses, wherein θ is between 198° and 310°, and preferably between 205° and 285°.

The aircraft of any of the preceding clauses, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

The aircraft of any of the preceding clauses, wherein the unducted fan propulsor has a dimensionless cruise fan net thrust parameter expressed as follows:

$$0.15 > \frac{{F}_{n e t}}{{ρ}_{0} {A}_{a n} {V}_{0}^{2}} > 0.06 ,$$

wherein Fₙₑₜ is cruise fan net thrust, po is ambient air density, V₀ is cruise flight velocity, and Aₐₙ is annular cross-sectional area perpendicular to an axis of rotation of a rotor axis of rotation.

The aircraft of any of the preceding clauses, further comprising an airfoil, wherein the airfoil comprises the airfoil section, and wherein the unducted fan propulsor is undermounted to the airfoil with one or more intermediate structures.

The aircraft of any of the preceding clauses, wherein the P of the unducted fan propulsor is variable to accommodate different operating conditions.

An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7; wherein the unducted fan propulsor comprises a turbomachine defining an inlet duct, a secondary fan located downstream of the rotating blades and positioned within the inlet duct, and an electric machine, wherein during operation of the unducted fan propulsor, the unducted fan propulsor defines a tip speed ratio equal to or greater than 0.2 and less than or equal to 1.0, the tip speed ratio being defined by a tip speed of a rotor of the electric machine to a tip speed of a blade of the secondary fan.

The aircraft of any of the preceding clauses, wherein the unducted fan propulsor comprises a shaft, and wherein the electric machine and the secondary fan are both operatively coupled with the shaft.

The aircraft of any of the preceding clauses, wherein the unducted fan propulsor defines a primary fan radius of the rotating blades to secondary fan radius of the secondary fan equal to or greater than 2.0 and less than or equal to 6.5.

The aircraft of any of the preceding clauses, wherein the unducted fan propulsor and the electric machine define a secondary fan radius to electric machine radius ratio equal to or greater than 1.33 and less than or equal to 3.8.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{R L}{D} + \frac{( \begin{matrix}\sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.72 \; 25 * {cos}^{2} ( θ )} > 0 ,$$

$$and$$

$$\frac{R L}{D} + \frac{( \begin{matrix}- \sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.72 \; 25 * {cos}^{2} ( θ )} < 0 ,$$

wherein the unducted fan propulsor comprises a turbomachine defining an inlet duct, a secondary fan located downstream of the rotating blades and positioned within the inlet duct, and an electric machine, wherein during operation of the unducted fan propulsor, the unducted fan propulsor defines a tip speed ratio equal to or greater than 0.2 and less than or equal to 1.0, the tip speed ratio being defined by a tip speed of a rotor of the electric machine to a tip speed of a blade of the secondary fan.

The unducted fan propulsor of any of the preceding clauses, further comprising an outer cowling, wherein an electric machine tip radius to low pressure turbine last stage blade hub radius ratio is selected to define a diameter of the outer cowling at an axial location of the electric machine, and wherein the diameter of the outer cowling is configured to influence an aerodynamic interaction with the wing.

The unducted fan propulsor of any of the preceding clauses, wherein the electric machine and its associated power electronics add mass to an aft end of the unducted fan propulsor, thereby shifting a center of gravity of the unducted fan propulsor aft, and further comprising a pylon configured to support loads resulting from the aft-shifted center of gravity.

1. An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°;
wherein the unducted fan propulsor comprises a turbomachine defining an inlet duct, a secondary fan located downstream of the rotating blades and positioned within the inlet duct, and an electric machine, wherein during operation of the unducted fan propulsor, the unducted fan propulsor defines a tip speed ratio equal to or greater than 0.2 and less than or equal to 1.0, the tip speed ratio being defined by a tip speed of a rotor of the electric machine to a tip speed of a blade of the secondary fan.

2. The aircraft of claim 1, wherein the unducted fan propulsor comprises a shaft, and wherein the electric machine and the secondary fan are both operatively coupled with the shaft.

3. The aircraft of claim 1, wherein the unducted fan propulsor defines a primary fan radius of the rotating blades to secondary fan radius of the secondary fan equal to or greater than 2.0 and less than or equal to 6.5.

4. The aircraft of claim 1, wherein the unducted fan propulsor and the electric machine define a secondary fan radius to electric machine radius ratio equal to or greater than 1.33 and less than or equal to 3.8.

5. The aircraft of claim 1, wherein during operation of the unducted fan propulsor, the electric machine defines a power to voltage ratio equal to or greater than 0.3 and less than or equal to 2.0.

6. The aircraft of claim 1, wherein the unducted fan propulsor comprises a low pressure shaft, wherein the turbomachine comprises a turbine section comprising a low pressure turbine operatively coupled with the low pressure shaft, wherein the unducted fan propulsor defines an electric machine length to low pressure turbine length ratio equal to or greater than 0.01 and less than or equal to 3.0.

7. The aircraft of claim 1, wherein the unducted fan propulsor defines an electric machine tip radius to low pressure turbine last stage hub radius ratio as being equal to or greater than 0.1 and less than or equal to 1.0.

8. The aircraft of claim 1, wherein during operation of the unducted fan propulsor, the unducted fan propulsor defines a secondary fan tip speed to high pressure turbine tip speed ratio equal to or greater than 0.7 and less than or equal to 1.5.

9. The aircraft of claim 1, wherein 0.15≤RL/D.

10. The aircraft of claim 1, wherein 0.35≤RL/D, and preferably RL/D is about 0.72.

11. The aircraft of claim 1, wherein θ is between 198° and 310°, and preferably between 205° and 285°.

12. The aircraft of claim 1, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

13. The aircraft of claim 1, wherein the unducted fan propulsor has a dimensionless cruise fan net thrust parameter expressed as follows:
$$0.15 > \frac{{F}_{n e t}}{{ρ}_{0} {A}_{a n} {V}_{0}^{2}} > 0.06 ,$$
wherein Fₙₑₜ is cruise fan net thrust, ρ₀ is ambient air density, V₀ is cruise flight velocity, and Aₐₙ is annular cross-sectional area perpendicular to an axis of rotation of a rotor axis of rotation.

14. The aircraft of claim 1, further comprising an airfoil, wherein the airfoil comprises the airfoil section, and wherein the unducted fan propulsor is undermounted to the airfoil with one or more intermediate structures.

15. The aircraft of claim 1, wherein the P of the unducted fan propulsor is variable to accommodate different operating conditions.

16. An aircraft, comprising:
a fuselage;
an airfoil extending from the fuselage, the airfoil having an airfoil section defining an effective quarter chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position;
wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1 MajAL/D is 2.8 and 1 MinAL/D is 1.7;
wherein the unducted fan propulsor comprises a turbomachine defining an inlet duct, a secondary fan located downstream of the rotating blades and positioned within the inlet duct, and an electric machine, wherein during operation of the unducted fan propulsor, the unducted fan propulsor defines a tip speed ratio equal to or greater than 0.2 and less than or equal to 1.0, the tip speed ratio being defined by a tip speed of a rotor of the electric machine to a tip speed of a blade of the secondary fan.

17. The aircraft of claim 16, wherein the unducted fan propulsor comprises a shaft, and wherein the electric machine and the secondary fan are both operatively coupled with the shaft.

18. The aircraft of claim 16, wherein the unducted fan propulsor defines a primary fan radius of the rotating blades to secondary fan radius of the secondary fan equal to or greater than 2.0 and less than or equal to 6.5.

19. The aircraft of claim 16, wherein the unducted fan propulsor and the electric machine define a secondary fan radius to electric machine radius ratio equal to or greater than 1.33 and less than or equal to 3.8.

20. An aircraft, comprising:
a fuselage;
an airfoil extending from the fuselage, the airfoil having an airfoil section defining an effective quarter-chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:
$$\frac{R L}{D} + \frac{( \begin{matrix}\sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.72 \; 25 * {cos}^{2} ( θ )} > 0$$
$$and$$
$$\frac{R L}{D} + \frac{( \begin{matrix}- \sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.72 \; 25 * {cos}^{2} ( θ )} < 0 ;$$
wherein the unducted fan propulsor comprises a turbomachine defining an inlet duct, a secondary fan located downstream of the rotating blades and positioned within the inlet duct, and an electric machine, wherein during operation of the unducted fan propulsor, the unducted fan propulsor defines a tip speed ratio equal to or greater than 0.2 and less than or equal to 1.0, the tip speed ratio being defined by a tip speed of a rotor of the electric machine to a tip speed of a blade of the secondary fan.
